(19) United States
(12) Patent Application Publication
(10) Pub. No.: US 2017/0255981 A1
(43) Pub. Date: Sep. 7, 2017

(54) METHOD AND SYSTEM FOR ONLINE REDISTRIBUTION OF DATA AND REWARDS

(71) Applicants: Willem Jacobus Van Niekerk, Cape Town (ZA); Marc van Niekerk, Cape Town (ZA); Brendon van Niekerk, Cape Town (ZA); Ernst Kleinhans, Cape Town (ZA)

(72) Inventors: Willem Jacobus Van Niekerk, Cape Town (ZA); Marc van Niekerk, Cape Town (ZA); Brendon van Niekerk, Cape Town (ZA); Ernst Kleinhans, Cape Town (ZA)

(73) Assignee: Inspiration LLC, Wilmington, DE (US)

(21) Appl. No.: 15/464,934

(22) Filed: Mar. 21, 2017

Related U.S. Application Data
(62) Division of application No. 13/843,298, filed on Mar. 15, 2013.
(60) Provisional application No. 61/696,129, filed on Aug. 31, 2012.
(60) Provisional application No. 61/802,029, filed on Mar. 15, 2013.

(51) Int. Cl. G06Q 30/06; G06Q 30/02

(52) U.S. Cl. CPC G06Q 30/0623; G06Q 30/0277

(57) ABSTRACT

Systems and methods are provided for an automated online platform for any member of the public to promote and/or sell online digital content or physical products over the Internet at any time using the proprietary application of the present invention on any digital device connected to a network. Systems and methods are provided for an online promoter/reseller software application that can be accessible through the Internet or other network, and a computer or portable device. The portable device can be a smartphone or a tablet or a handheld device or other portable device. Communications are routed via a central database that associates an identifier with an accessing entity.

### CROSS-REFERENCE TO RELATED APPLICATIONS

This is a Divisional Application of U.S. patent application Ser. No. 13/843,298, filed on Mar. 15, 2013, which claims priority to U.S. Provisional Application No. 61/696,129, filed on Aug. 31, 2012, and U.S. Provisional Application No. 61/802,029, filed on Mar. 15, 2013, each of which is herein incorporated by reference in its entirety.

### FIELD OF THE INVENTION

The present invention generally relates to online sharing of information, more specifically, the present invention relates to the promotion of goods and/or services, and rewards for those who promote.

### COPYRIGHT AND LEGAL NOTICES

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### SUMMARY OF THE INVENTION

An embodiment of the present invention provides for an online promoter/reseller software application that can be accessible through the Internet or other network, and a computer or portable device. The portable device can be a smartphone or a tablet or a handheld device or other portable device.

An embodiment of the present invention provides for an automated online platform for any member of the public to promote and/or sell online digital content or physical products over the Internet at any time using the proprietary application of the present invention on any digital device connected to a network.

An embodiment of the present invention provides for an entity having Internet access to promote and/or resell products and/or content to other entities.

An embodiment of the present invention provides for a user friendly interface which will enable a user to promote and/or resell digital content and/or physical products to others. An embodiment of the present invention provides for a user to promote and/or resell digital content and/or physical products to others through one's own digital front end.

An embodiment of the present invention provides for a creation of a digital front end for a reseller and/or promoter of content which is associated with a central repository and/or central control entity. An embodiment of the present invention provides for the same or a different entity to buy content via the digital front end for a reseller and/or promoter. An embodiment of the present invention provides a digital front end which serves as an online store via which content can be purchased which effects downloading products and/or shipped product.

An embodiment of the present invention provides for a creation of a list and/or catalogue for a reseller and/or promoter of content, the list and/or catalogue being associated with a central repository and/or central control entity. An embodiment of the present invention provides for the same or a different entity to buy content via the list and/or catalogue associated with a reseller and/or promoter. An embodiment of the present invention provides an electronic list and/or electronic catalogue which serves as an online store and/or a link to allow a purchase of a item on the electronic list and/or electronic catalogue. The content can be purchased which effects a downloading of products and/or a shipping of a product and/or an availability of a product in a lockbox or other pickup location.

An embodiment of the present invention provides for a reselling and/or redistributing of content that is not specifically owned by an entity.

An embodiment of the present invention provides for a monetary and/or reward units system for the entity who is reselling and/or distributing product.

An embodiment of the present invention provides for product recommendations and/or reviews via the online digital front end.

An embodiment of the present invention provides for an entity to create a personalized digital front end via which the entity can resell and/or distribute purchased or received content.

An embodiment of the present invention provides for the personalized digital front end to be a substore. An embodiment of the present invention provides for the personalized digital front end to be a template that can be customized by the user who wants to promote content. For example, the content can be from a central server device or a catalogue or a database or from the user's personal digital file location.

An embodiment of the present invention provides for a promoter (e.g., an individual, company, band, user, etc.) to sign up with the central server device in order to promote specific content from the central server device catalogue/database/warehousing facility/repository. The content portrayed and promoted in the promoter's “substore” does not have to be that person's own or personally uploaded content. For example: a promoter can advertise basketballs, a band's new single, ebooks, and so on. The promoter selects items from the catalogue/database/warehousing facility/repository or other location to be included in the promoter's “substore”. Those items are displayed in the “substore”, and can be directly promoted to individual users officially from the promoter via text/email/other transmission methods.

In an embodiment of the present invention, a promoter of content can be an individual, a company, a band, and a user who uses a digital substore or catalogue or list to get rewarded for causing the purchase of a specific item. In an embodiment the buyer of content is also rewarded.

In an embodiment of the present invention, an uploader of content to the central depository device can create a substore of just content. The actual items listed do not have to have been uploaded by the user.

In an embodiment of the present invention, a created substore is effected through the use of a sync up wizard approach in order to allow a user to define the intended environment of its items listing and/or digital storefront.

In an embodiment of the present invention, content on a digital storefront or listing or catalogue or the like can be entered manually, imported files, etc.

In an embodiment of the present invention, a user first uploads content and/or links content for the user's substore; and the user then sets up the listing for the substore/digital listing. A user can search for product(s) via the MPower website to determine if certain products are available for linking from the central repository. If so, then a link can be made. If not, then a user can upload the product to the MPower website and then link to the product. Alternatively, the product can remain in a different repository.

In an embodiment of the present invention, the content listings and promoter listings are searchable via the MPower website. Privacy settings can be set to prevent some or all users from accessing another user's listing and/or sub store.

In an embodiment of the present invention, digital and physical products can be available for purchase. For example, for physical products, the purchase can be allowed only for specific regions and/or delivery to or pickup from a specific region(s).

In an embodiment of the present invention, if a user does not wish to use the MPower payment gateway, alternative interfaces are available, including Paypal, etc.

In an embodiment of the present invention, when payment is made, an identifier and/or response card is sent to the MPower system to allow further processing in the transaction.

In an embodiment of the present invention, a user can go to the MPower website and search for and obtain a specific person's list. In an embodiment of the present invention, a user can get the specific person's list because it was sent to the user by the specific person. In an embodiment of the present invention, a user can get the specific person's list by searching for the person's substore.

In an embodiment of the present invention, one can request via the MPower website for items and/or lists and/or substore and/or content that might be of interest to the user. Such determinations may be made on the previous purchases of the user, the items in the user's listing, and/or the items searched by the user. The information is being pulled from the system in order to find possible relevant content.

Embodiments of the present invention may effectively reduce piracy of digital content or physical products. Embodiments of the present invention may embolden confidence in electronic trading and obtaining of digital content and/or physical products. Embodiments of the present invention may enhance the marketing and global reach of digital content and/or physical products through the user network. Embodiments of the present invention may empower members of the global community to create individual cashflow means with minimal and/or no start-up costs.

### BRIEF DESCRIPTION OF THE DRAWINGS

FIG. 1 shows an example options for integrating MPower with a Social Network Integration.

FIG. 2 shows an example options for using MPower on a website.

FIG. 3 shows an example process for using a plug-in via Social Network.

FIG. 4 shows an example process for purchasing an item via the BUYiT option of a plug-in.

FIG. 5A shows an example process for using a plug-in via the MPower website.

FIG. 5B shows an example process MPower website.

FIG. 5C shows an example message creation window.

FIG. 5D shows an example of a received message.

FIGS. 6A to 6L show examples of a method according to embodiments of the present invention.

FIGS. 7A to 7Q show examples of the options available for a user when they log on to the MPower website.

FIGS. 8A to 8Q show examples of a method according to embodiments of the present invention.

FIGS. 9A to 9Q show examples of a method according to embodiments of the present invention.

FIGS. 10A to 10F show examples of a method according to embodiments of the present invention.

FIGS. 11A to 11Q show examples of a method according to embodiments of the present invention.

FIG. 12A shows an example process for creating a substore within the MPower system.

FIG. 12B shows examples of information that can be displayed to users accessing a substore.

FIGS. 13A and 13B show examples of a method according to embodiments of the present invention.

FIG. 14A to 14G show examples of a method according to embodiments of the present invention.

FIG. 15 shows an example process for getting an item via the MPower system.

FIG. 16 shows an example of a method according to an embodiment of the present invention.

FIG. 17 shows an example of a method according to an embodiment of the present invention.

FIG. 18 shows an example of a method according to an embodiment of the present invention.

FIG. 19 shows an example system according to an embodiment of the present invention.

FIG. 20A shows an example diagram of a user's experience according to an embodiment of the present invention.

FIG. 20B shows an example diagram of an administrator's experience according to an embodiment of the present invention.

FIG. 21 shows an example connection scenario according to an embodiment of the present invention.

FIG. 22 shows an example page flow diagram according to an embodiment of the present invention.

FIG. 23 shows a flowchart illustrating an example embodiment of the present invention.

FIGS. 24A to 24D show examples of a method according to embodiments of the present invention.

FIG. 25 shows an example of a simplified flow diagram that illustrates a process for accessing the MPower system via a plug-in at a Supplier website according to an embodiment of the present invention.

FIG. 26 shows an example of a simplified flow diagram that illustrates a process for registering new suppliers with the MPower system according to an embodiment of the present invention.

### DETAILED DESCRIPTION

The following description provides specific details for a thorough understanding of, and enabling description for, various embodiments of the technology. One skilled in the art will understand that the technology may be practiced without many of these details. In some instances, well-known structures and functions have not been shown or described in detail to avoid unnecessarily obscuring the description of the embodiments of the technology. It is intended that the terminology used in the description presented below be interpreted in its broadest reasonable manner, even though it is being used in conjunction with a detailed description of certain embodiments of the technology. Although certain terms may be emphasized below, any terminology intended to be interpreted in any restricted manner will be overtly and specifically defined as such in this Detailed Description section.

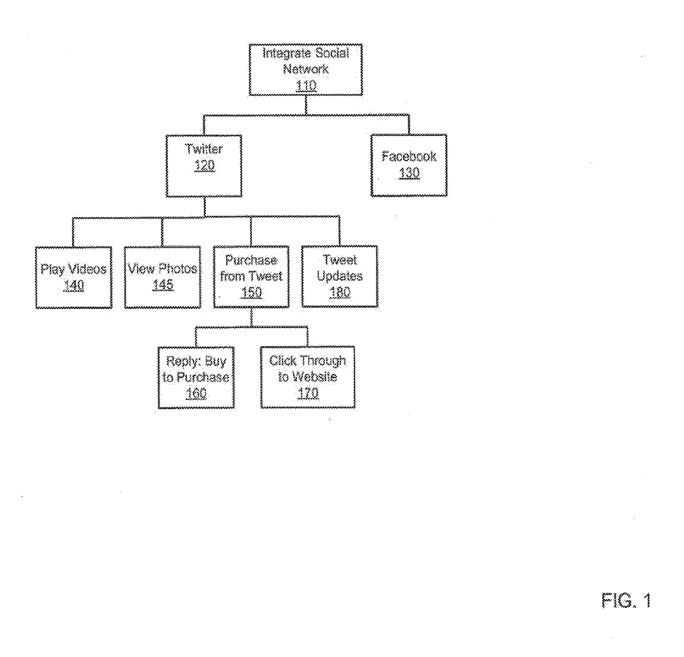

FIG. 1 illustrates example options for integrating MPower with a Social Network Integration. As shown in FIG. 1, the MPower user can choose to interact with MPower through an existing Social Network account (block 110). The user has multiple options for integrating MPower into their Social Networks. For example, the MPower user can choose to use MPower with their existing Twitter account (block 120) or with their existing Facebook account (block 130). The MPower user can choose multiple different Social Networks with which to integrate MPower. Additionally, if the user does not already have an existing account on a selected Social Network, then the user may be prompted to create an account before MPower can be integrated with their Social Network.

For example, if the user chooses to integrate their Twitter account with their MPower account, the user can interact with MPower via Twitter in multiple ways. For example, the user can play videos (block 140) and view photos (block 145) on Twitter. Those items can then be shared via MPower. Additionally, users can purchase items (block 150) via MPower on Twitter, for example, by replying to a promotional tweet (block 160) or by clicking through a link in the tweet to the MPower website (block 170). This is similar to the Chirpify system.

MPower users can also receive messages via their selected Social Network (block 180). For example, the MPower system can send account status updates as a tweet that indicates the user's current point status, reward status, or other updates regarding shared items. Users can also receive notifications indicating that a shared item has been purchased and a reward disbursed.

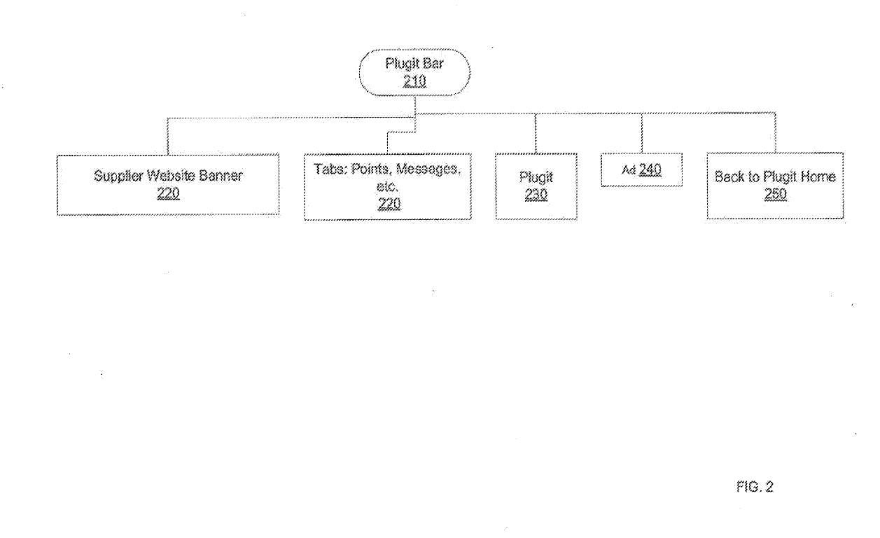

FIG. 2 illustrates example options for using MPower on a website. A PlugIt Bar associated with the MPower system can be provided to allow users to plug or share items while they're browsing, shopping, or surfing the web (block 210).

A user can access the MPower system via a PLUGiT Bar. The PLUGiT bar allows users to plug or share items while they are browsing, shopping, or surfing the web. The PLUGiT bar can be integrated as part of a web browser and accessible as any other toolbar. The PLUGiT bar can also be accessible at a registered Supplier's website as a banner at the top, bottom, side, or other location on the website. Access to the PLUGiT bar can also be placed in an advertisement, whether a banner ad, a pop-up ad, or some other advertisement of an item that can be purchased via the MPower system.

A PLUGiT bar can provide several options for the MPower user. For example, the PLUGiT bar may have multiple tabs or pulldown options for accessing or viewing the user's account, the notifications and messages sent to the user, the points and rewards available or redeemed by the user, the items shared by or with the user, etc. The PLUGiT banner can also provide links, for example so that the user can return to the MPower home page, can log-in to their account, or can share or plug the current webpage or item.

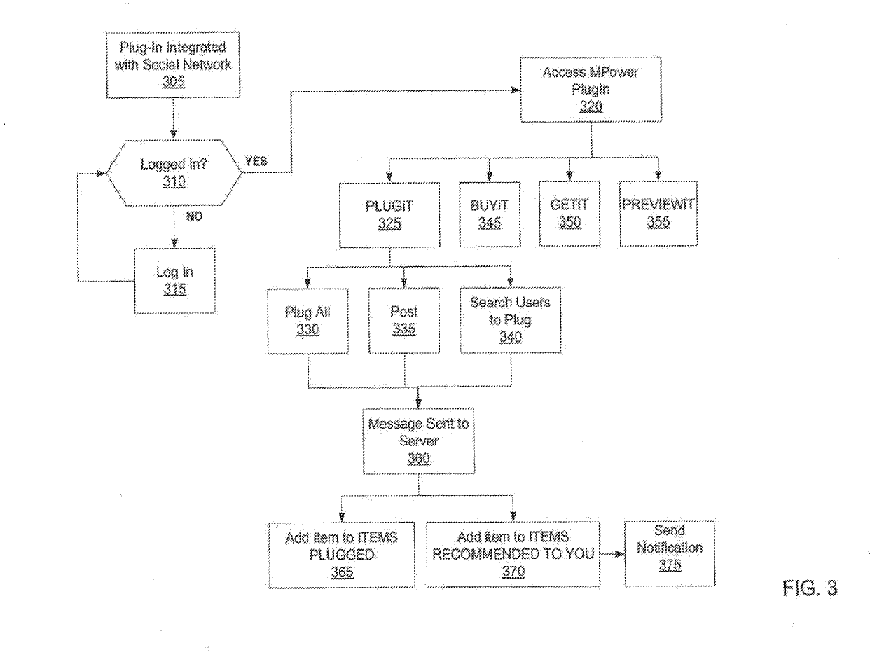

FIG. 3 illustrates an example process for using a plug-in via Social Network. Initially, a user's MPower account can be integrated with a Social Network (block 305). Then when the user accesses the plug-in from the Social Network, the plug-in initially checks to determine whether the user is logged in to an MPower account (block 310). If the user is not logged in, the user will be prompted to enter a username name and password to log in to their MPower account (block 315). Once the user is logged in, they can access the features of the plug-in. For example, from the plug-in, as shown in FIG. 3, the user can plug or share an item on the current webpage, comment, tweet, stream, or other Social Network platform (block 325). To plug or share an item, the user is presented with multiple options. For example, the user can share the item by choosing to Plug All (block 330). The Plug All option allows the user to post or share the item with all MPower users at the MPower website. The user also has the option to post the item to a third party website, such as via a Social Network message board or other posting option, or by sharing the item with an email recipient via a traditional email message (block 335). The user also has the option to share the item with a specific smaller group of users (block 340). To share the item with a group of users, the sharing user can select one or more MPower users or user groups from a presented list.

Once an item has been successfully shared or plugged, a message is sent to the MPower server to record the action (block 360). Then the item shared can be added to the sharing user's list of items plugged (block 365). The item shared can also be added to a selected user's list of items recommended to them if the user was specifically selected to receive the share (block 370). Lists of items associated with a user can actually be stored in a database or other memory in a manner that associates the item with the user. Then the list can be recreated and adjusted as needed. When an item is added to a user's list of items that have been recommended to them, the user may receive a notification indicating a new item has been shared. The notification can also include an identification of the item and an identification of the user who originally shared the item with them.

As shown in FIG. 3, the user can perform additional actions from the plug-in other than plug or share an item. For example, the user can buy an item (block 345), get an item (block 350) or preview an item (block 355). Example processes for executing each of these functions are discussed below.

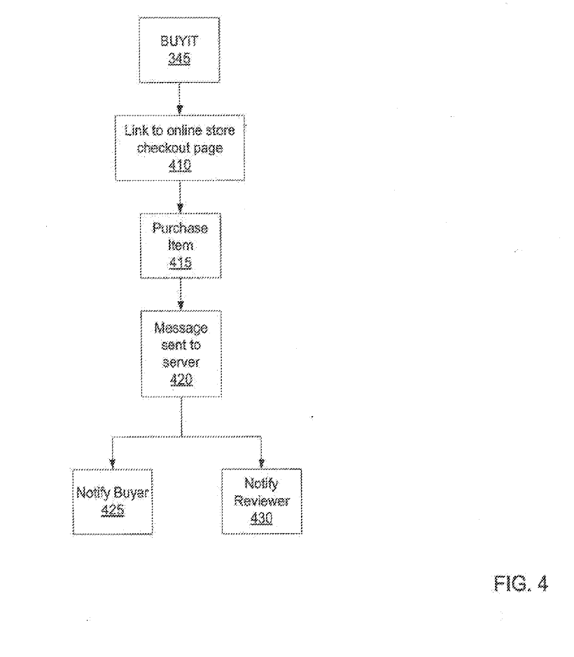

FIG. 4 illustrates an example process for purchasing an item via the BUYiT option of a plug-in. As previously noted, the user can purchase an item via the Social Network plug-in (block 345). When the BUYiT option is selected, the plug-in accesses a link to the Supplier or online store that is selling the selected item (block 410). The user can be delivered directly to the checkout page of the store web site. Then the user can purchase the item from the website (block 415). Once the purchase has been successfully completed, a message is sent to the MPower server to record the action (block 420). The MPower system may then send a notification to the user/buyer of the item confirming the purchase, identifying a reward disbursement for the purchase, or transmitting some other message related to the purchase (block 425). The MPower system can also send a notification to a reviewer that originally shared or plugged the item (block 430). The notification to the reviewer can include an identification of the item purchased, the user who purchased the item, the purchase price, and/or a reward for recommending the item.

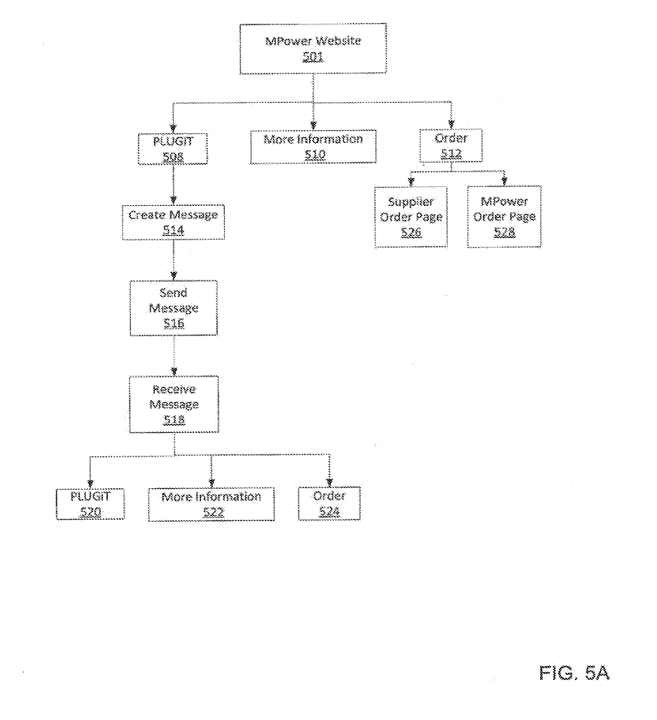

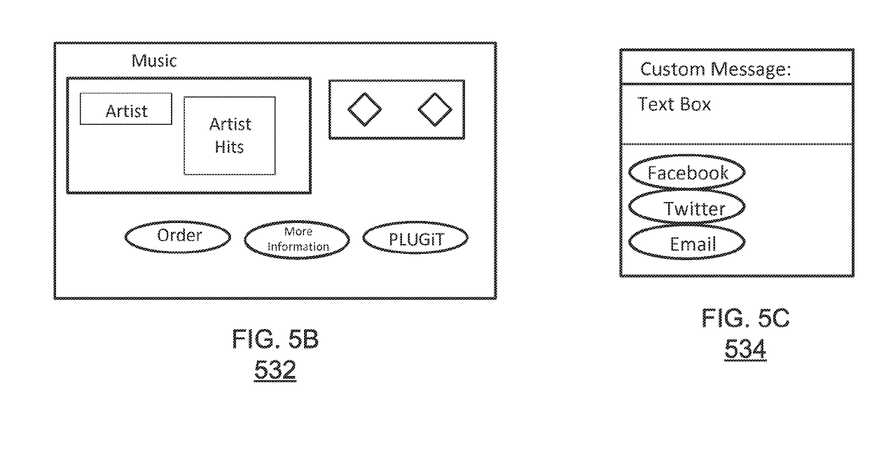

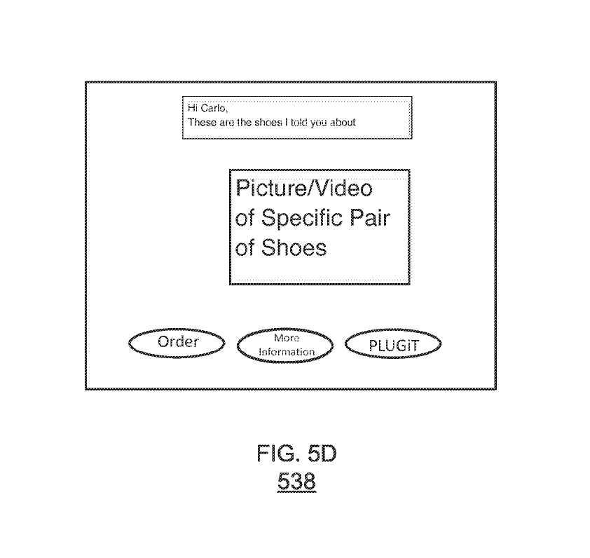

FIG. 5(A) illustrates an example process for using a plug-in via the MPower website. FIG. 5(B) illustrates an example MPower website 532. As shown in FIG. 5(B), the website can be dedicated to a single category (e.g. Shoes), or any other organizational structure useful for browsing, sharing, and purchasing items available through the MPower system. From the MPower website, the user can perform several different actions. For example, the user can share an item via the PLUGiT button (block 508), view more information about the item (block 510), or order the item (block 512).

When a user elects to see additional information about the item (block 510), the user is directed to an MPower website dedicated to the item. Then, media related to the item is presented. For example, if the shared item is a pair of shoes, the item website can include background on the shoes, what sizes they have available, options of style: e.g. colors, related photos, a link to a video or embedded advertisement video, etc.

As described herein, when a user elects to order the item (block 512) the user can be directed either to an MPower managed page to complete the purchase (block 528) or to a Supplier page to complete the purchase through the Supplier selling the item (block 526).

When a user elects to share an item via a PLUGiT button or link (block 508), they are prompted to create a message (block 514). An example message creation window is shown in FIG. 5(C). As shown in FIG. 5(C), from the message creation window 534, the user can enter a custom message in a text box, and select a Social Network (e.g. Facebook or Twitter) via which to share the message. The user can also choose to share the item and message via an email.

Once a message is created, the message can be posted to the selected Social Network, or sent to one or more selected users (block 516). If the message is sent to a selected user, the selected user will then receive the message or notification (block 518). An example of a received message is shown in FIG. 5(D). From the received message 538, the recipient can view the shared item and select one or more actions. For example, the recipient can plug or share the item (block 520), can see additional information about the item (block 522), or can order the item (block 524). These optional recipient actions can be the same actions that the original user browsing the MPower website had the option to take.

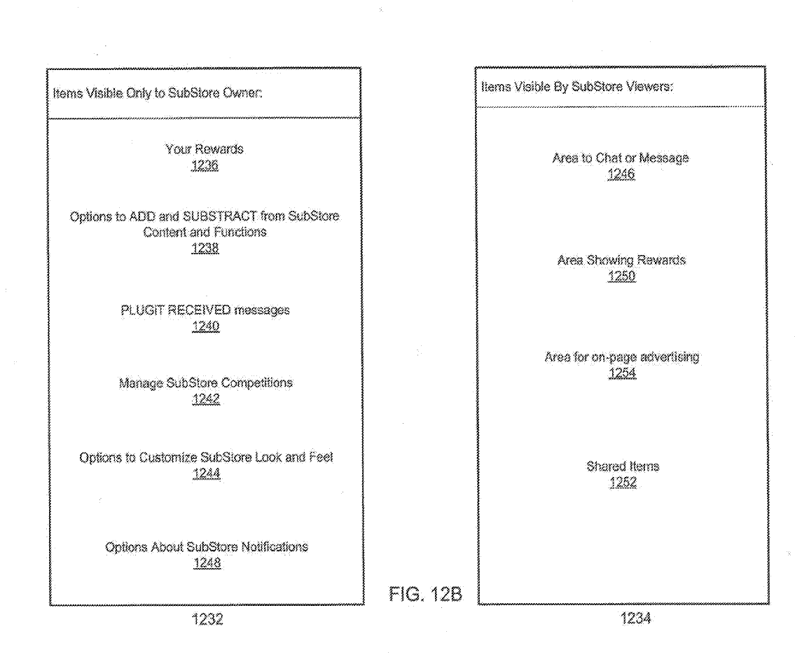

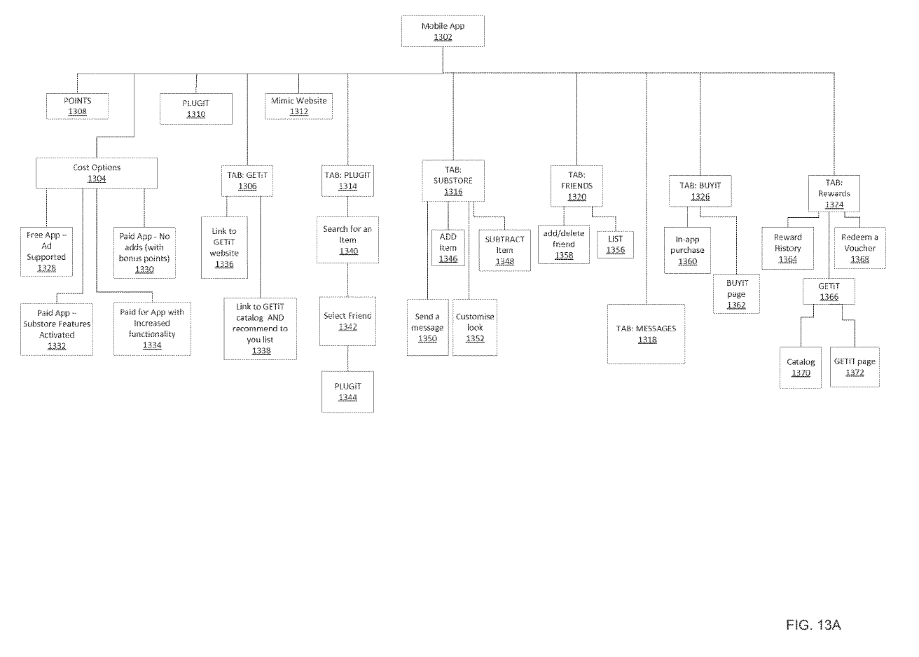

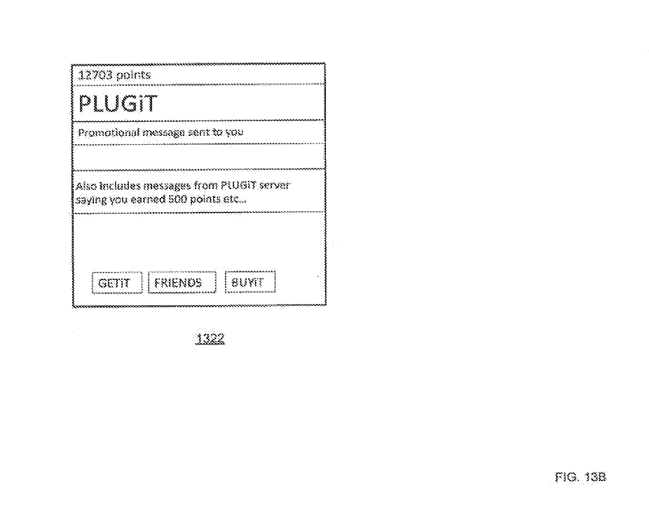

FIG. 12(A) illustrates an example process for creating a substore within the MPower system. A substore is created from a template that can be customized by a user to review and/or promote content. For example, an individual user or a user that is affiliated with a company, band, author, etc. can create an MPower account to review and/or promote content from the mPower catalogue. The user can then create a substore to promote content (block 1202). Preliminarily, the user selects a template or sets a layout for the substore (block 1226). Then the user can identify whether the substore will be a public substore viewable (and searchable) by all MPower users, or whether the substore will be private with membership restricted to a group of invited users (block 1218).

MPower users can search or browse for public substores as well as public items. Content in a substore may belong to a predetermined category and users searching for items or information in that category can find those items via a search. The substore itself can also be categorized so that a search for items or substores in that category will result in the created substore.

If the user creates a private substore, the user can then create the group of users that will have access to the substore (block 1210). Users within the group can share items to the group. Users in a private substore can compete against the other members of the group (block 1216). For example, users within the group can compete with other members in a running or time limited competition to see who can earn the most rewards, or to determine who can reach a reward goal first, etc. Group members can be encouraged to buy and/or plug/share specific products to earn additional rewards. Similarly, users in a substore group, or the group as a whole, can compete with other users or groups in the MPower system (block 1218).

If the user creates a public substore, the user adds content to the substore that they have promoted or reviewed (block 1220). The user can also manually delete items from his reviewed/plugged list on the substore. To add content, the user selects items from the mPower catalogue, database, or from a warehousing facility to be included in the substore. These items will be displayed in the substore, and can also be directly promoted/reviewed to individual users by the user by sharing the items with those individual users.

The content displayed in the substore, does not have to be content created by an company or organization affiliated with the user, or content uploaded to MPower by the user. For example, User A can recommend basketballs, U2's new single, ebooks, etc. However, if the user has created and/or uploaded content to MPower, they can create a substore of only that content in order to promote their own content. The user can then share their content as described (block 1224). A user that creates a substore is essentially a Promoter/Reviewer of content and is rewarded (along with the buyer) for the purchase of an item purchased through their substore. The more traffic a user brings to their substore, the more rewards the user earns. The reward process is described elsewhere.

FIG. 12(B) shows examples of information that can be displayed to users accessing a substore. As shown in FIG. 12(B), there are option and categories of information that are viewable only by the substore creator/owner 1232. For example, a substore owner can view the rewards that they have accumulated to date 1236 and their personal messages 1240, including items that other users have shared with the owner. The substore owner can also access options to manage the substore. For example, the owner can add or subtract content from the store and set options for functionality available within the store 1238. Such options can include setting the type and frequency of notifications sent to sub store members, inviting MPower users to join the substore, or turning off notifications entirely 1248. If applicable, the owner can also view and manage competitions running between members of the substore 1242. The owner can also customize the look of the sub store, for example by changing the layout, the background, and other cosmetic settings 1244.

Additionally, as shown in FIG. 12(B), there are option and categories of information that are viewable to all users accessing the substore 1234. For example, a user viewing a substore can access a chat or message area to communicate with members viewing the substore 1246. If applicable, the user can also view the reward standings for substore group members participating in a competition 1250. There can also be an area for on-page advertising as part of the substore 1254.

Substore viewers also have access to all the items shared within the substore, including items shared or promoted by the substore creator and if applicable, any items shared by substore group members 1252. The shared items need not indicate the users to whom the item has been shared or who received the original share in the group. A shared items list can be created automatically, for example, by displaying all items the substore owner has shared regardless of how that item was shared. For example, an item shared by the substore owner with a specific selected friend can be automatically added to the list of items displayed in the substore. Essentially, all recommendations by the substore owner can be added to the items displayed in the substore. Each displayed item contains a link to the item such that the item can be shared or purchased by a user viewing the substore. Based on the size of the shared items list, the items in the substore can be categorized and sorted, can be searchable, or can simply be presented in a list or basic display.

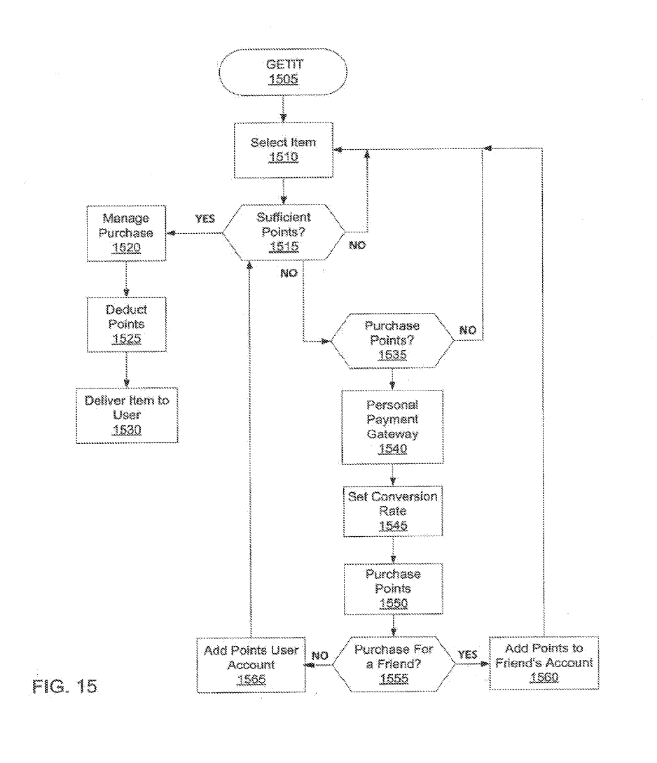

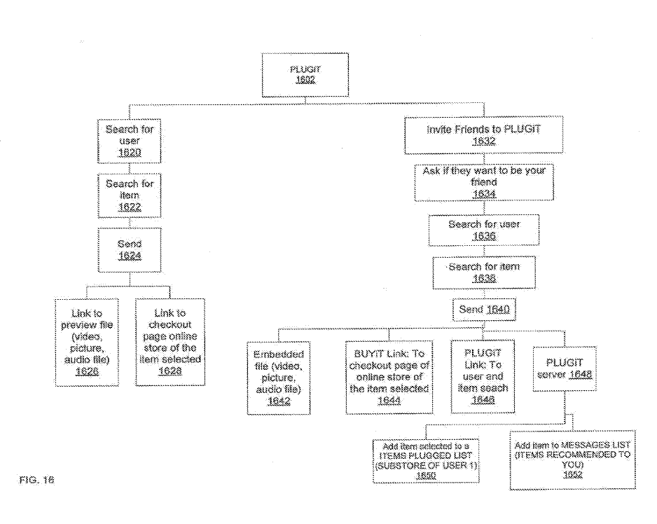

FIG. 15 illustrates an example process for getting an item via the MPower system. For example, a user can get an item by accessing the GETiT button or link from any MPower interface, including the GETiT option of a plug-in (block 1505). As previously noted, a user can accumulate rewards when they share an item and that share results in a successful purchase of the item. For example, once a purchase has been successfully completed, a message is sent to the MPower server to record the action and the MPower system sends a notification to a reviewer that originally shared or plugged the item to the buyer. The notification to the reviewer can include an identification of the item purchased, the user who purchased the item, the purchase price, and/or a reward for recommending the item. The reward can take the form of a cash reward or a point reward.

As shown in FIG. 15, after the user has access the GETiT function, the user is presented with a webpage that allows the user to select a reward redeemable for points (block 1510). The webpage can include a small subset of items, items of a certain type (for example, certain clothes or books), or could allow the user to select any item available for purchase through the MPower system. Once the user has selected an item, the MPower system determines whether the user has sufficient points to redeem the selected item (block 1515). If the user does have sufficient reward points, an MPower server manages the purchase of the item, for example, by collecting user and delivery information, confirming the purchase, etc. (block 1520). Then the MPower system will deduct the appropriate amount of points form the user's account (block 1525). The MPower system can also arrange for delivery of the item (block 1530). For example, if the purchased item is a physical item, an MPower server may send a message to a distribution center to deliver the item to the user's address. If the purchased item if a digital item, the MPower system could cause the database to deliver the digital item to the user, for example, via a download link, via an email or other message, a pop-up etc.

If the user does not have sufficient points to purchase the selected item, the user may be prompted to purchase additional points (block 1535). If the user does not have the option to purchase additional points, or if the user chooses not to buy additional points, the user will be returned to the item selection webpage to select an item which they can afford to purchase (block 1510). However if the user chooses to purchase points, the user will be directed to a personal payment gateway (block 1540). At the personal payment gateway, the conversion rate for points for money will be set and displayed (block 1545). The user can also have the option to purchase points for himself, or for a friend. Once points are successfully purchased (block 1550), if the points were purchased for a friend (block 1555), the purchased points will be added to the friend's account (block 1560) and the user will be returned to the item selection page (block 1510). If points were purchased by the user, for the user, then the purchased points will be added to the user's account (block 1565) and the MPower system will determine if the user now has sufficient points to purchase the selected item (block 1515). The user may have the option to enter the personal payment gateway at any time and purchase points.

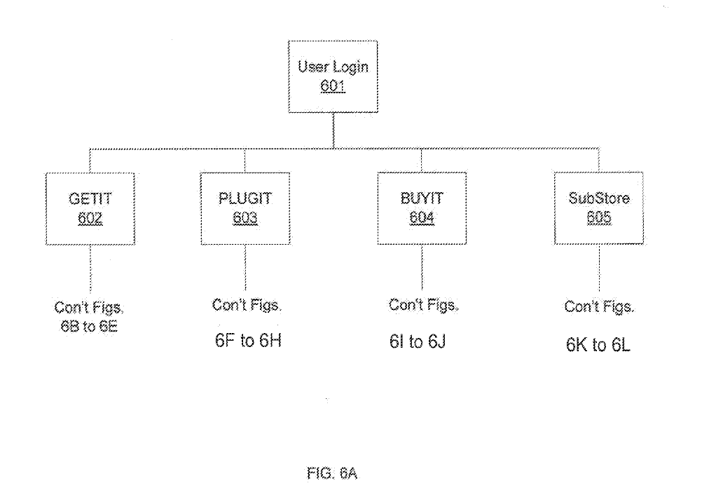

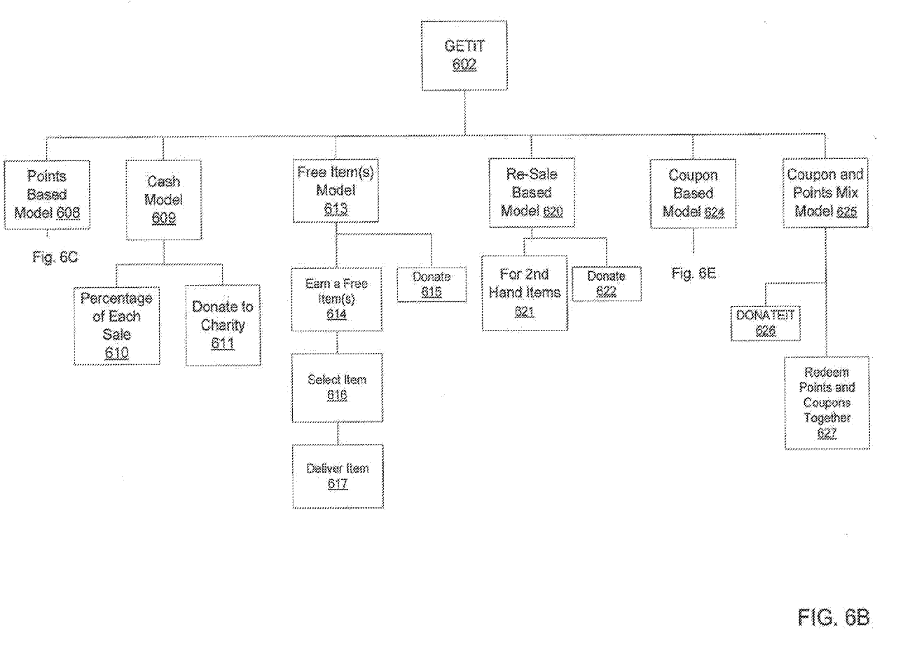

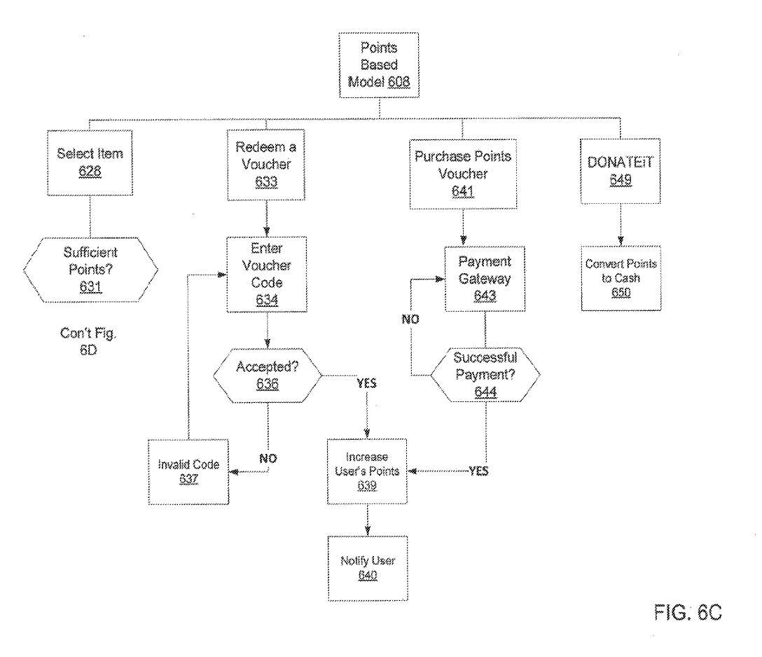

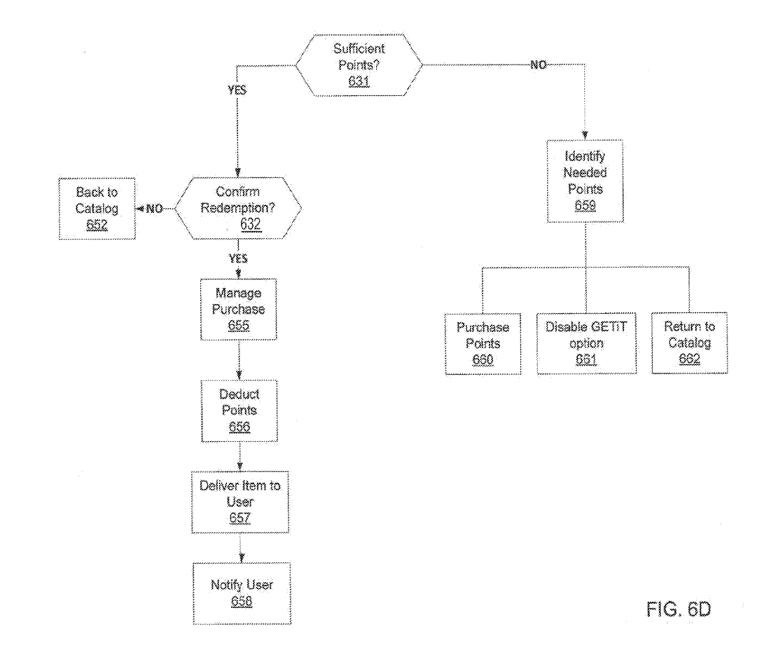

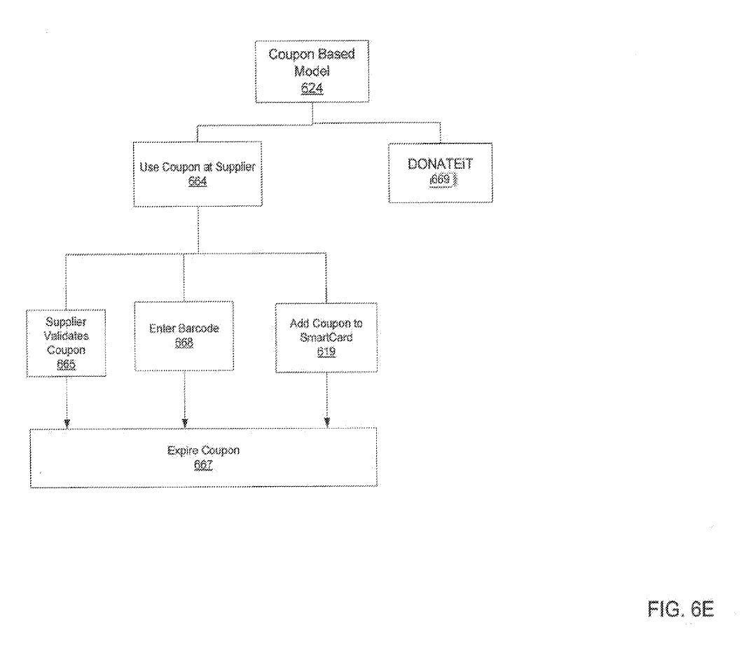

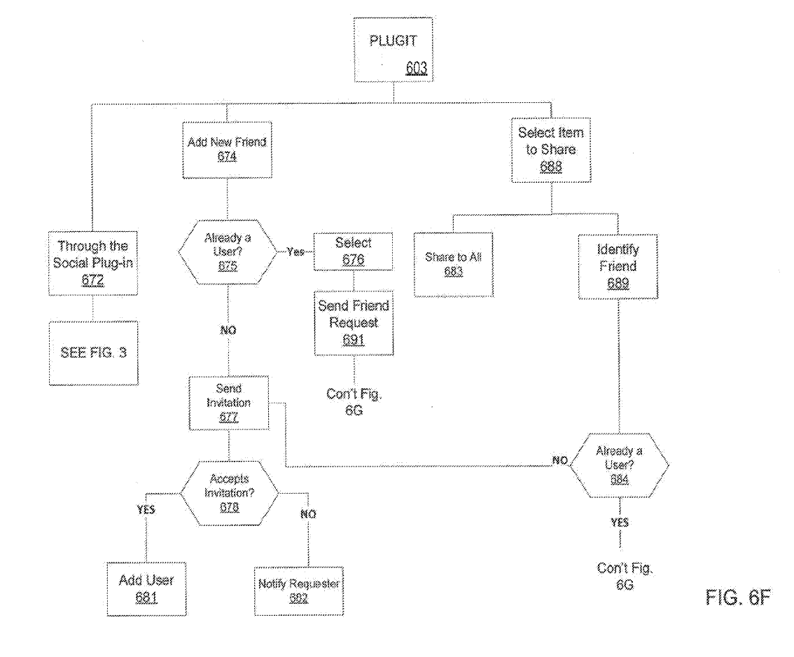

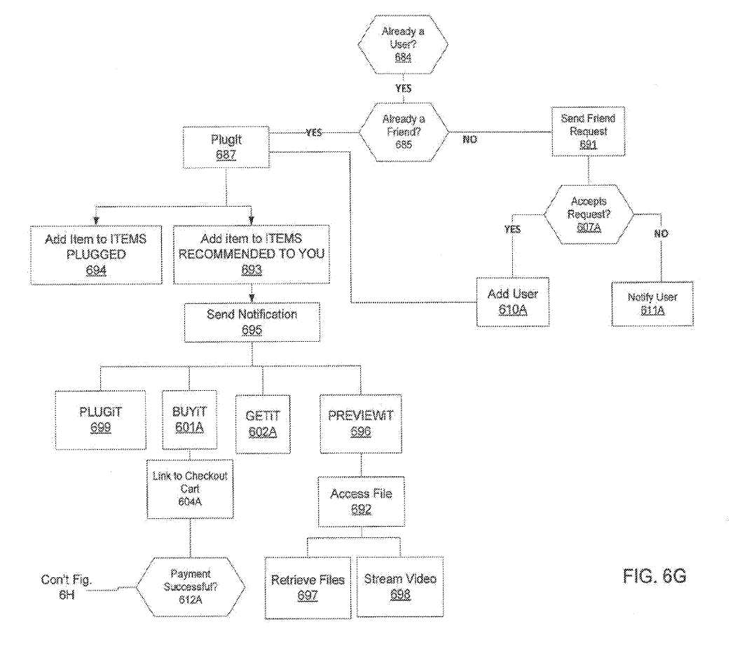

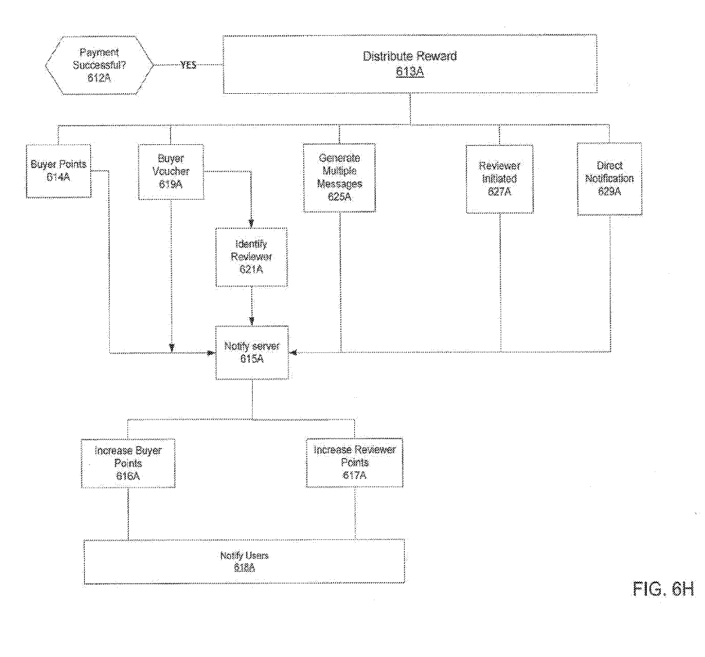

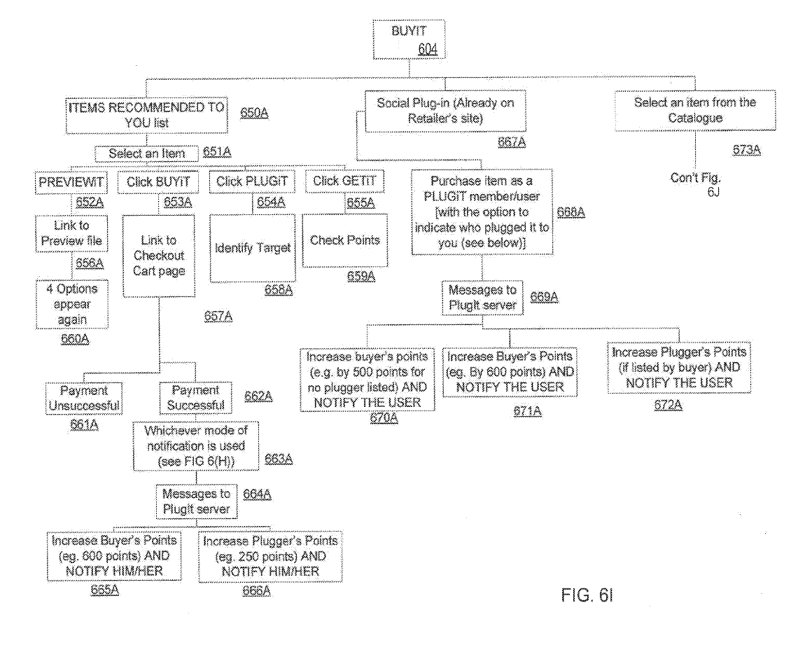

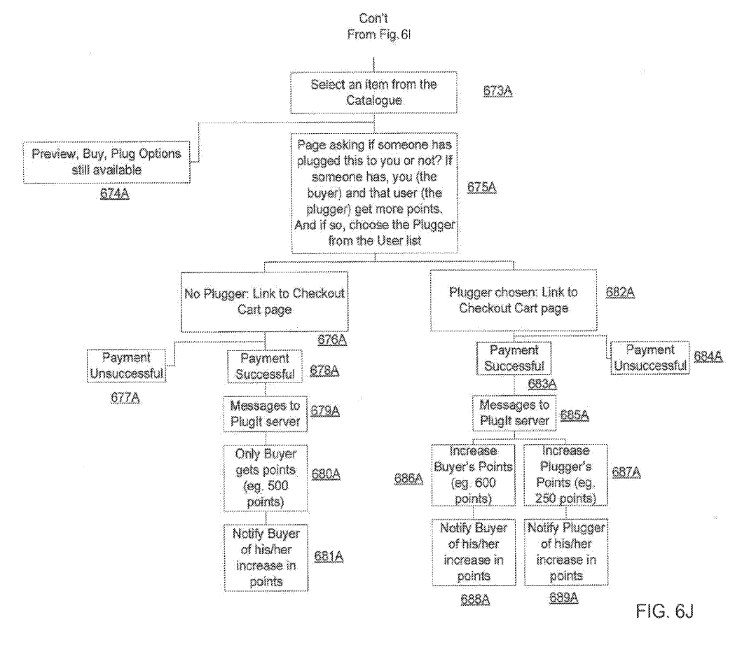

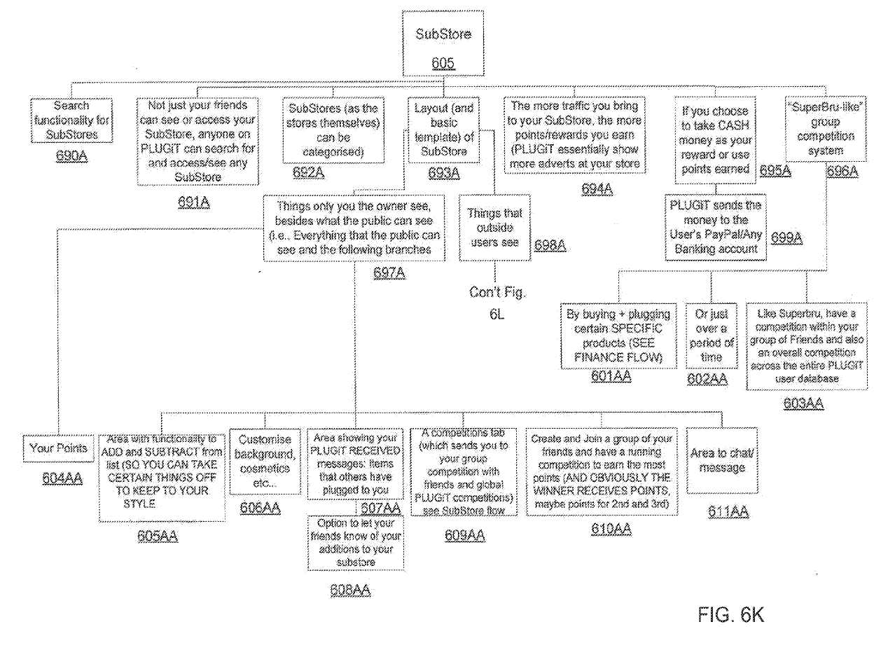

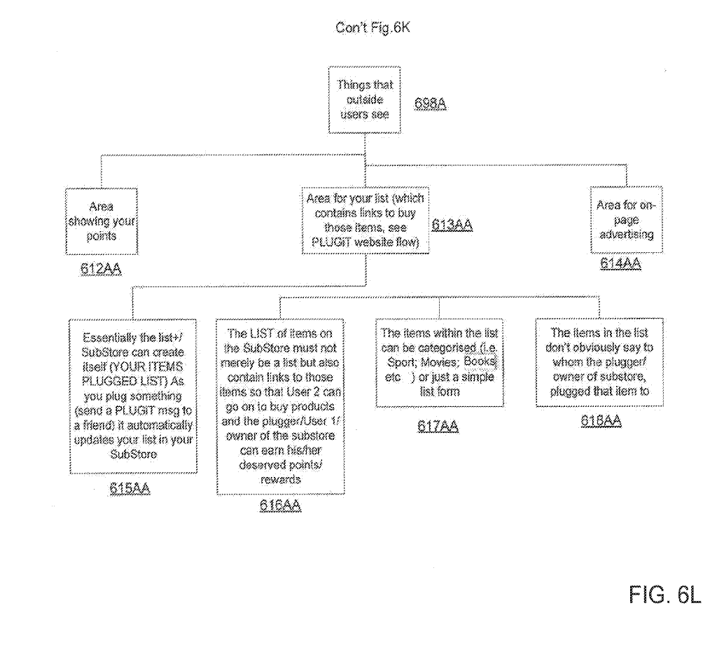

FIG. 6(A) illustrates an example process for the user to interact with an embodiment of the MPower system. As shown in FIG. 6(A), the user initially logs-in to the MPower system to access the available features (block 601). The user then has several options for interacting with the MPower system. The User can access a GETiT feature (block 602), a PLUGiT feature (block 603), a BuyiT feature (block 604), or a substore feature (block 605).

FIG. 6(B) illustrates an example process for using the GETiT feature (block 602). The GetiT feature is used to redeem rewards earned through the MPower system. The process for redeeming rewards can depend on reward model being used.

Reward models can be exponential such that if a user makes a purchase after via a review of a single item and the item is part of larger set, then the reward for each individual item purchased singlely will be less than the reward for the set. For example, if a user reviews a book, and the book is in a series of 3 books, the 3 individual rewards for each book will earn less than 1 reward for a purchase of the whole series at once. Therefore, the user is motivated to review or promote a whole surround sound system rather than just the speakers.

If the rewards system is a cash based model (block 609), a percentage of each sale goes to the reviewer and/or the buyer (block 610). For example, 70% of a purchase price will go to the content creator, 20% of the purchase price will go to MPower, and 10% of the purchase price will go to the reviewer (or will be split between reviewer and the buyer).

As described herein, the MPower servers keep a record of a user's reviews and recommendations and when a purchase initiated by that review is completed, the server will distribute the appropriate reward to the reviewer. The reward distribution may occur immediately upon successful completion of a purchase, or at a predetermined time, for example monthly or once the accumulated reward distribution for the user reaches a specific predetermined value. According to an embodiment, the user can also choose to donate their cash rewards to a charity (block 611).

If the rewards system is a free items based model (block 613), the user can earn free items after the user has accumulated a predetermined amount of sales from reviews (block 614). For example, after X successful sales due to shared reviews, the reviewer receives Y amount of free goods. The free goods could be books, magazines, basketballs or other items (physical/digital) available through the MPower system. The user then selects a free item from a catalog or via a plug-in which provides access to items that may be earned (block 616). The catalog can include a small subset of items, items of a certain type (for example, certain books), or could allow the user to select any item available for purchase through the MPower system.

Once the user has selected an item, an MPower server manages the purchase of the item, for example, by collecting user and delivery information, confirming the purchase, etc. Then the MPower system will arrange for delivery of the item (block 617). For example, if the purchased item is a physical item, an MPower server may send a message to a distribution center to deliver the item to the user's address. If the purchased item is a digital item, the MPower system could cause the database to deliver the digital item to the user, for example, via a download link, via an email or other message, a pop-up etc. . . . . According to an embodiment, the user can also choose to donate their free item rewards to a charity (block 615).

If the rewards system is a re-sale based model (block 620), the user can earn free second hand goods in the same manner that the user earns free items (block 621). The second hand goods could be books, magazines, or other physical/digital items available through the MPower system. According to an embodiment, the user can also choose to donate their free item rewards to a charity (block 622).

The rewards system could also be points based (block 608), coupon based (block 624) or a combination of both (block 625).

FIG. 6(C) illustrates an example process for redeeming rewards with a points based model (block 608). According to an embodiment, the user is presented with a webpage that allows the user to select an item that can be purchased with points (block 628). The webpage can include a small subset of items, items of a certain type (for example, shoes or books), items recommended to the user by other MPower users, or could allow the user to select any item available for purchase through the MPower system. Once the user has selected an item, the MPower system determines whether the user has sufficient points to redeem the selected item (block 631).

FIG. 6(D) illustrates an example process for purchasing a selected item with points in a points based rewards system. If the user does have sufficient reward points (block 631), the user will be prompted to confirm the transaction (block 631). If the user does not confirm the transaction, the user will be returned to the item selection webpage to select an item which they can afford to purchase (block 652). If the user does confirm the redemption, an MPower server manages the purchase of the item, for example, by collecting user and delivery information, etc. (block 655). Once the transaction details have been completed, the MPower system will deduct the appropriate amount of points form the user's account (block 656). The MPower system can also arrange for delivery of the item (block 657). For example, if the purchased item is a physical item, an MPower server may send a message to a distribution center to deliver the item to the user's address. If the purchased item is a digital item, the MPower system could cause the database to deliver the digital item to the user, for example, via a download link, via an email or other message, a pop-up etc. . . . . Then the MPower system will send a notification to the user identifying the delivery details and the deduction of rewards points from the user's rewards account (block 658).

If the user does not have sufficient points to purchase the selected item, the amount of points the user needs to complete the transaction may be determined and displayed (block 659). The user may then be prompted to purchase additional points (block 660), returned to the item selection webpage to select an item which they can afford to purchase (block 662), or the GETiT option temporarily disabled for the user or the selected item (block 661).

Returning to FIG. 6(C), as part of the points based rewards model, the user can redeem a voucher for points (block 633). This procedure is similar to redeeming an Amazon gift card. To redeem a voucher, the user enters a voucher code (block 634). The voucher code will then be validated (block 636). If the voucher is not accepted, the system will display an error message, for example, indicating that the code is not valid (block 637), and the user will be prompted to enter another code (block 634). If the voucher code is accepted, an MPower server will manage the addition of points to the user's account (block 639). For example, the server will receive a message identifying the valid redemption and will update the user's account. Then the MPower system will send a notification to the user identifying addition of points to the user's rewards account (block 640).

As part of the points based rewards model, the user can purchase a voucher for points (block 641). This procedure is similar to purchasing an Amazon gift card. To purchase a voucher, the user will be directed to a personal payment gateway (block 643). At the personal payment gateway, the purchase of points and vouchers will be managed. For example, the conversion rate of points for money will be determined, and a payment from the user's payment account will be processed. Through the payment gateway, the user also has the option to securely donate money to a charity of their choice. Once points are successfully purchased (block 644), the purchased points will be added to the user's account (block 639). Then the MPower system will send a notification to the user identifying addition of points to the user's rewards account (block 640).

As part of the points based rewards model, the user can donate their points to charity (block 649). When a user chooses to donate points, the MPower system will convert points to cash and donate the converted amount to a charity of the user's choice (block 650).

FIG. 6(E) illustrates an example process for redeeming coupons in a coupon based rewards system (block 624). When a user earns a reward in a Coupon based system, the user receives access to one or more coupons that they can use during the purchase of an item available on MPower. As with points, coupons can be accumulated and redeemed for greater rewards. A coupon can have an associated point value and in some circumstances can be redeemed for points. For example, 10 points could purchase a free book from MPower or 10 points could be worth a discount at a Supplier. Then the user can choose to use an earned coupon with a Supplier to purchase an item (block 664).

Retailers and Suppliers have multiple options for managing coupons. For example, if a coupon is redeemed by a user, the Supplier could later access their MPower account and validate the coupon via a coupon code (block 665). Then the MPower system will manage the records related to the redemption. For example, the server will receive a message identifying the valid redemption and will update the user's account. Once the Supplier validates the coupon, the coupon will expire and will no longer be valid (block 667).

Retailers can also scan the coupon barcode at the time of redemption at the point of service (block 668). Additionally, the user can redeem their coupon by adding the rewarded amount to a smart card (block 619). Then the MPower system will manage the records related to the redemption. For example, the server will receive a message identifying the valid redemption and will update the user's account. After the coupon is redeemed, the coupon will be expired and will no longer be valid (block 667).

FIG. 6(F) illustrates an example process for using the PLUGiT feature (block 606). The PLUGiT feature is used to share or plug items with other users. For example, a user's MPower account can be integrated with a Social Network and from a plug-in (block 672), the user can plug or share an item on the current webpage, comment, tweet, stream, or other Social Network platform as shown in FIG. 3. Through the PLUGiT feature, a user can build his or her friends list. The friends list includes a list of MPower users and other contacts with whom the user can share items. For example, if the MPower account is integrated with an existing Social Network, the user can share items with his friends and contacts in his Social Network. The user also has the option to add new friends to her friends list (block 674). The user enters identifying information and the MPower system searches through the existing users, for example by searching a user database to determine if the new friend is already an MPower user (block 675). If the user is identified in the user database, the requesting user is asked for a confirmation that the found user is the requested friend (block 676), and if so, the contact information for that individual is retrieved and a friend request message is sent to the identified user (block 691).

If the new friend is not already a user, the MPower system will send an invitation to the contact address provided inviting the friend to join MPower (block 677). If the friend accepts the invitation to join MPower (block 678), the friend is added as a user to system and as a friend to the requesting user's friend list (block 681). If the friend declines the invitation (block 678), a notification message may/may not be sent to the requesting user stating that the invitation was not accepted (block 682).

Once a user has selected an item to share, plug, or review, the user is presented with multiple options (block 688) For example, the user can share the item by choosing to Plug All (block 683). The Plug All option allows the user to post or share the item with all MPower users at the MPower website and will add the item to the user's list of shared items, for example, as displayed in a substore. The user also has the option to post the item to a third party website, such as via a Social Network message board or other posting option, or by sharing the item with an email recipient via a traditional email message.

The user also has the option to share the item with a specific user (block 689). To share the item with a group of users, the sharing user can identify an individual with whom to share the item (block 689). The user enters identifying information and the MPower system searches through the existing users, for example by searching a user database to determine if the new friend is already an MPower user (block 684). If the user is identified in the user database, and if the user is already a friend of the reviewer (block 685), the item is shared with the identified friend (block 687). If the identified friend is not already a user, the MPower system will send an invitation to the contact address provided inviting the friend to join MPower (block 677). If the friend accepts the invitation to join MPower (block 678), the friend is added as a user to system and as a friend to the requesting user's friend list (block 681) and the item will be shared with the new friend. If the friend declines the invitation (block 678), a notification message may/may not be sent to the requesting user stating that the invitation was not accepted (block 682).

If the identified person is already a user (block 684), but the identified person is not yet a friend of the reviewer (block 685), a friend request will be sent to the identified user (block 691). If the user accepts the friend request (block 607A), the user will be added to the reviewer's friend list (block 610A) and the selected item will be shared with the user.

If the user declines the friend request (block 607A), a notification message may/may not be sent to the reviewer stating that the request was not accepted (block 611A).

If the user is already a friend of the reviewer (block 685), the item will be shared with the friend (block 687). To share the item, a message is sent to the selected friend. When a user elects to share an item, they are prompted to create a message. An example message creation window is shown in FIG. 5(C). The message will then be sent to the selected user (block 695). An example of a received message is shown in FIG. 5(D). From the received message, the recipient can view the shared item and select one or more actions. For example, the recipient can plug or share the item as previously described (block 699), can see additional information about the item (block 696), if applicable, can redeem rewards to get the item as previously described (block 602A), or can buy the item (block 601A).

All users on the mPower system will have privacy settings to be able to control over; for example, what they can receive as reviews/promotions from other users; what personal details are shown to others etc. . . . .

The information about the item that the selected user can access from the notification message can include one or more of the following: an embedded video, picture, or audio file embedded in the notification or a link to any of them (block 692). The files can be retrieved directly from a supplier or other third party (block 697). Videos may also be streamed from a website such as YouTube (block 698).

If the user chooses to buy the shared item, the user can be directed to a checkout cart for purchasing the item (604A). Then, once the payment has been successfully completed (block 612A), the rewards associated with that purchase will be distributed (block 613A).

Once an item has been successfully shared or plugged, a message is sent to the MPower server to record the action. Then the shared item can be added to the sharing user's list of items plugged (block 694). The item shared can also be added to the selected user's list of items recommended to them (block 693). When an item is added to a user's list of items that have been recommended to them, the user may receive a notification indicating a new item has been shared. The notification can also include an identification of the item and an identification of the user who originally shared the item with them.

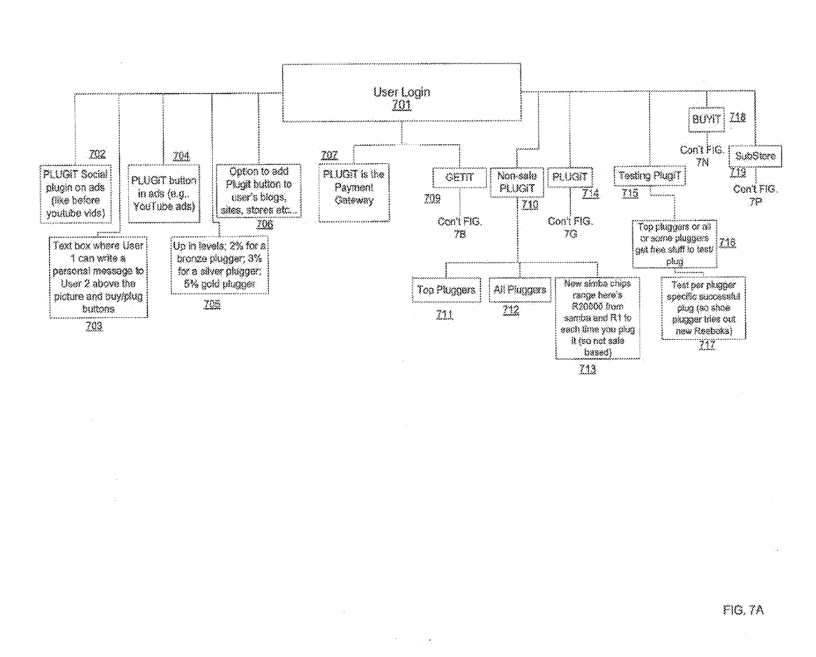

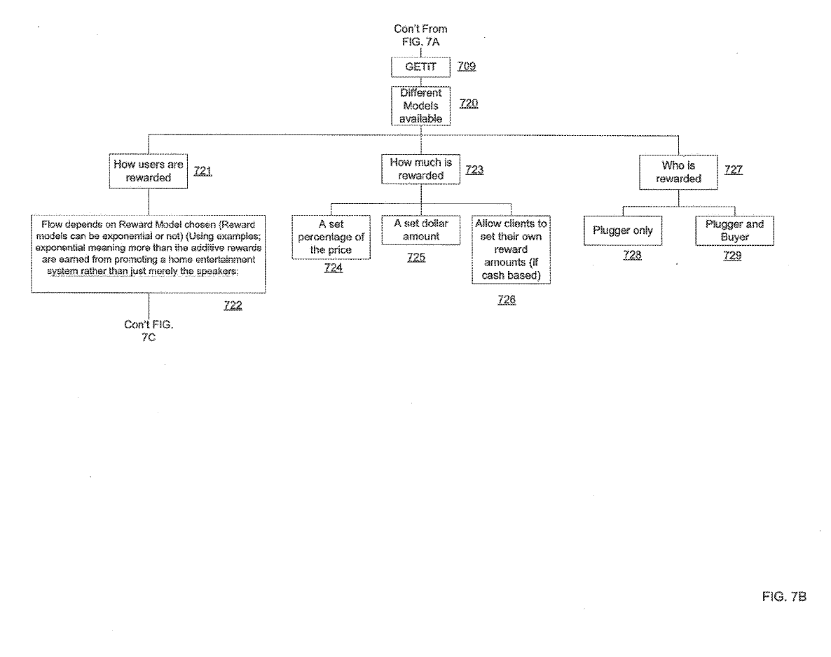

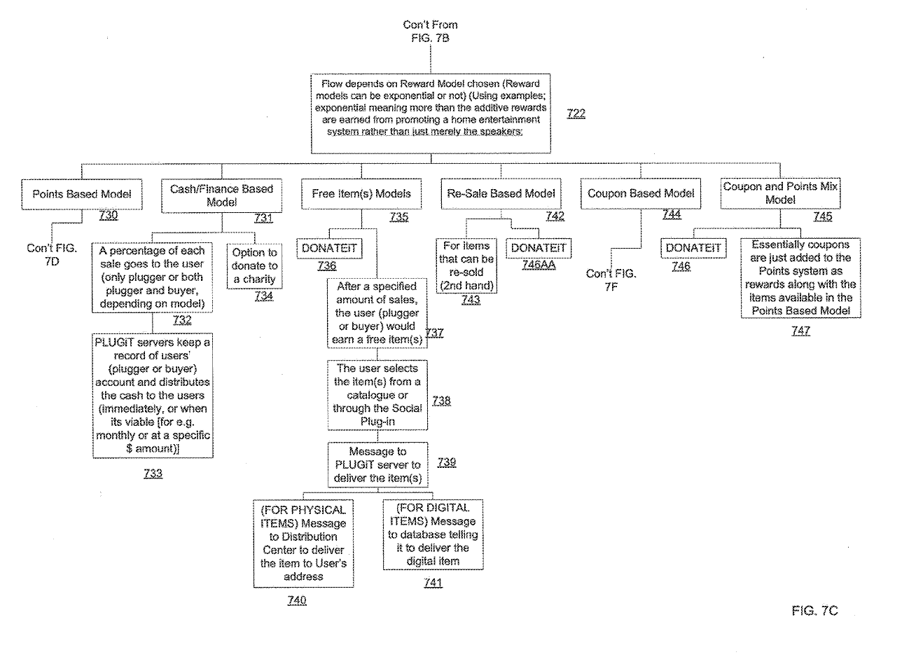

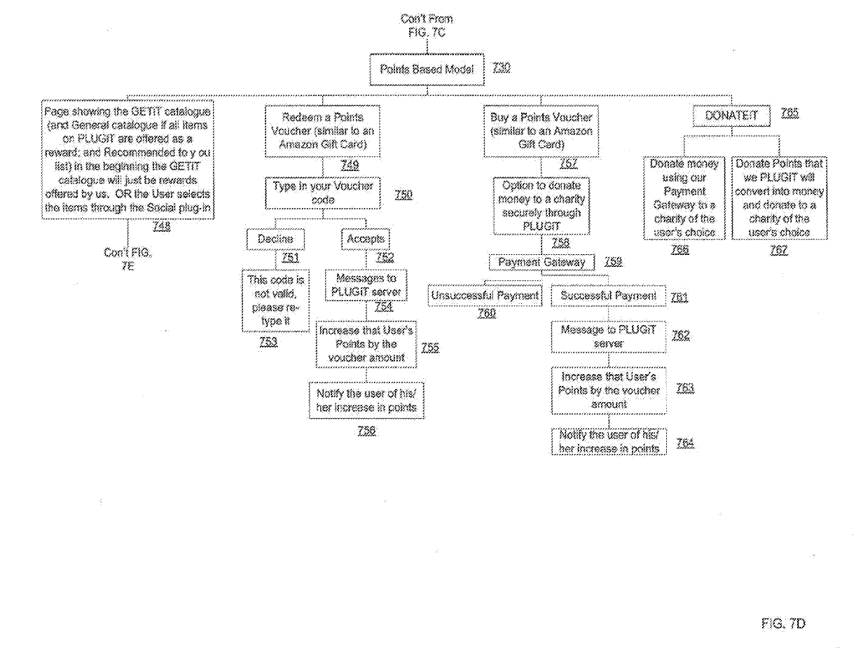

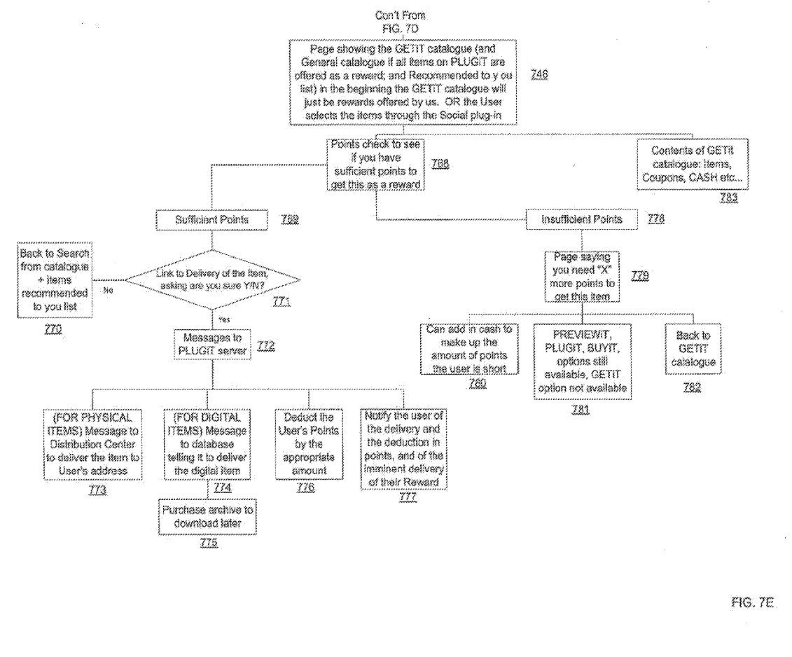

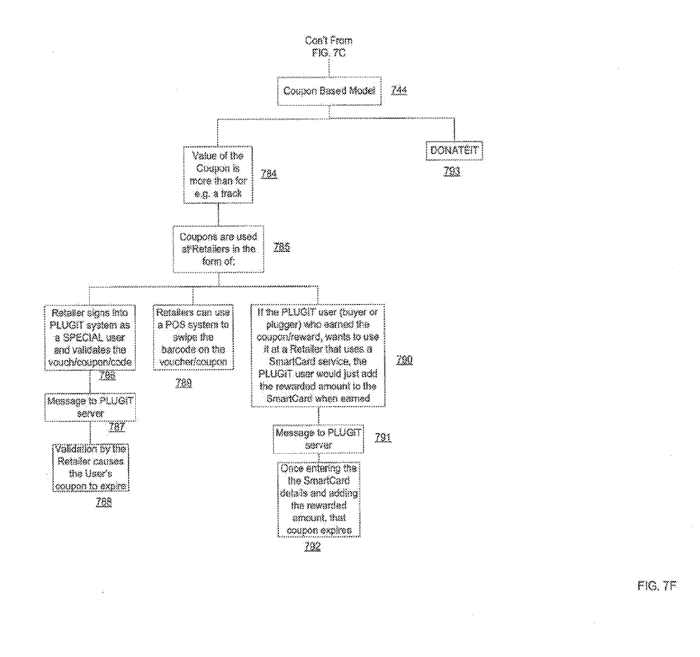

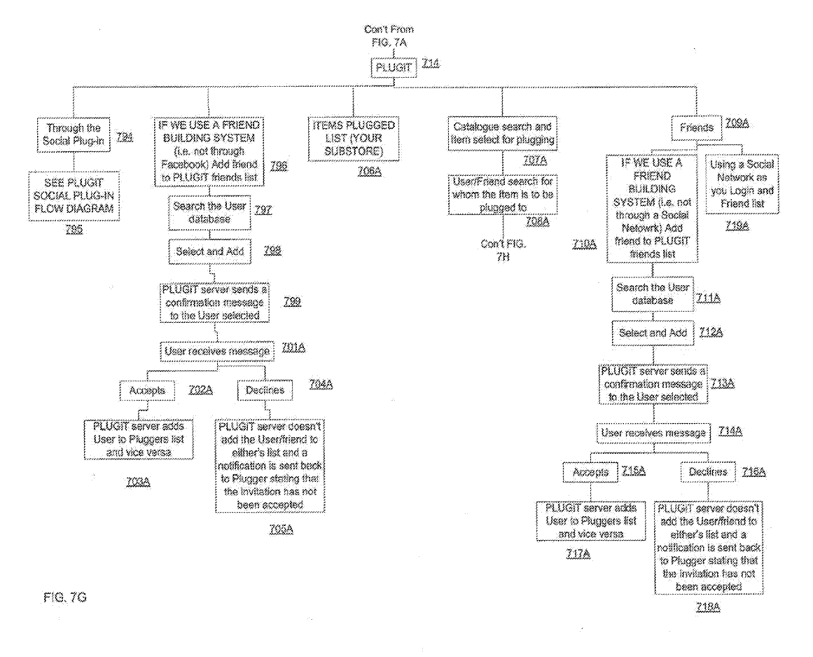

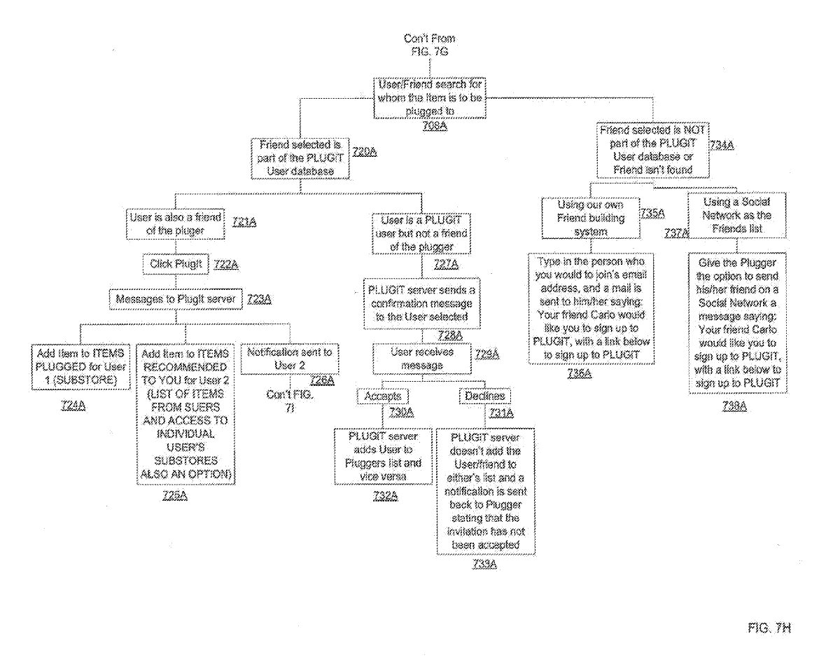

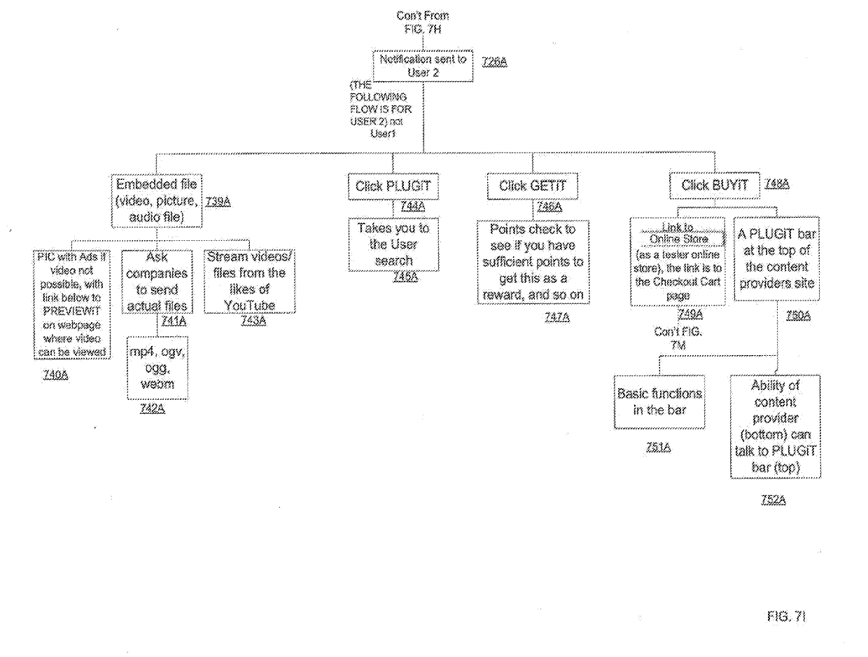

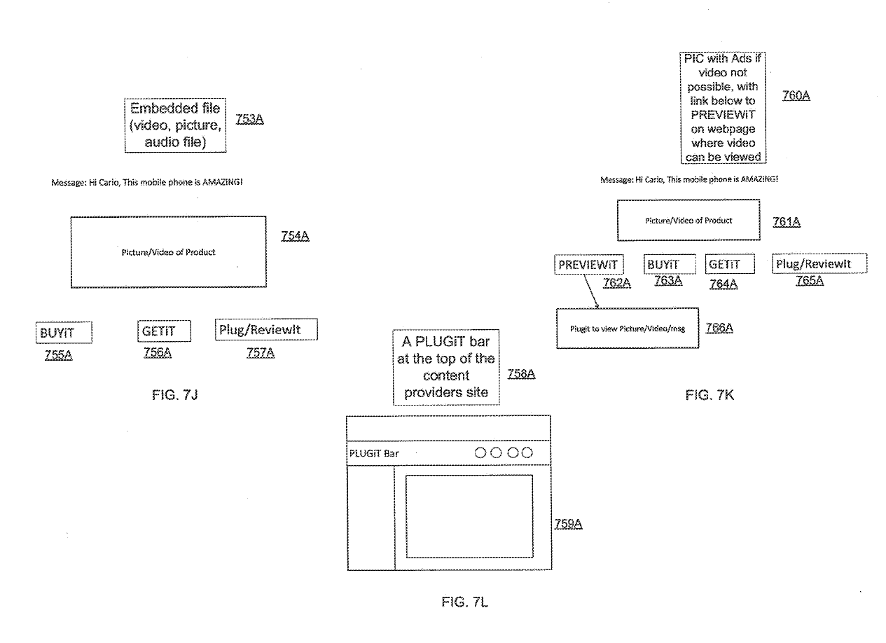

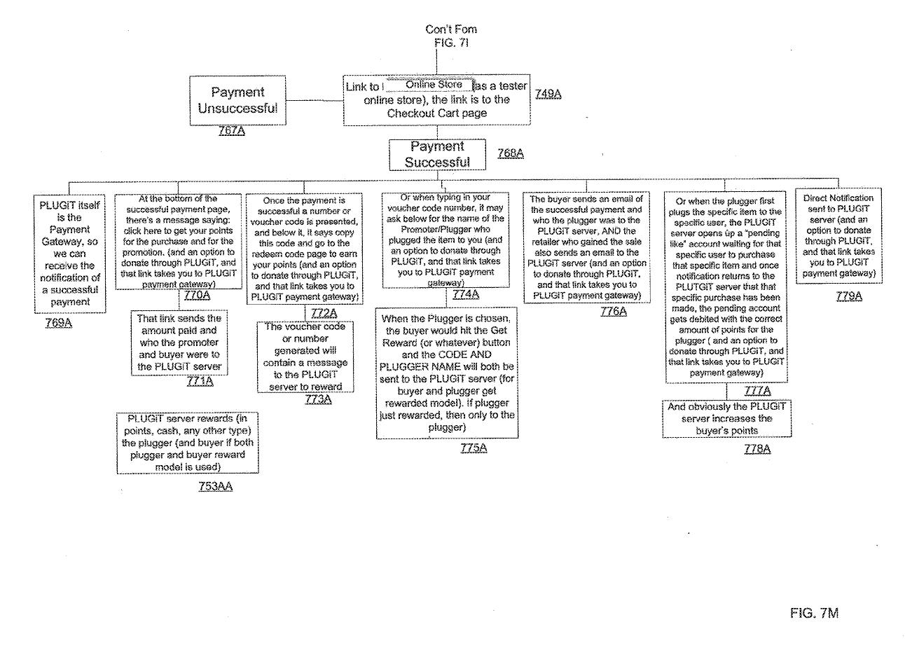

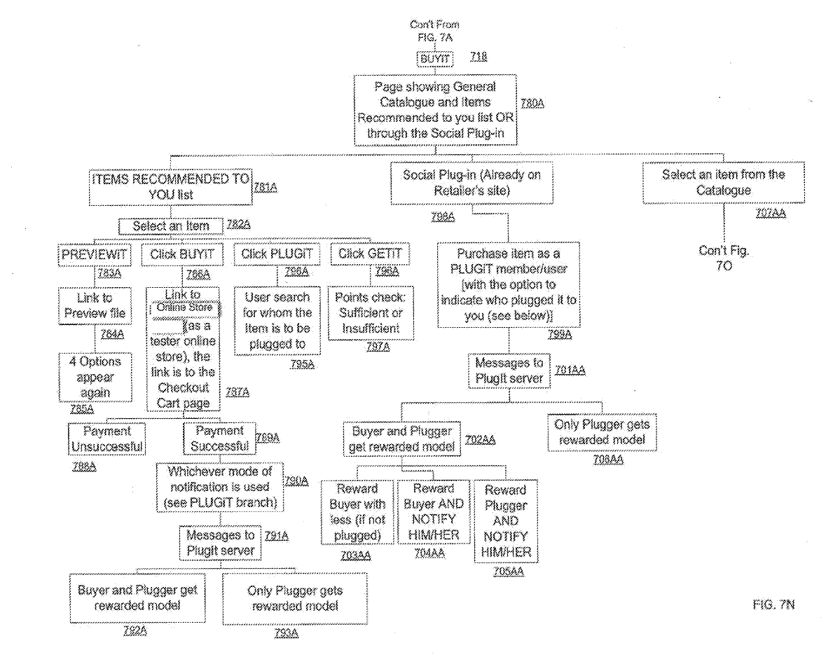

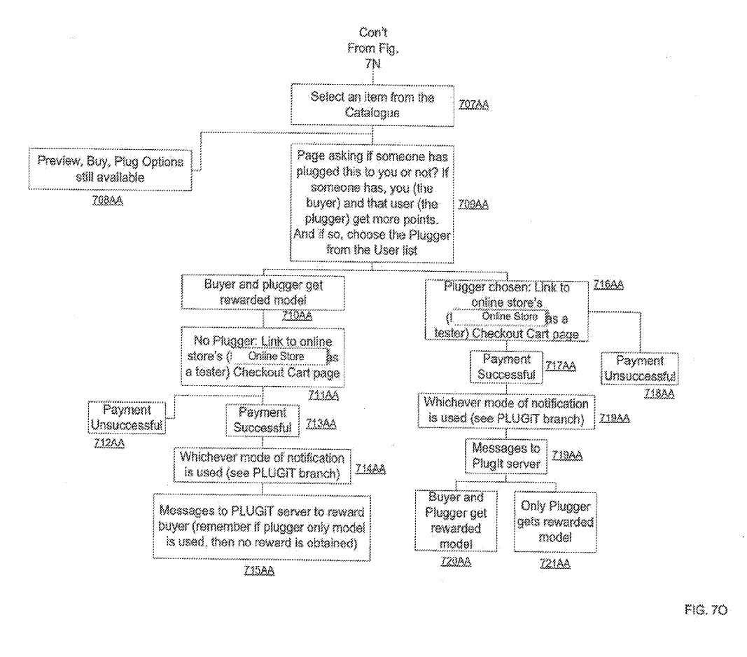

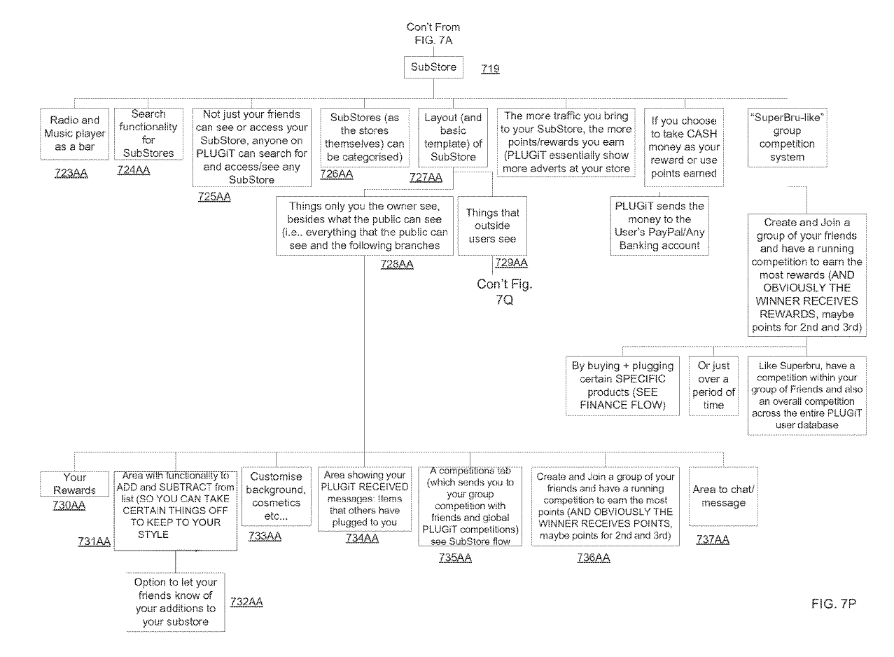

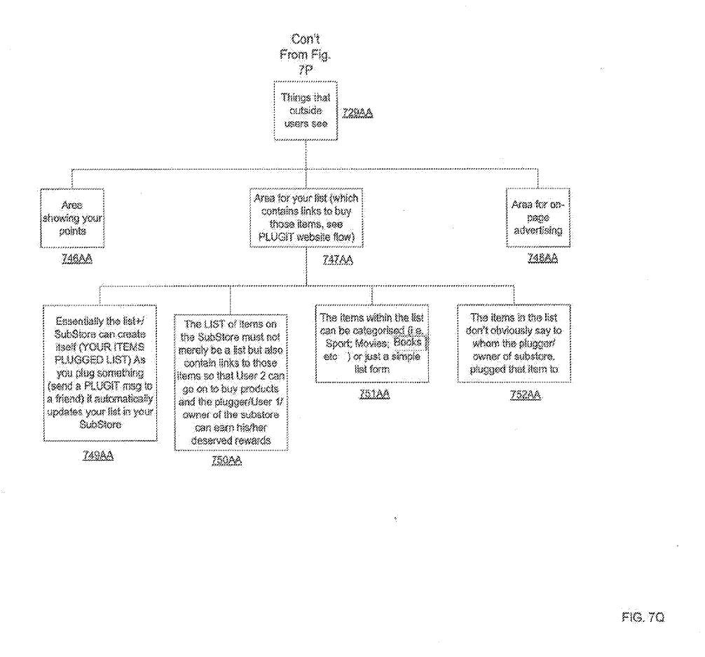

FIG. 6(H) illustrates an example process for distributing rewards earned through the MPower plug process. See also FIG. 7(M). Once a payment has been successfully completed (block 612A), the rewards associated with that purchase will be distributed (block 613A). For example, according to an embodiment, once a successful payment is made, details are captured to record points for the purchase and for the promotion (block 614A). There can also be an option for donating the reward to charity. The details sent can be, for example, the amount paid and who the reviewer and buyer were to the MPower server (block 615A). The server then determines the amount of the reward should be disbursed based on the purchase amount and increases the reviewer's points (block 616A) and, if applicable, increases the buyer's points (block 617A). Then the reviewer and buyer will receive a notification identifying the reward disbursement (block 618A).

According to an embodiment, once the payment is successful, a number or voucher code is presented to the buyer with a message indicating that the buyer should copy this code and go to the “redeem code” page to earn your points (block 619A). There can also be an option for donating the reward to charity. When the buyer redeems the voucher, the redemption generates a message including the voucher code and who the reviewer and buyer were to be sent to the MPower server (block 615A). The server then determines the amount of the reward should be disbursed based on the voucher code and increases the reviewer's points (block 616A) and, if applicable, increases the buyer's points (block 617A). The voucher code can contain a message to the server including amount of points for disbursement. Then the reviewer and buyer will receive a notification identifying the reward disbursement (block 618A).

According to an embodiment, when the buyer redeems the voucher, the redemption system can request that the buyer enter the identity of the reviewer (block 621A). Then a message including the voucher code and who the reviewer and buyer were to be sent to the MPower server (block 615A). The server then determines the amount of the reward should be disbursed and increases the reviewer's points (block 616A) and, if applicable, increases the buyer's points (block 617A).

According to an embodiment, once the payment is successful, multiple messages are generated (block 625A). For example, a message is generated from the buyer including the purchase details and who the reviewer and buyer were is sent to the MPower server (block 615A). A second message is also generated for the Supplier who received the purchase order including the purchase details and who the buyer (and the reviewer possibly, are). The server then determines the amount of the reward should be disbursed based on the payment details and increases the reviewer's points (block 616A) and, if applicable, increases the buyer's points (block 617A). Then the reviewer and buyer will receive a notification identifying the reward disbursement (block 618A).

According to an embodiment, once the reviewer shares an item, the MPower server tracks the share and identifies any follow-up (block 627A). For example, when the reviewer first shares the specific item to the specific user, the server opens up a “pending like” account waiting for that specific user to purchase that specific item. Once notification returns to the server that that specific purchase has been made, the pending account gets debited with the correct amount of points for the reviewer. If applicable, the server also increases the buyer's points (block 617A). Then the reviewer and buyer will receive a notification identifying the reward disbursement (block 618A).

According to an embodiment, once the payment is successful, a direct notification is sent to the MPower signal indicating the disbursement amounts (block 629A). The server then increases the reviewer's points (block 616A) and, if applicable, increases the buyer's points (block 617A) according to the received message. Then the reviewer and buyer will receive a notification identifying the reward disbursement (block 618A).

FIG. 6(I) illustrates a process for purchasing an item according to an embodiment of the present invention. As shown in FIG. 6(I), a user can purchase an item with the BUYiT feature of the MPower system several different ways (block 604). For example, when an item is shared with a user, that item is added to the user's ITEMS RECOMMENDED TO YOU list (block 650A). From that list, the user can select an item to purchase (block 651A). As previously described, once an item is selected, the User can access a GETiT feature (block 655A), a PLUGiT feature (block 654A), a BuyiT feature (block 653A), or a PREVIEWiT feature (block 652A).

For additional detail on the BUYiT feature, see FIGS. 6(G)-(H). For additional detail on the PLUGiT feature, see FIG. 6(F). For additional detail on the GETit feature, see FIGS. 6(B)-(D).

The user can also choose to purchase an item from a plug-in embedded at a Supplier's/retailer's website (block 667A). At the third party website, the user can log-in to their MPower account via the Supplier's plug-in (block 668A). Then user can complete their purchase as managed by the supplier/mPower, and the plug-in generates a message to an MPower reporting the successful completion of the transaction (block 669A). The server will then disburse points or other rewards as appropriate and notify the user(s) of the reward disbursement (blocks 670A-672A).

Additionally, the user can browse the MPower catalog and select an item to purchase (block 673A), as shown in FIG. 6(J). When the user chooses to purchase an item from the catalog, they may be prompted to identify whether the item was plugged or recommended to them by another user (block 675A). If the user does not identify a reviewer, the user will be directed to a checkout cart for purchasing the item (676A). Then, once the payment has been successfully completed (block 678A), the rewards associated with that purchase can be distributed to the buyer (block 680A). Then the buyer will receive a notification identifying the reward disbursement (block 681A). If the user does identify a reviewer, the user will be directed to a checkout cart for purchasing the item (682A). Then, once the payment has been successfully completed (block 683A), the rewards associated with that purchase can be distributed to the buyer and the reviewer (block 686A, 687A). Then the buyer and reviewer will receive notifications identifying the reward disbursement (block 688A, 689A).

FIGS. 6(K) and 6(L) illustrate an example set of features available with the substore option of the MPower system. For a detailed description of the substore, see the discussion of FIG. 12 herein.

FIG. 7(A) illustrates an example of the options available for a user when they log on to the MPower website. For data efficiency purposes, if the user is in an area of poor Internet connection speed, the page will load with a less intensive display setting. From the log in page, the user has several different navigation and interaction options (block 701). For example, there is an option for a Social plug-in on advertisements (block 702), a button embedded in ads (block 704), an option to add buttons to the user's blogs, websites, stores, etc. (block 706), a text box for exchanging messages with other users (block 703), and a display indicating the users status within the system (block 705), for example, the user may be a bronze plugger and receive 2% of payments they initiate through a plug or review, a silver plugger and get 3%, or a gold plugger and get 5%. The user can also access their payment gateway for making secure payments after the user logs into their MPower account (block 707). Other options can include accessing the GETiT feature (block 709), accessing the BUYiT feature (block 718), and accessing a user's substore (block 719). There can also be several PLUGiT options. For example, the user can perform a non-sale plug (block 710) with access for top pluggers (block 710) or all pluggers (block 712). The user can access the PLUGiT feature (block 714) or can access a testing room (block 715) where some pluggers get free stuff to test and plug (block 716). The pluggers with access to the test plugs can get targeted free items that relate to items they have successfully plugged in the past.

FIG. 7(B) illustrates example options that will determine how users are rewarded as part of the GETiT feature (block 709). As shown in FIG. 7(B), there are potentially several models for assigning awards (block 720). For example, the amount that users are rewarded (block 723) can be determined as a set percentage of the price (block 724), a set dollar amount (block 725), and may provide the option to allow Suppliers to set reward amounts (block 726). Additionally, when determining who will be rewarded (block 727), either only the plugger will be rewarded (block 728) or both the plugger and the buyer can be rewarded (block 729).

The process by which users are rewarded depends on the reward model being used (block 722). For more on awarding users, see the discussion of FIGS. 6(B) to (E) above. FIG. 7(C) illustrates an example process for using the GETiT feature. For additional detail about this figure, see the discussion of FIG. 6(B) above. FIGS. 7(D)-(E) illustrate an example process for redeeming rewards with a points based model (block 730). For additional detail about these figures, see the discussion of FIGS. 6(E)-(G). FIG. 7(F) illustrates an example process for redeeming coupons in a coupon based rewards system (block 744). For additional detail about this figure, see the discussion of FIG. 6(E).

FIGS. 7(G) to (I) illustrate an example process for using the PLUGiT feature (block 714). For additional detail about these figures, see the discussion of FIGS. 6(F)-(G). Specifically, FIG. 7(H) illustrates example options for a user from a received share message (block 726A). From a received message, the recipient can view the shared item and select one or more actions. For example, the recipient can plug or share the item as previously described (block 744A); can see additional information about the item; if applicable, can redeem rewards to get the item as previously described (block 746A); or can buy the item (block 748A).

The information about the item that the selected user can access from the notification message can include one or more of the following: an embedded video, picture, or audio file embedded in the notification or a link to any of them (block 739A). If video is not available on the webpage, a picture with/without ads will be presented with a link to the video (block 740A). The files can be retrieved directly from a supplier or other third party (block 741A). For example, such files may include mp4 files, ogv files, ogg files, or webm files. Videos may also be streamed from a website such as YouTube (block 743A).

If the user chooses to buy the shared item, the user can be directed to a checkout cart for purchasing the item (749A). The user can also access a PLUGiT bar from a content provider's site (block 750A). The content bar will provide access to all the basic MPower functions (block 751A) and the content provider will be able to exchange information with the bar (block 752A).

FIG. 7J illustrates an example of a message with embedded media. As shown, the message can include a short greeting from the reviewer, a picture or video of the item being plugged 754A, and options for the recipient to buy the item 755A, get the item 756A, or review the item 757A.

FIG. 7L illustrates an example of a PLUGiT bar implemented at a content provider's website. FIG. 7K illustrates a message with an additional link to content that might not be available via the message. As shown, the message can include a short greeting from the reviewer, a picture or video of the item being plugged 761A, and options for the recipient to buy the item 763A, get the item 764A, review the item 765A, or preview the item 762A via the attached link 766A.

FIG. 7(M) illustrates an example process for distributing rewards earned through the MPower plug process. Once a payment has been successfully completed (block 768A), the rewards associated with that purchase will be distributed. For example, according to an embodiment, at the bottom of the successful payment page, there's a message saying: click here to get your points for the purchase and for the promotion (block 770A). There can also be an option for donating the reward to charity. When the buyer selects that link, it sends the amount paid and who the reviewer and buyer were to the MPower server (block 771A). The server then determines the amount of the reward that should be disbursed based on the purchase amount and increases the reviewer's reward and/or buyer's reward (block 753AA). The reward can be points, cash, voucher, or a disbursement in accordance with any other reward method.

According to an embodiment, once the payment is successful, a number or voucher code is presented to the buyer with a message indicating that the buyer should copy this code and go to the “redeem code” page to earn your points (block 772A). There can also be an option for donating the reward to charity. When the buyer redeems the voucher, the redemption generates a message to be sent to the MPower server and directing the server to disburse the reward (block 773A).

According to an embodiment, when the buyer redeems the voucher, the redemption system can request that the buyer enter the identity of the reviewer (block 774A). Then a message is sent to the MPower server directing the reward payouts (block 775A).

According to an embodiment, once the payment is successful, multiple messages are generated (block 776A). For example, a message is generated from the buyer including the purchase details and who the reviewer and buyer were is sent to the MPower server.

A second message is also generated for the Supplier who received the purchase order including the purchase details and who the buyer (and the reviewer possibly, are).

According to an embodiment, once the reviewer shares an item, the MPower server tracks the share and identifies any follow-up (block 777A). For example, when the reviewer first shares the specific item to the specific user, the server opens up a “pending like” account waiting for that specific user to purchase that specific item. Once notification returns to the server that that specific purchase has been made, the pending account gets debited with the correct amount of points for the reviewer. If applicable, the server also increases the buyer's points (block 778A).

According to an embodiment, once the payment is successful, a direct notification is sent to the MPower signal indicating the disbursement amounts (block 779A). Additionally, the PLUGiT is the payment gateway so notifications of successful payments are also received (block 769A).

FIGS. 7(N) to (O) illustrate a process for purchasing an item according to an embodiment of the present invention. For additional detail about these figures, see the discussion of FIGS. 6(I) and 6(J). FIGS. 7(P) and 7(Q) illustrate an example set of features available with the substore option of the MPower system. For a detailed description of the substore, see the discussion of FIG. 12 herein.

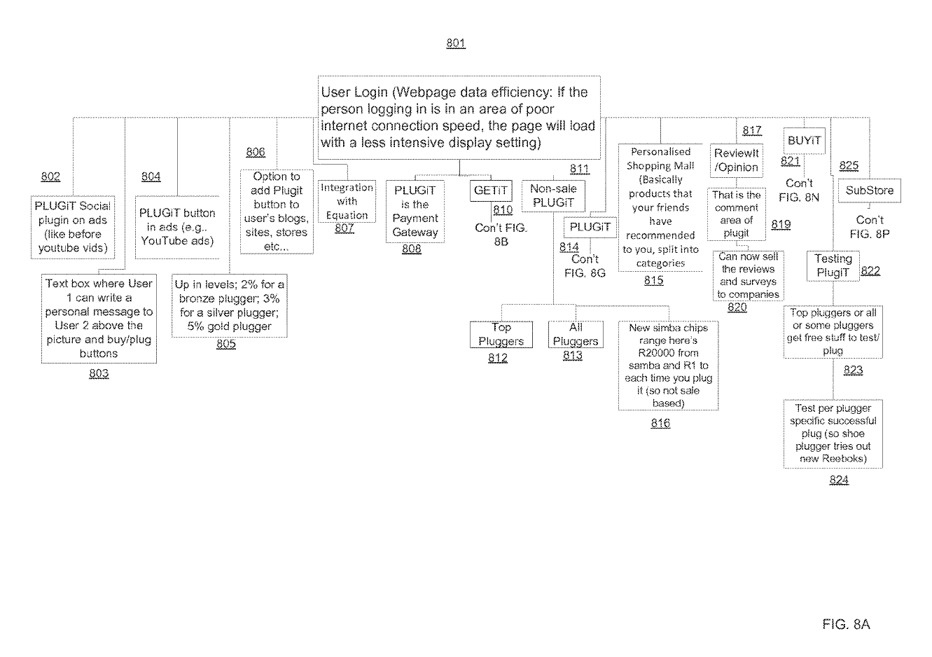

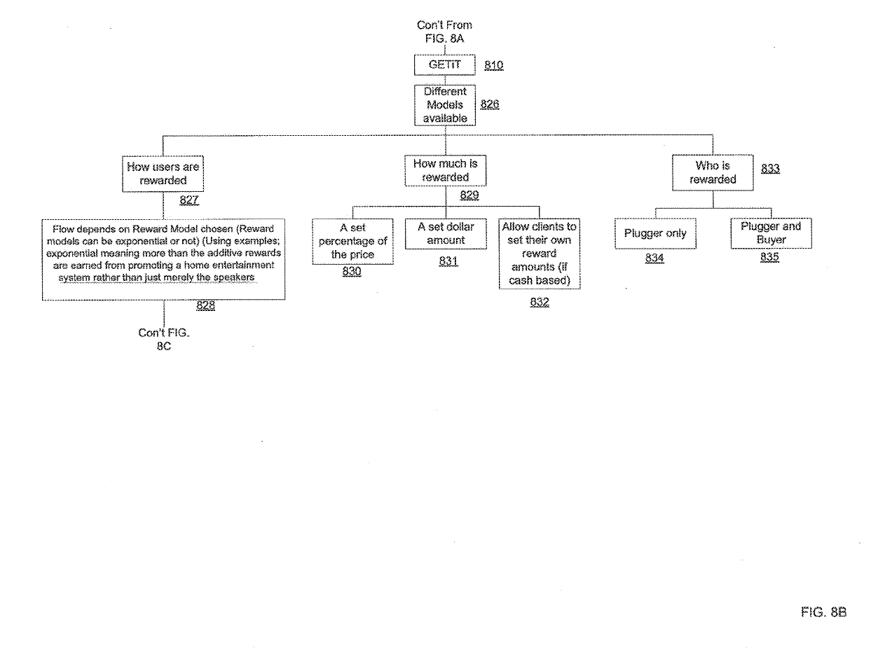

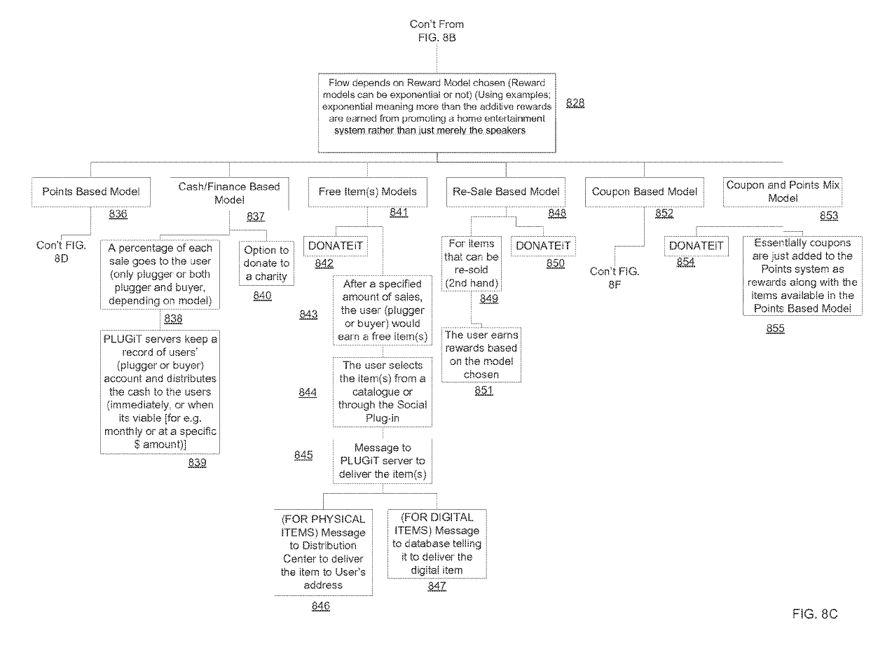

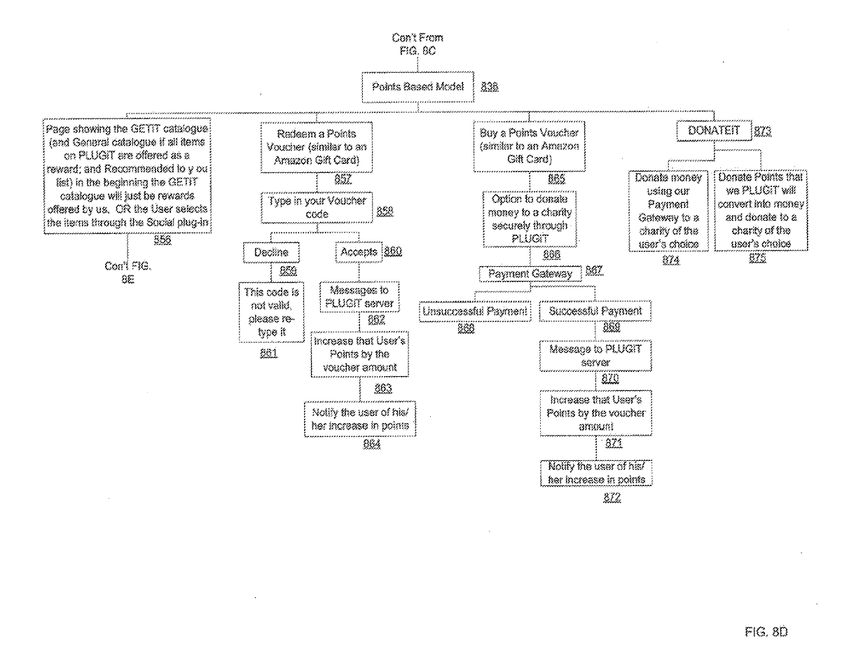

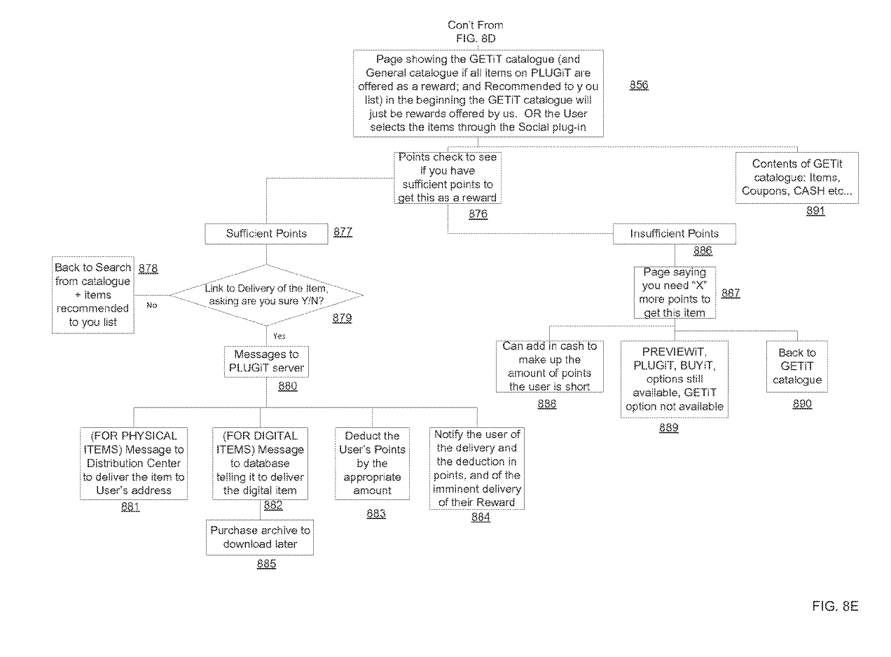

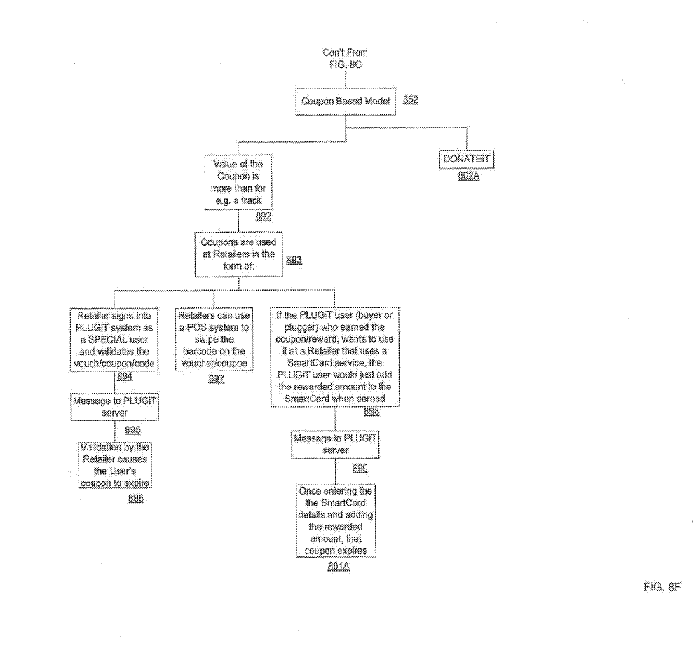

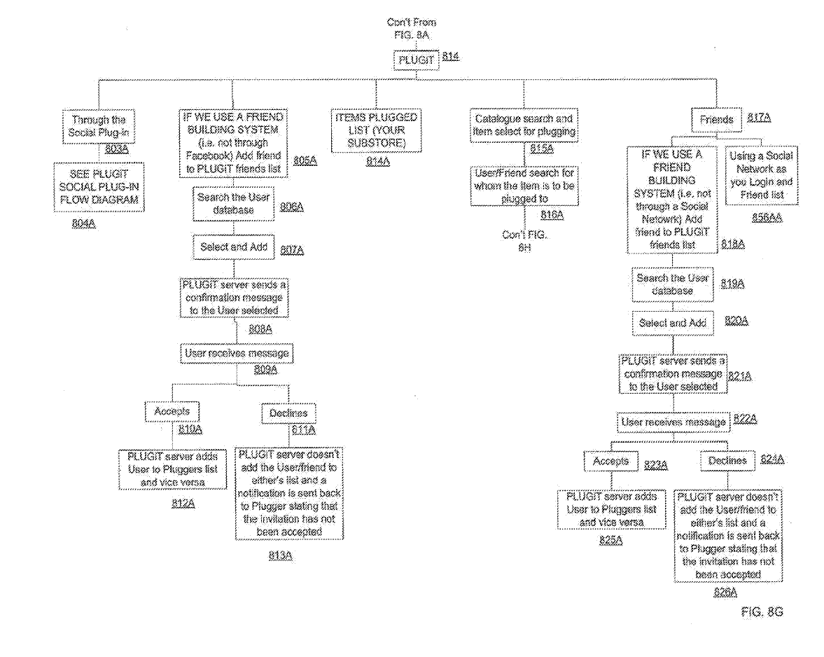

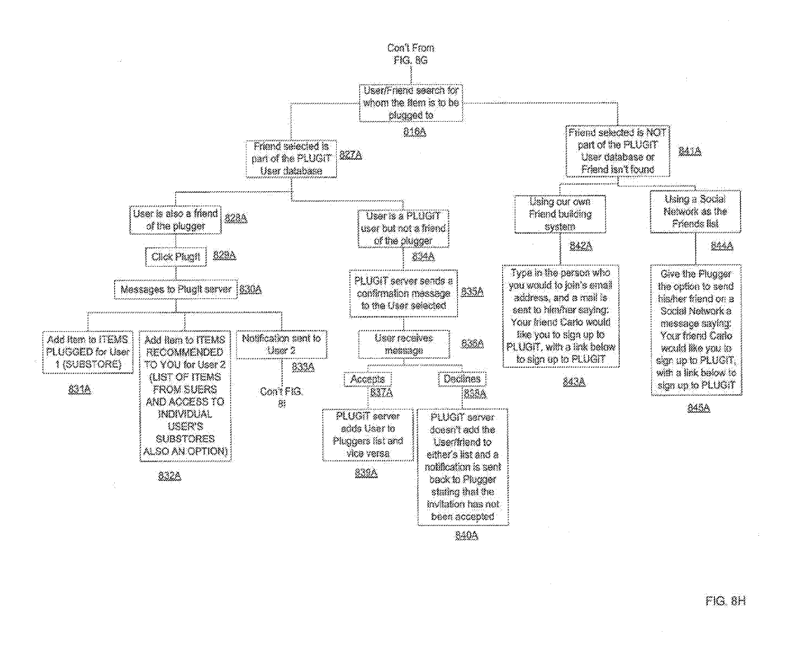

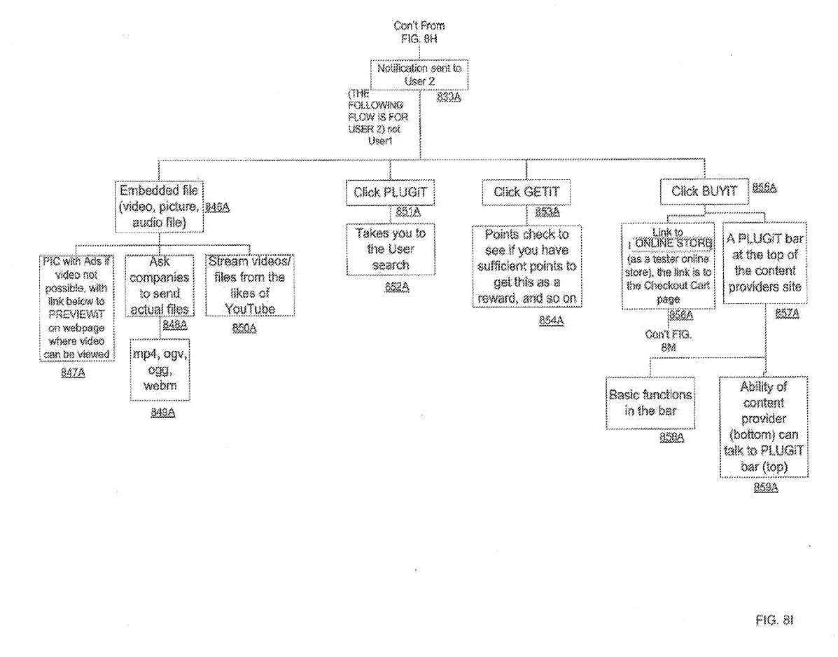

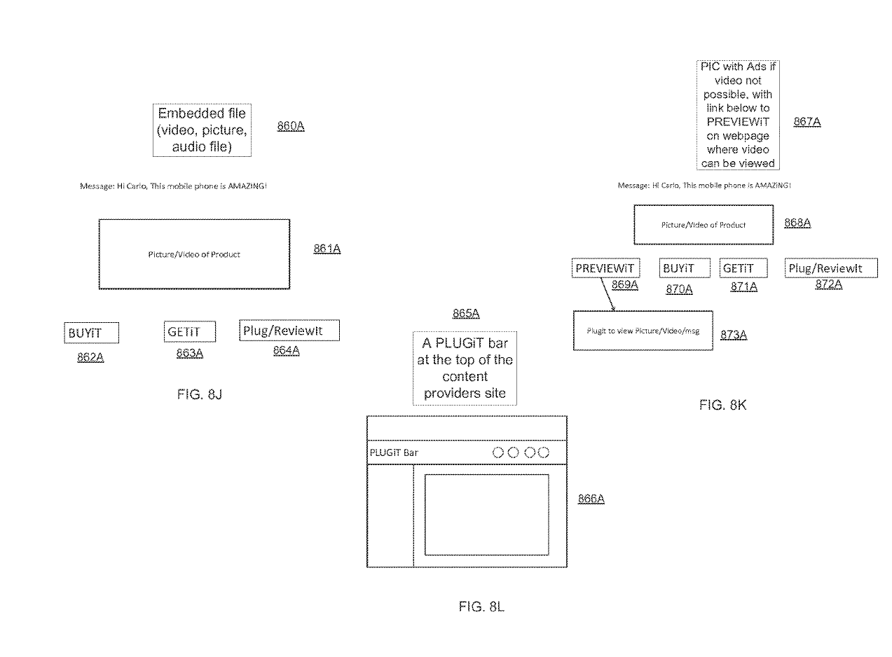

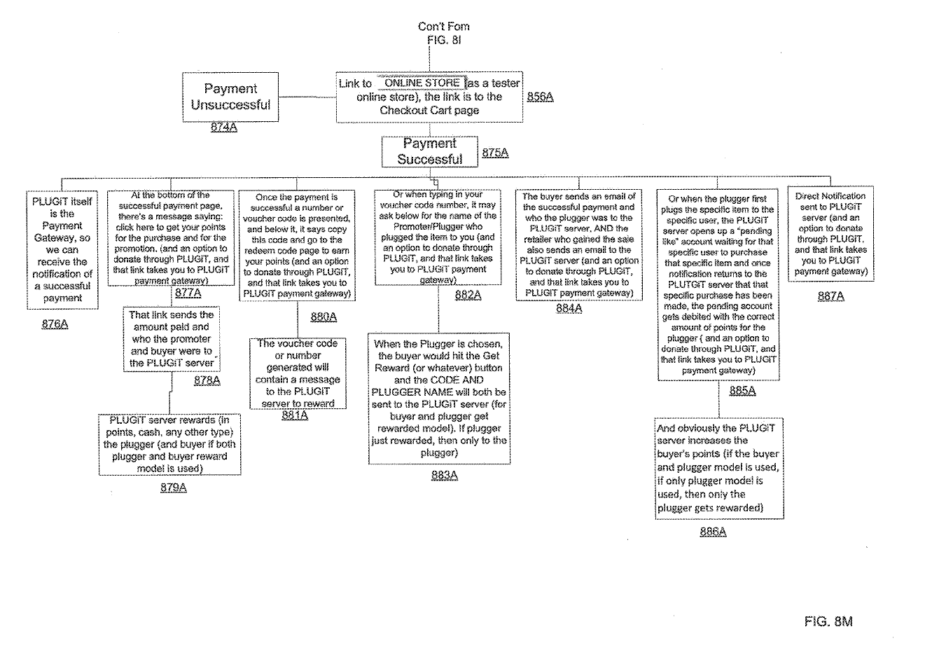

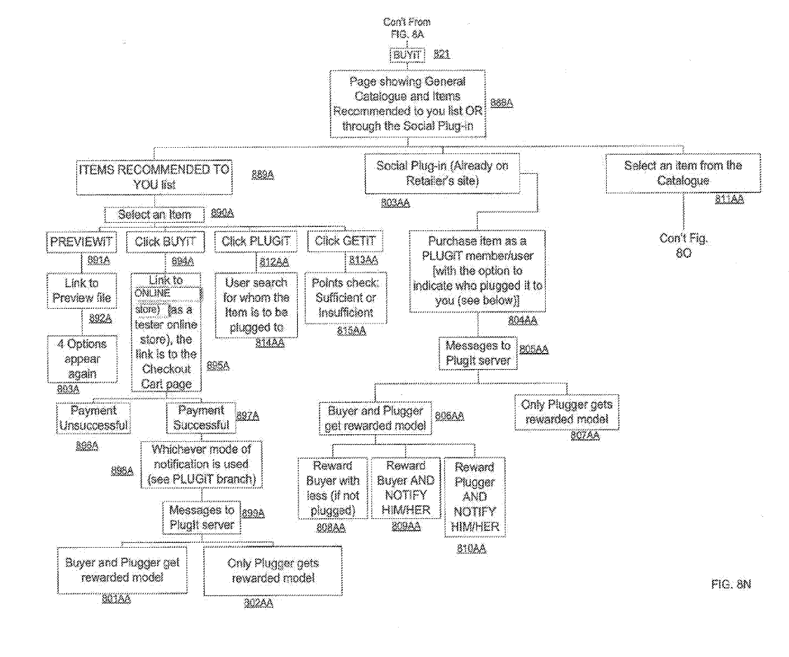

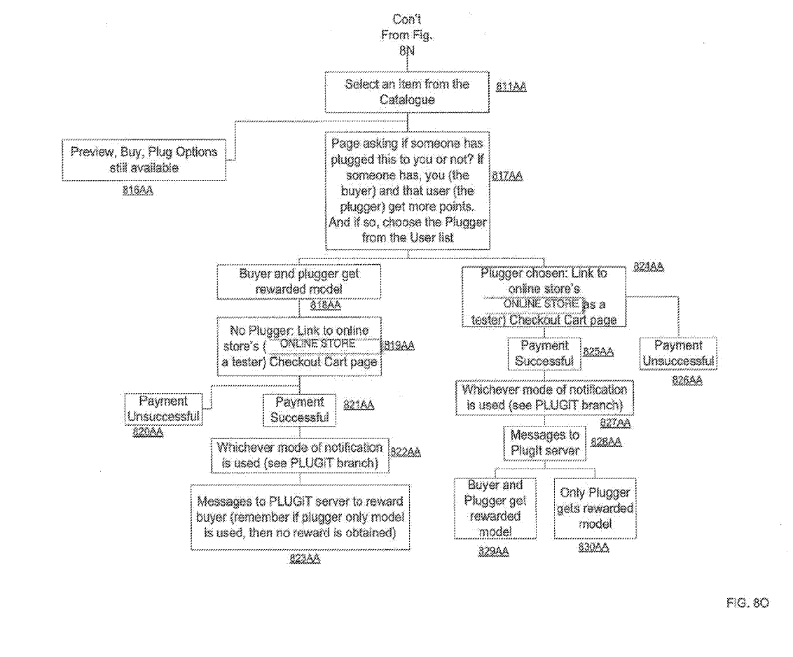

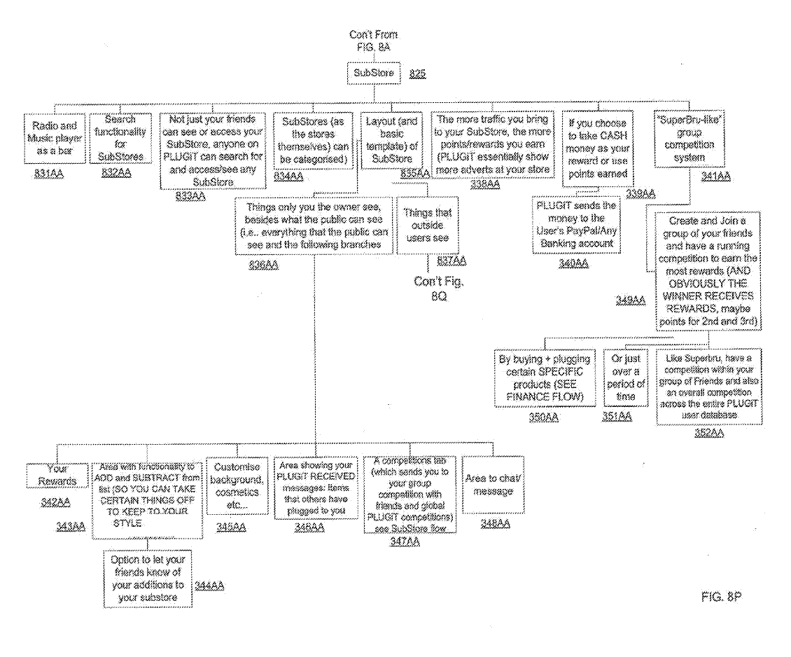

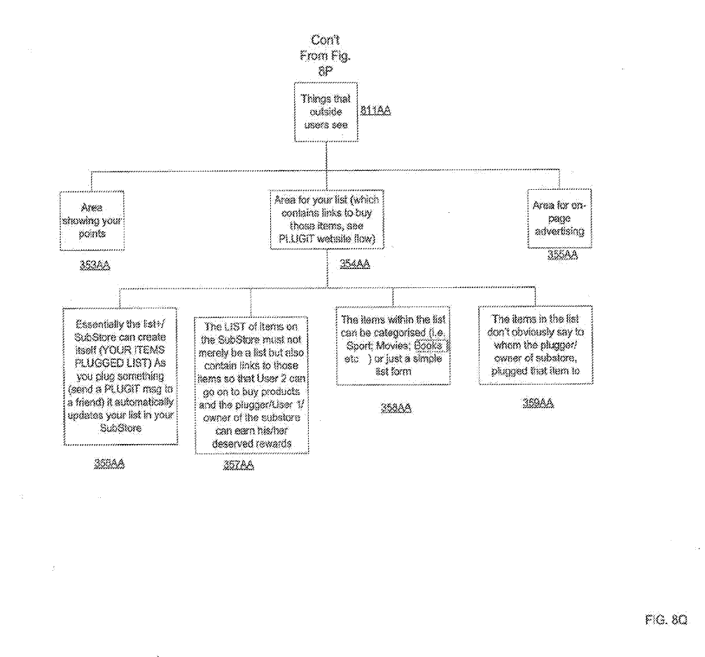

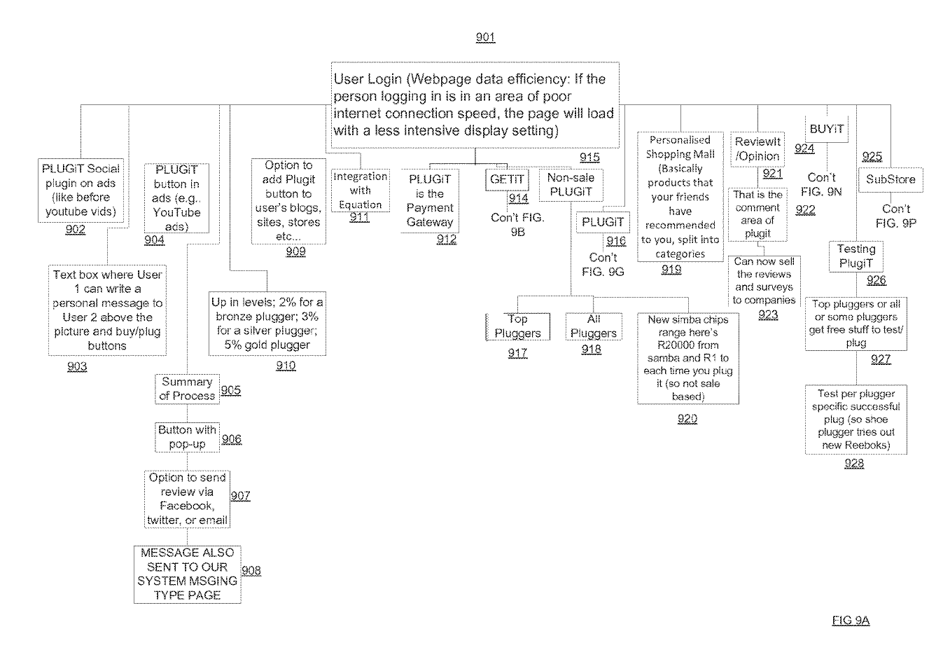

FIG. 8(A) illustrates an example of the options available for a user when they log on to the MPower website. For a detailed description of these options, see the discussion of FIG. 7(A) herein. Additional available options may include an integration with equation (block 807), access to a personalized shopping mall containing the products and items that user's in a friend's list have recommended or shared, sorted for each of searching (block 815), and a review it/opinion option (block 817).

FIG. 8(B) illustrates example options to determine how users are rewarded as part of the GETiT feature (block 810). For additional details about this figure, see the discussion of FIG. 7(B).

The process by which users are rewarded depends on the reward model being used (block 828). For more on awarding users, see the discussion of FIGS. 6(B) to (E) above. FIG. 8(C) illustrates an example process for using the GETiT feature. For additional detail about this figure, see the discussion of FIG. 6(B) above. FIGS. 8(D)-(E) illustrate an example process for redeeming rewards with a points based model (block 836). For additional detail about these figures, see the discussion of FIGS. 6(E)-(G). FIG. 8(F) illustrates an example process for redeeming coupons in a coupon based rewards system (block 852). For additional detail about this figure, see the discussion of FIG. 6(E).

FIGS. 8(G) to (I) illustrate an example process for using the PLUGiT feature (block 814). For additional detail about these figures, see the discussion of FIGS. 6(F)-(G) and FIGS. 7(G) to (I). FIG. 8J illustrates an example of a message with embedded media. As shown, the message can include a short greeting from the reviewer, a picture or video of the item being plugged 861A, and options for the recipient to buy the item 862A, get the item 863A, or review the item 864A.

FIG. 8L illustrates an example of a PLUGiT bar implemented at a content provider's website. FIG. 8K illustrates a message with an additional link to content that might not be available via the message. As shown, the message can include a short greeting from the reviewer, a picture or video of the item being plugged 868A, and options for the recipient to buy the item 869A, get the item 870A, review the item 871A, or preview the item 872A via the attached link 873A.

FIG. 8(M) illustrates an example process for distributing rewards earned through the MPower plug process. For additional detail about this figure, see the discussion of FIG. 7(M) above.

FIGS. 8(N)-(O) illustrate a process for purchasing an item according to an embodiment of the present invention. For additional detail about these figures, see the discussion of FIGS. 6(I) and 6(J). FIGS. 8(P) and 8(Q) illustrate an example set of features available with the substore option of the MPower system. For a detailed description of the substore, see the discussion of FIG. 12 herein.

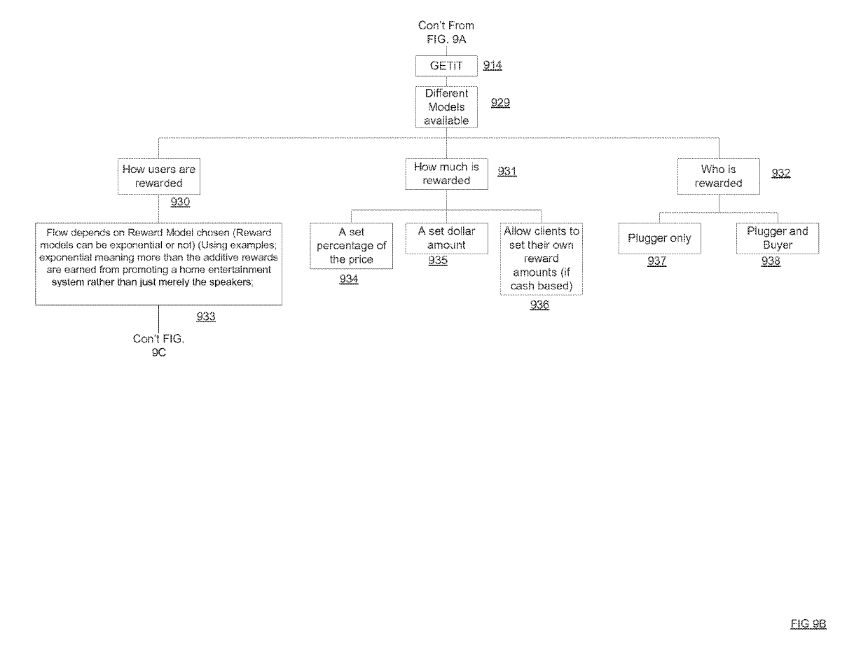

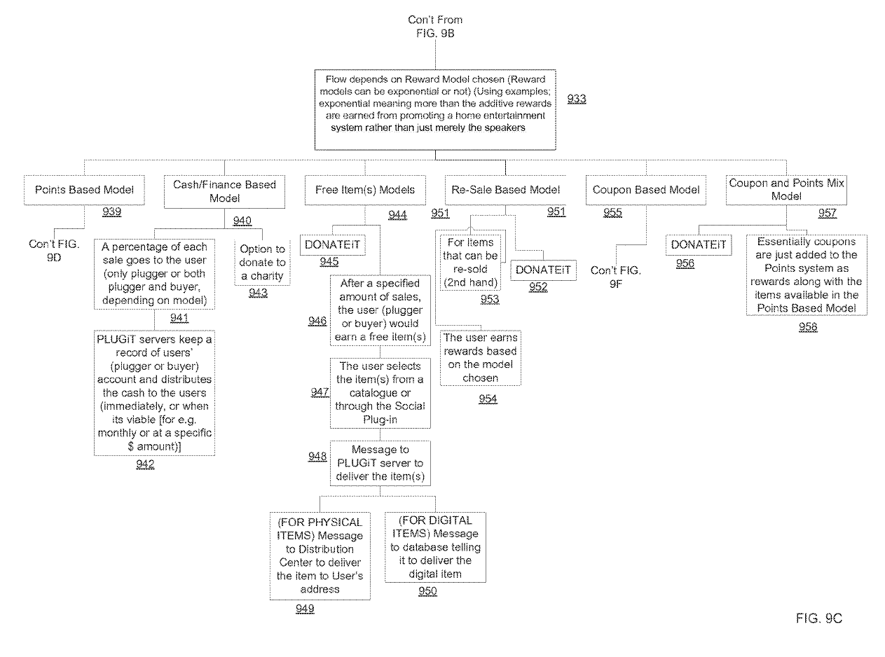

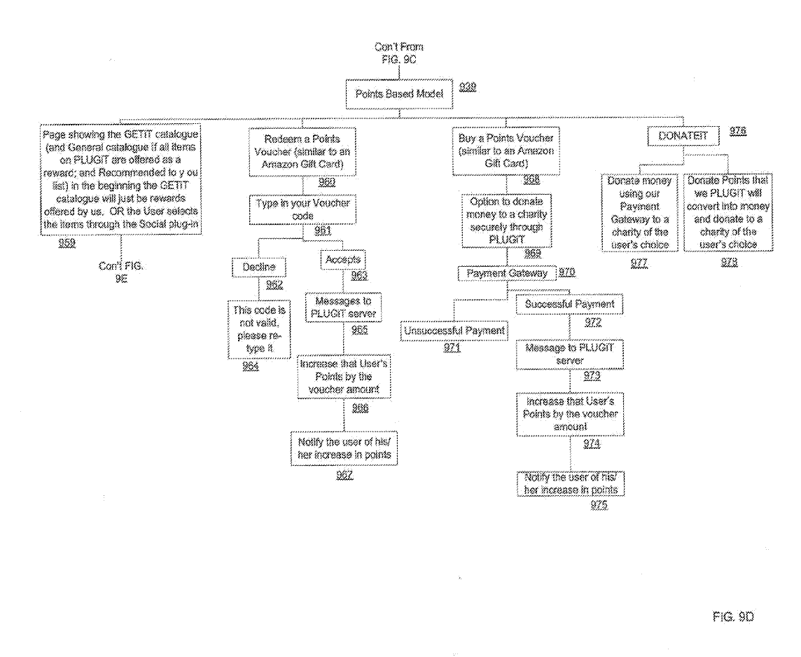

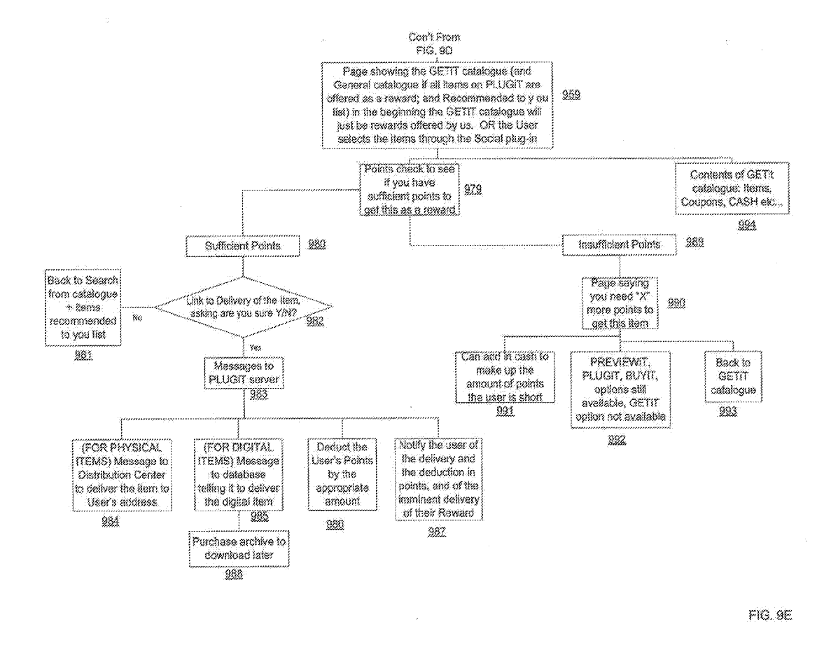

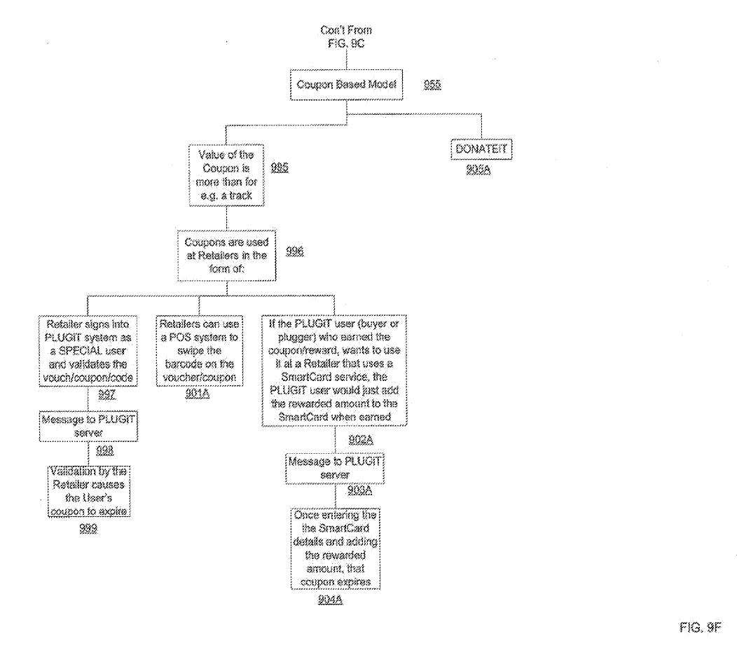

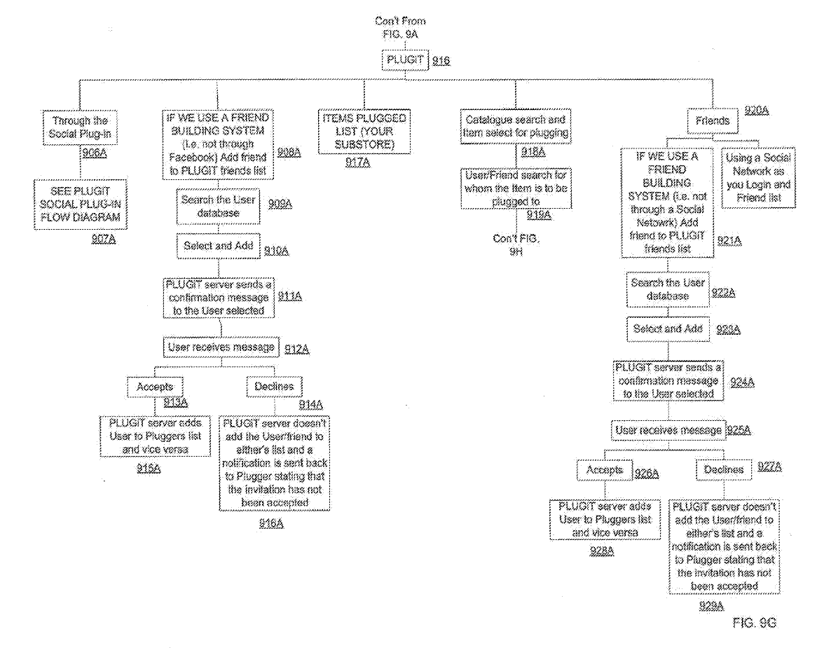

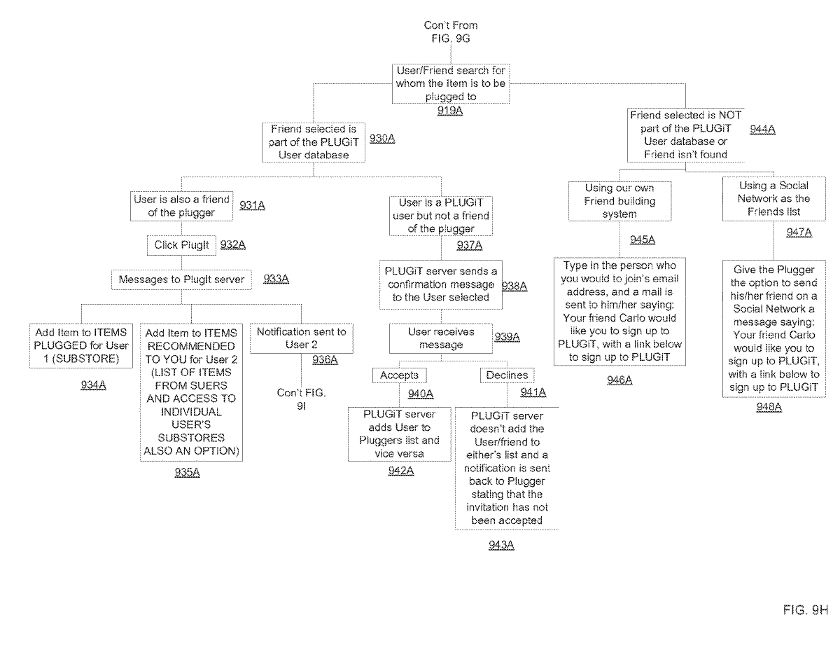

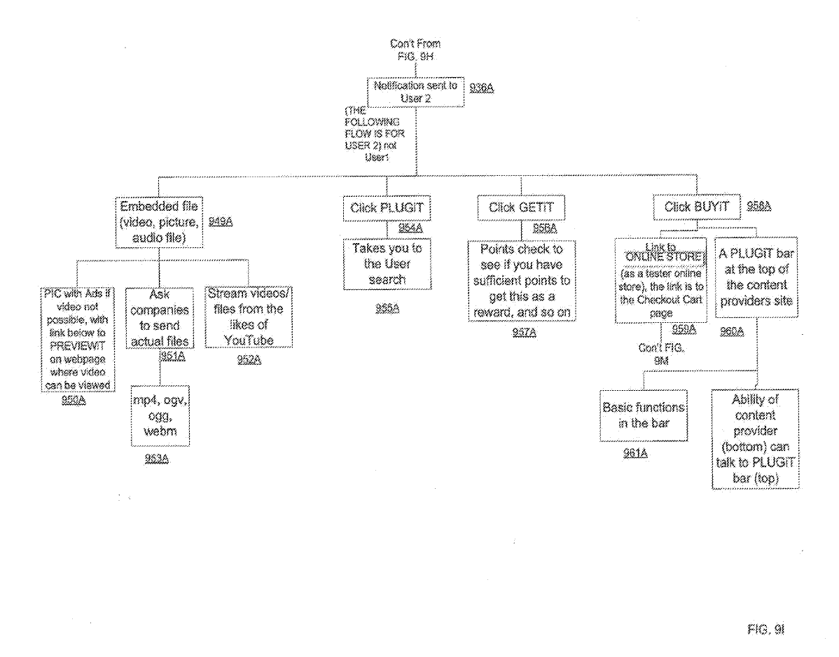

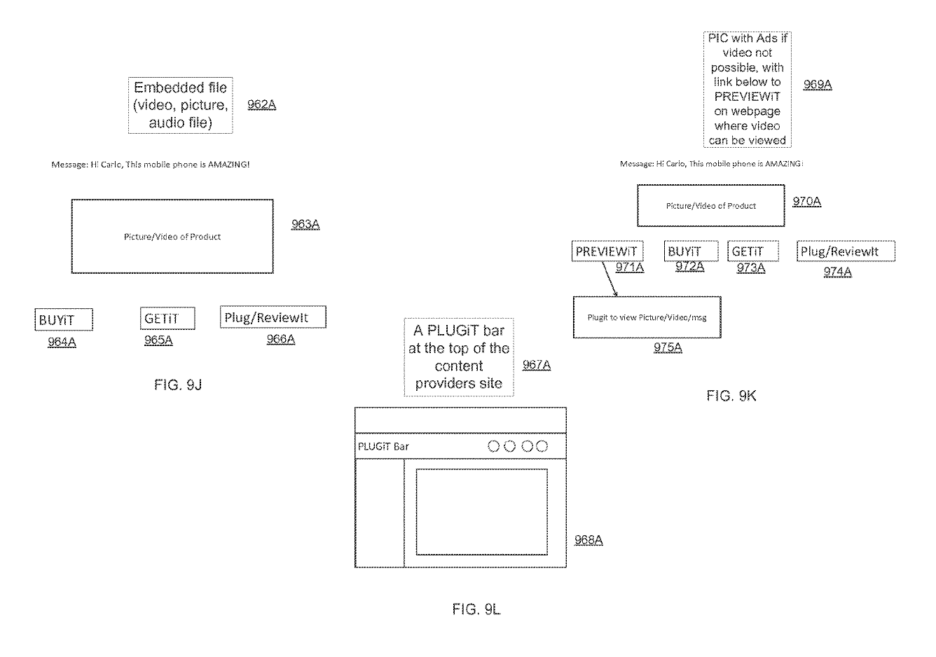

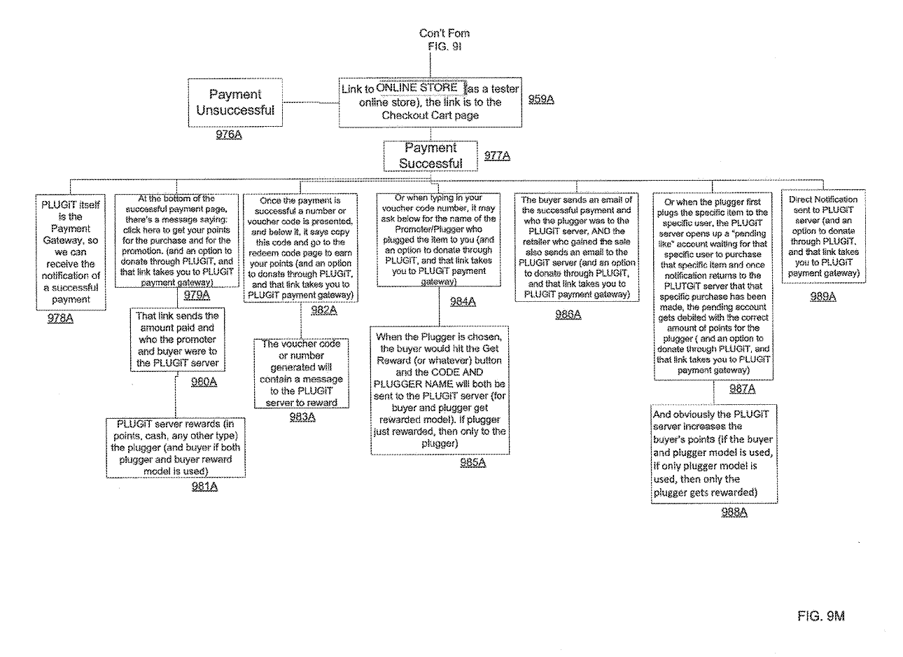

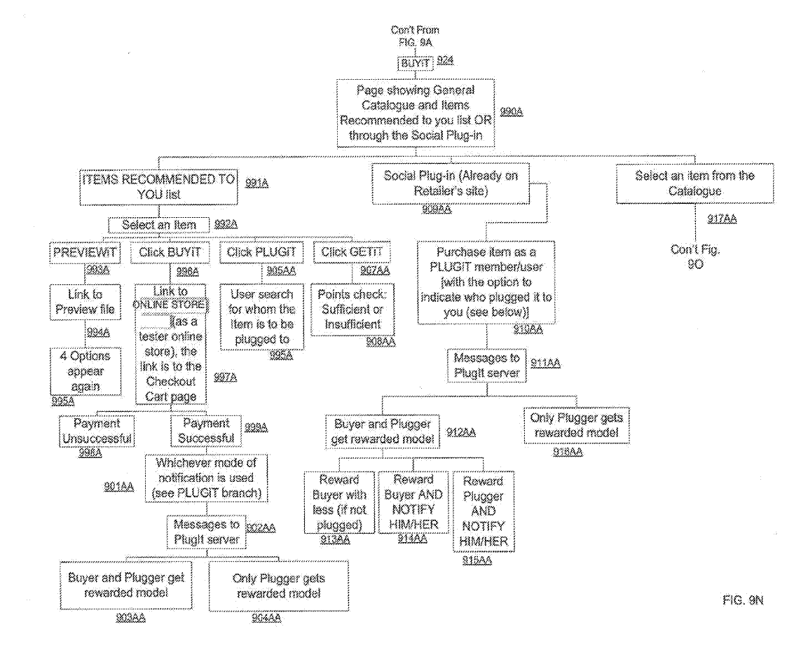

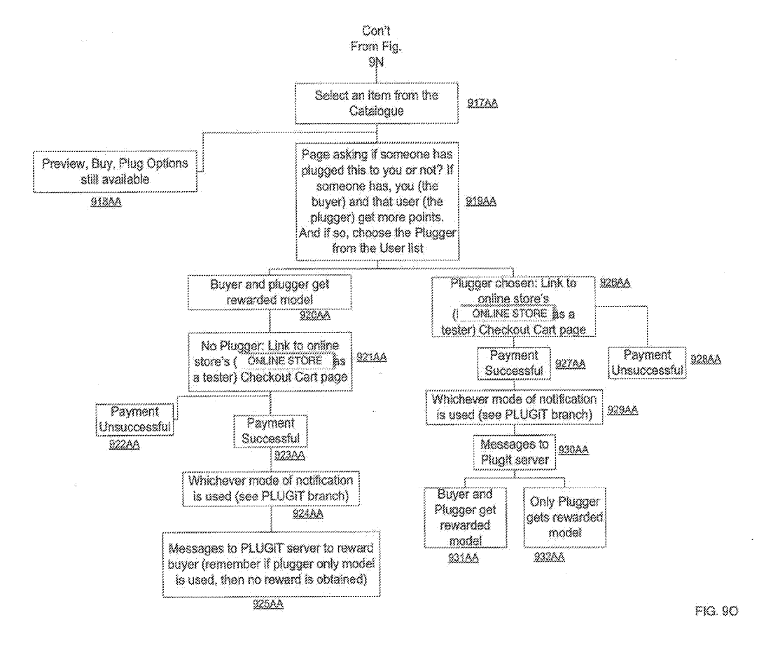

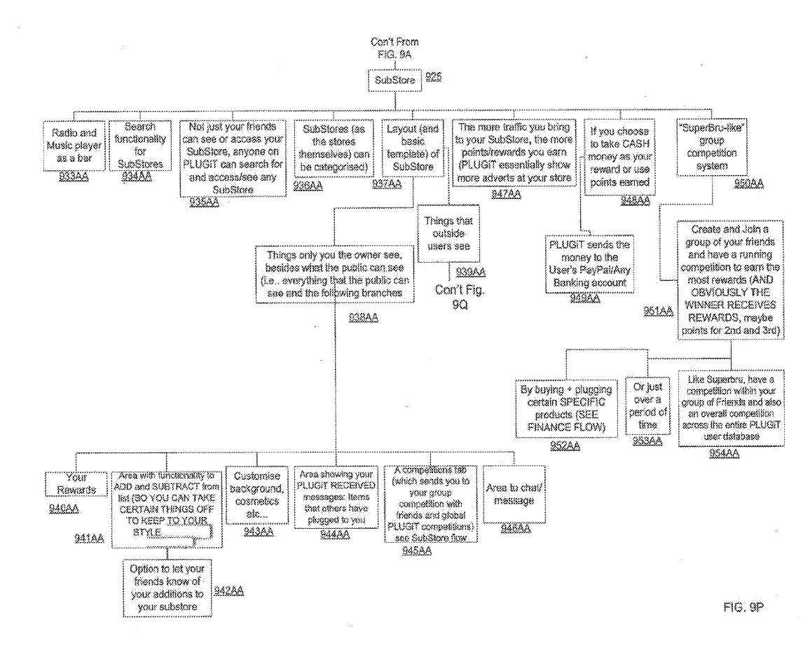

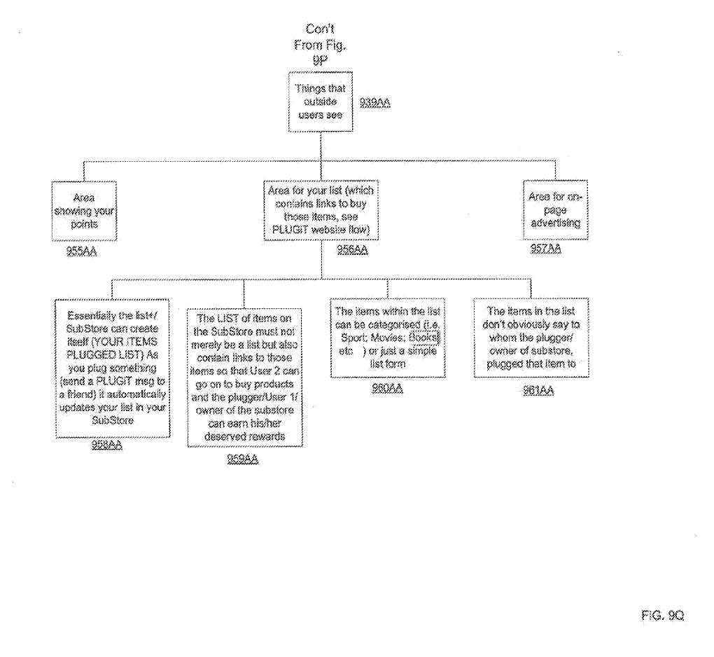

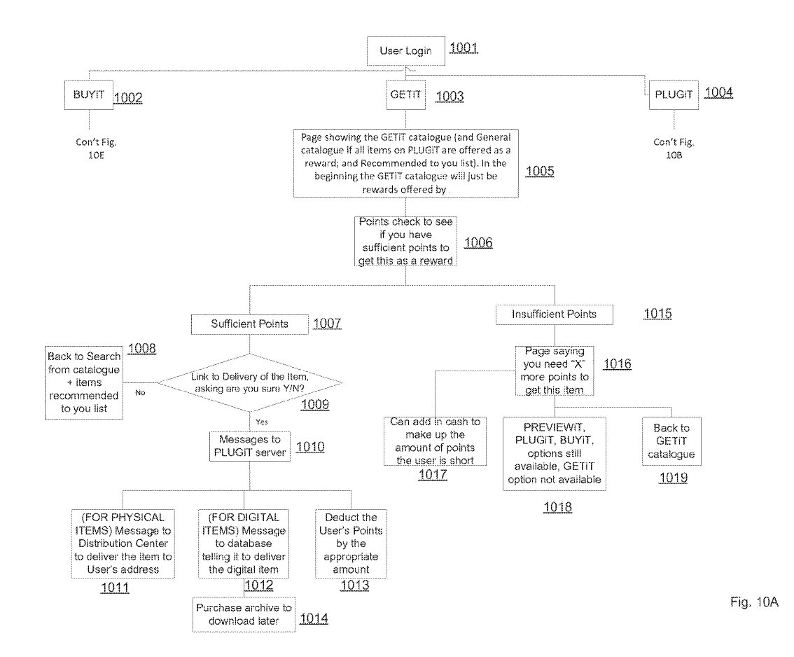

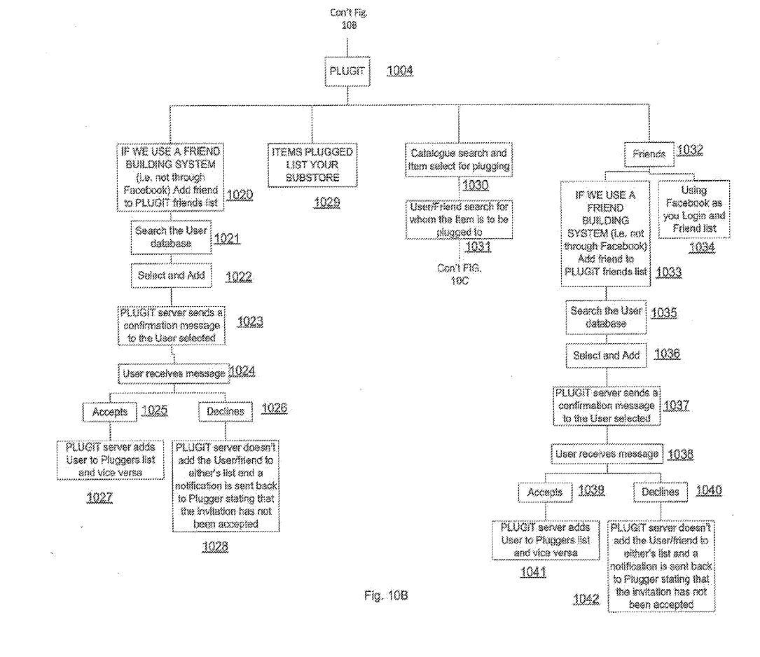

FIG. 9(A) illustrates an example of the options available for a user when they log on to the MPower website. For a detailed description of these options, see the discussion of FIGS. 7(A) and 8(A) herein. Additional available options may include a summary feature (block 905) which can be provided with a button or pop-up (block 906) and provides the option to send a review via an existing social network (block 907). For a review sent via a social network, a message is also sent to the MPower system (block 908).

FIG. 9(B) illustrates example options to determine how users are rewarded as part of the GETiT feature (block 914). For additional details about this figure, see the discussion of FIG. 7(B).

The process by which users are rewarded depends on the reward model being used (block 933). For more on awarding users, see the discussion of FIGS. 6(B) to (E) above. FIG. 9(C) illustrates an example process for using the GETiT feature. For additional detail about this figure, see the discussion of FIG. 6(B) above. FIGS. 9(D)-(E) illustrate an example process for redeeming rewards with a points based model (block 939). For additional detail about these figures, see the discussion of FIGS. 6(E) to (G). FIG. 9(F) illustrates an example process for redeeming coupons in a coupon based rewards system (block 955). For additional detail about this figure, see the discussion of FIG. 6(E).

FIGS. 9(G) to (I) illustrate an example process for using the PLUGiT feature (block 916). For additional detail about these figures, see the discussion of FIGS. 6(F)-(G) and FIGS. 7(G) to (I). FIG. 9J illustrates an example of a message with embedded media. As shown, the message can include a short greeting from the reviewer, a picture or video of the item being plugged 961A, and options for the recipient to buy the item 964A, get the item 965A, or review the item 966A.

FIG. 9L illustrates an example of a PLUGiT bar implemented at a content provider's website. FIG. 9K illustrates a message with an additional link to content that might not be available via the message. As shown, the message can include a short greeting from the reviewer, a picture or video of the item being plugged 970A, and options for the recipient to buy the item 971A, get the item 972A, review the item 973A, or preview the item 974A via the attached link 975A.

FIG. 9(M) illustrates an example process for distributing rewards earned through the MPower plug process. For additional detail about this figure, see the discussion of FIG. 7(M) above.

FIGS. 9(N)-(O) illustrate a process for purchasing an item according to an embodiment of the present invention. For additional detail about these figures, see the discussion of FIGS. 6(I) and 6(J). FIGS. 9(P) and 9(Q) illustrate an example set of features available with the substore option of the MPower system. For a detailed description of the substore, see the discussion of FIG. 12 herein.

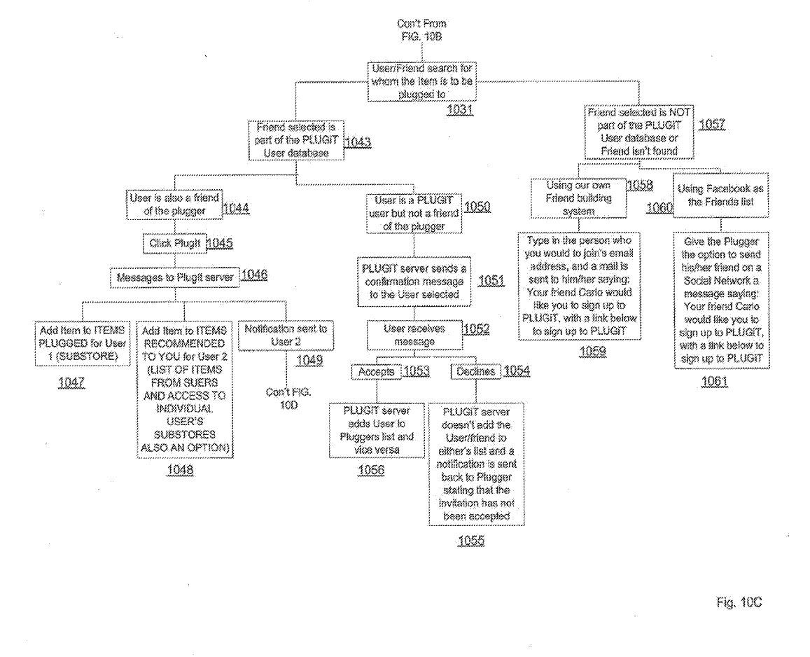

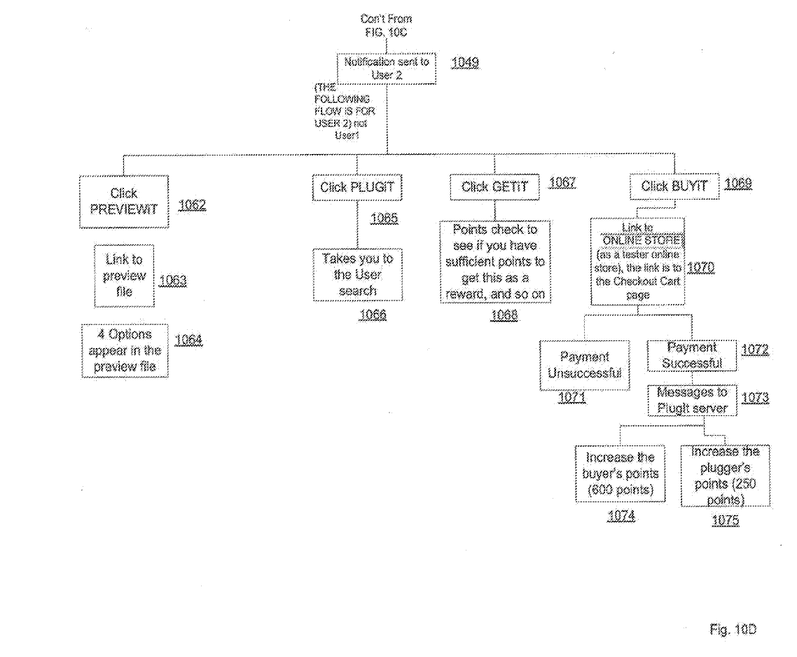

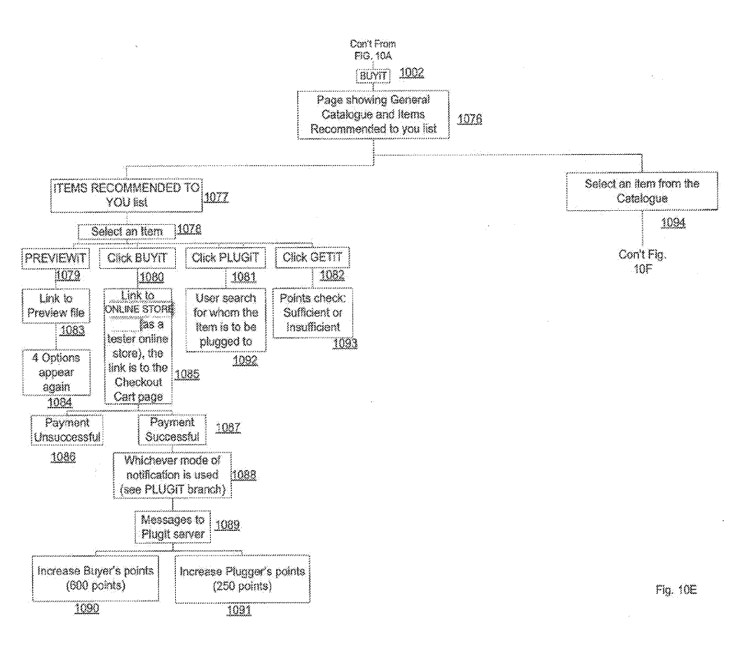

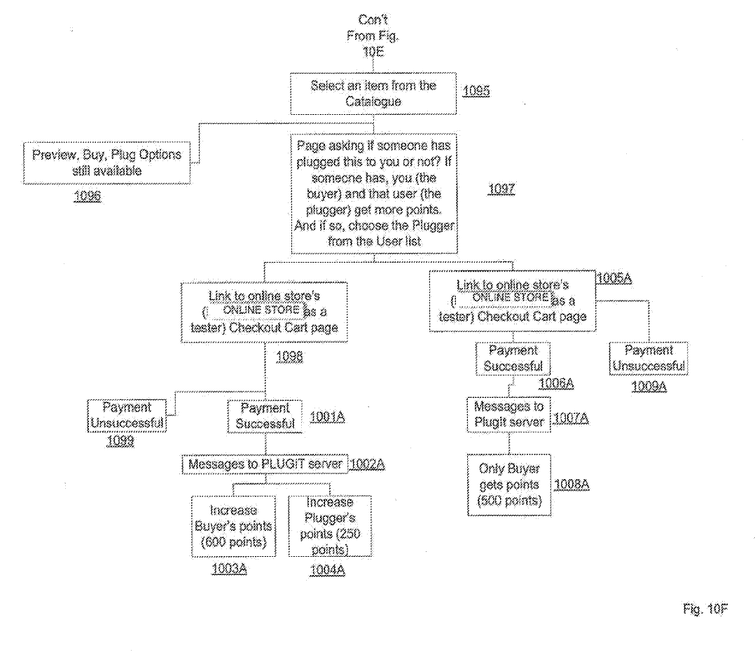

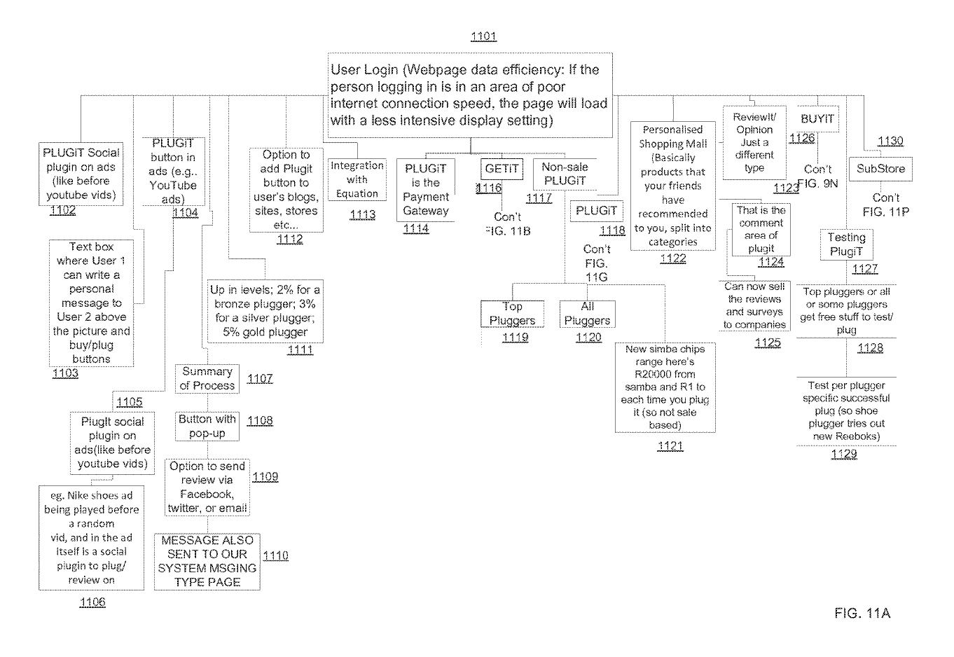

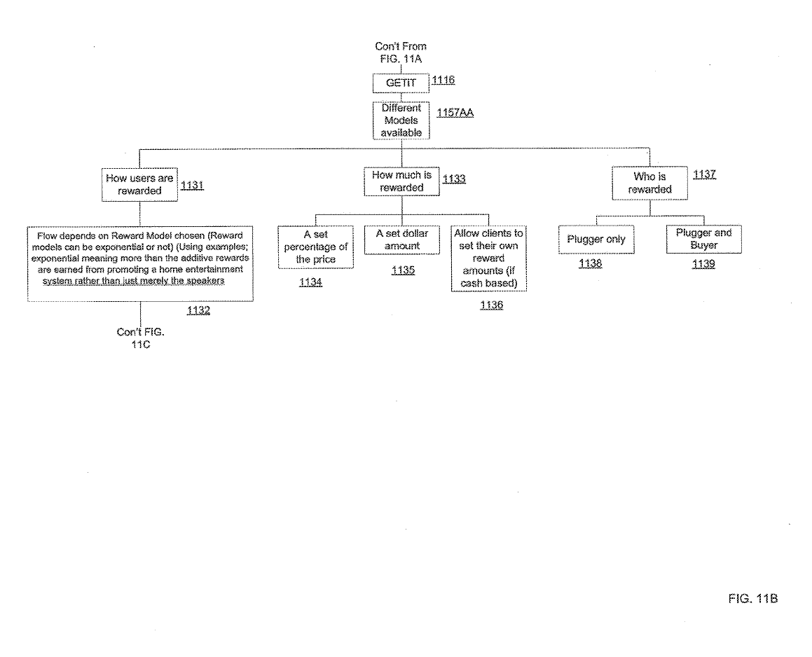

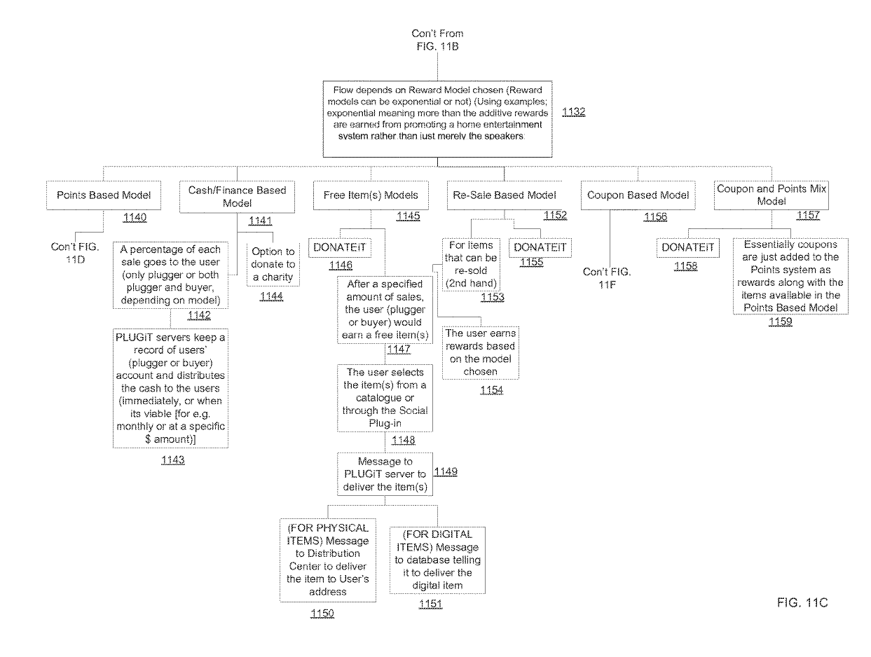

FIG. 10(A) illustrates an example of the options available for a user when they log on to the MPower website. From the log in page, the user has several different navigation and interaction options (block 1001). For example, there is an option to access the GETiT feature (block 1003), accessing the BUYiT feature (block 1002), and accessing a PLUGiT option (block 1004). FIG. 10(A) illustrates an example process for redeeming rewards with points (block 1005). For additional detail about these figures, see the discussion of FIG. 6(D). FIGS. 10(B) to (D) illustrate an example process for using the PLUGiT feature (block 1004). For additional detail about these figures, see the discussion of FIGS. 6(F) to (H) and FIGS. 7(G) to (I). FIGS. 10(E)-(F) illustrate a process for purchasing an item according to an embodiment of the present invention. For additional detail about these figures, see the discussion of FIGS. 6(I) and 6(J).

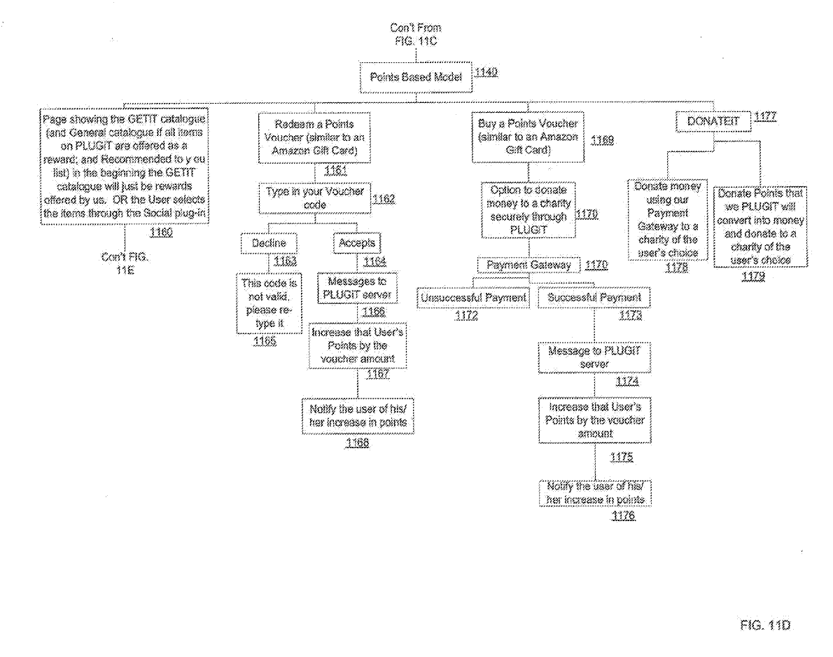

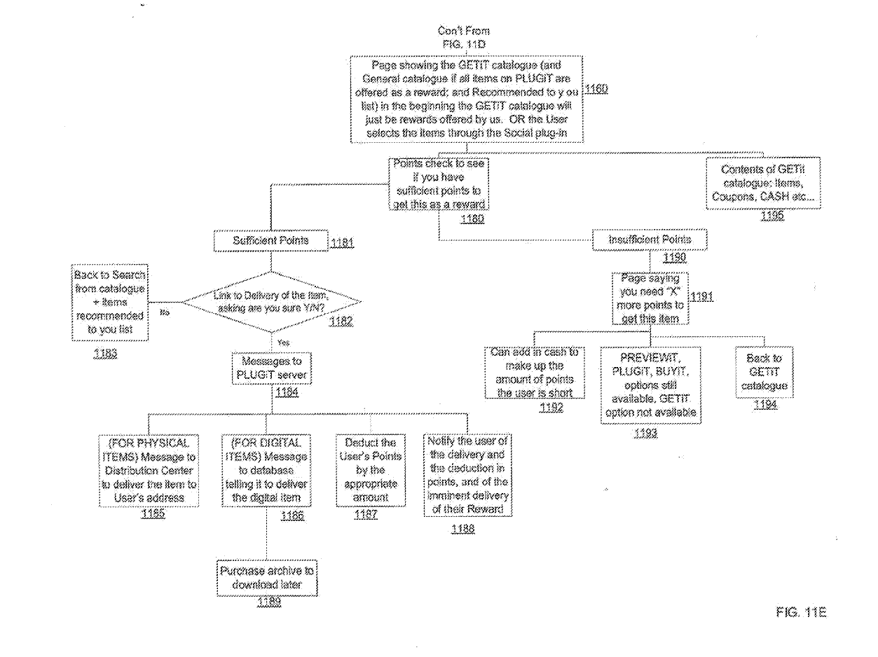

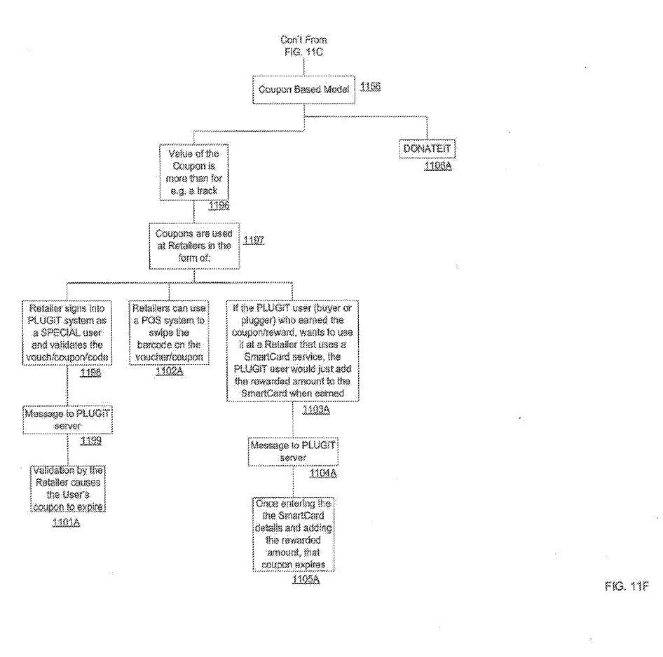

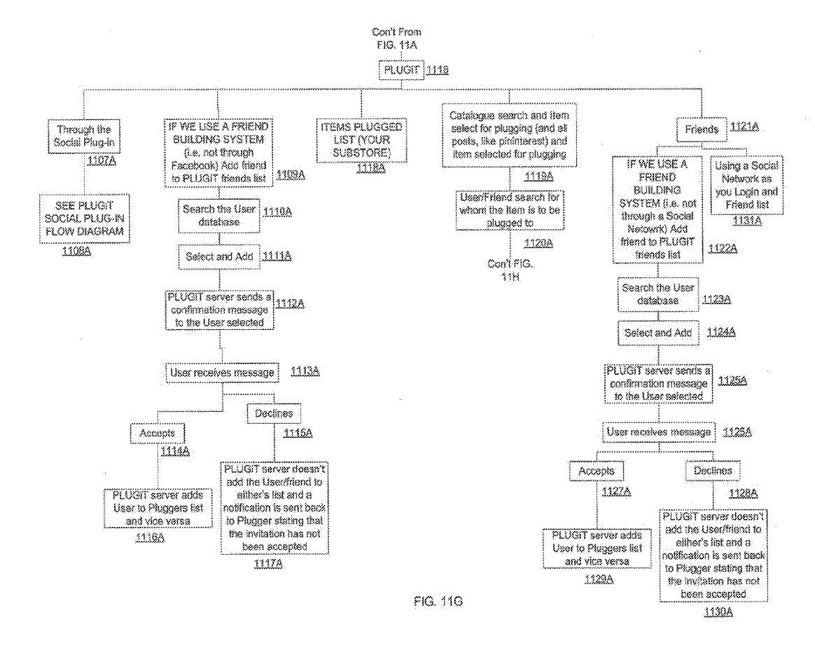

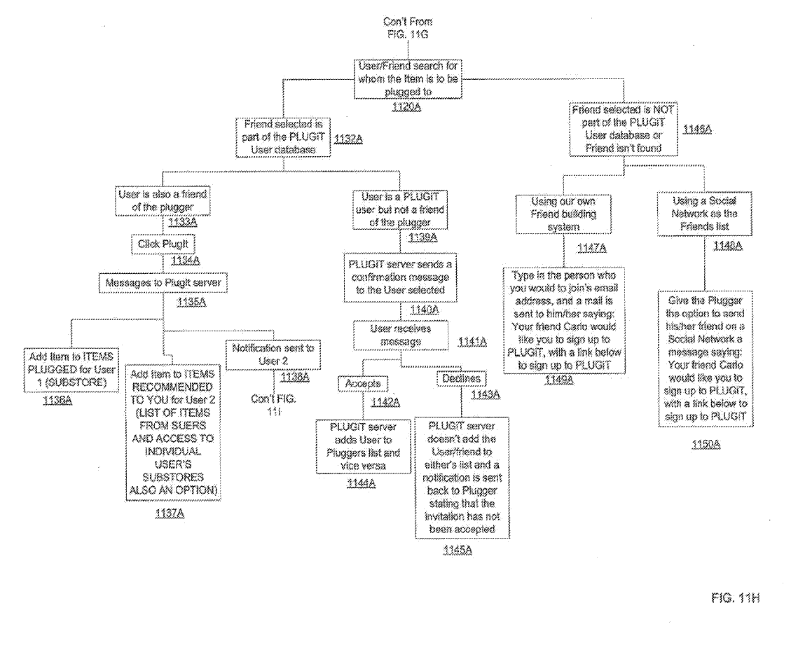

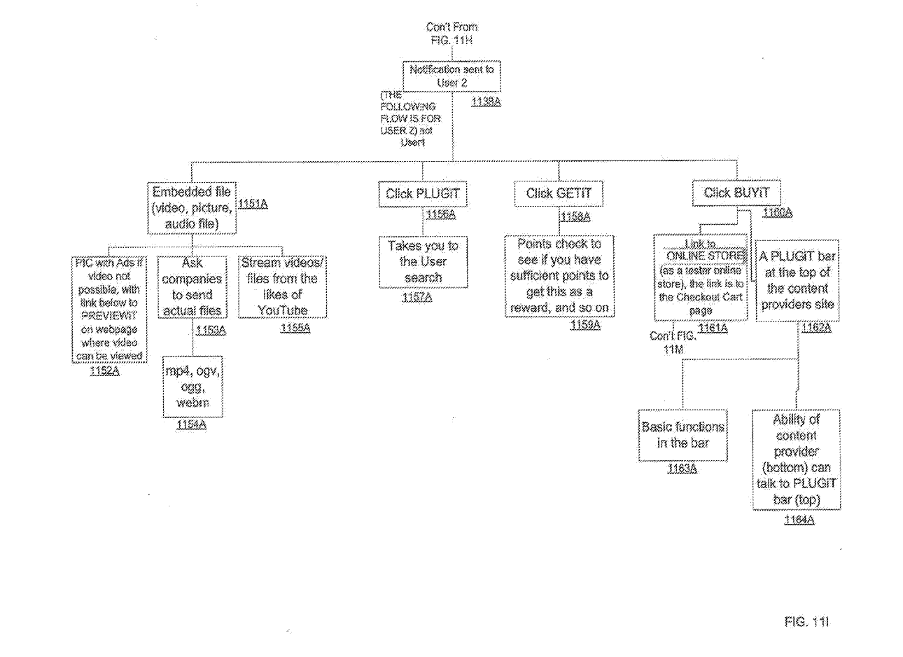

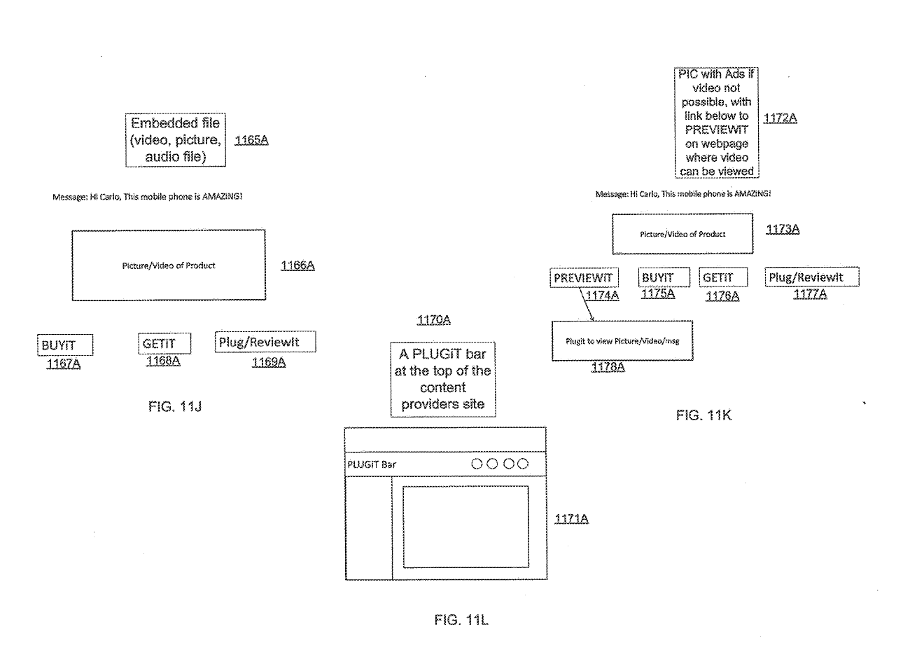

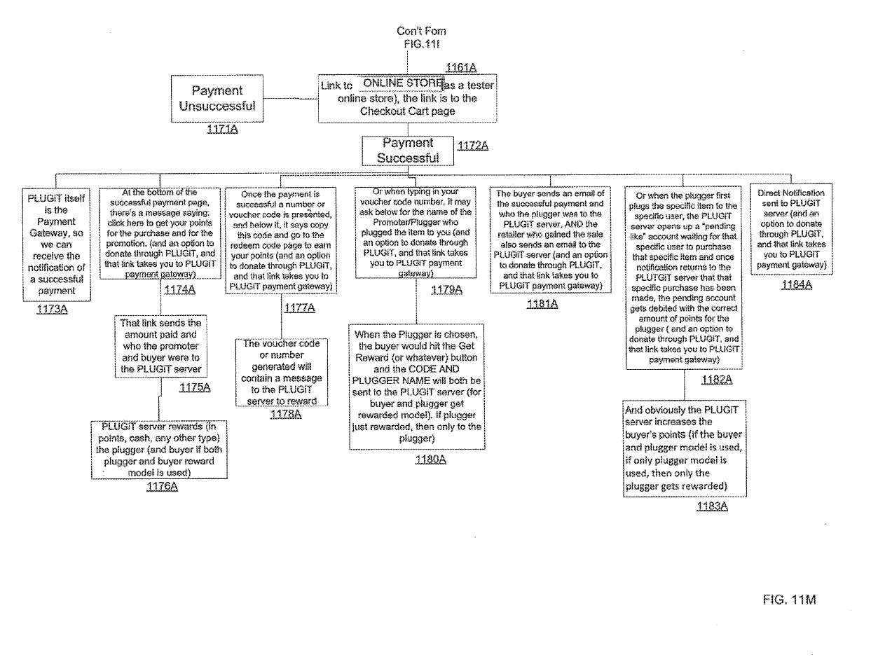

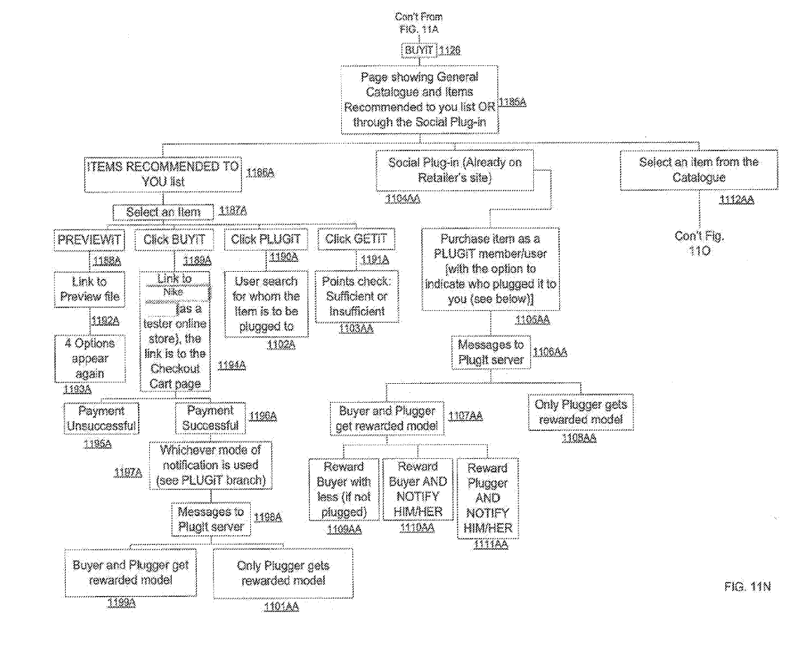

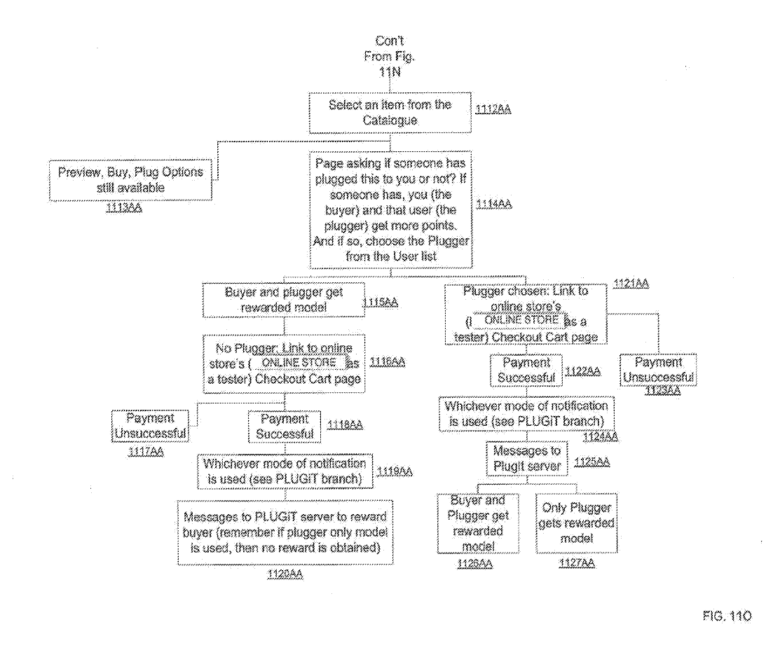

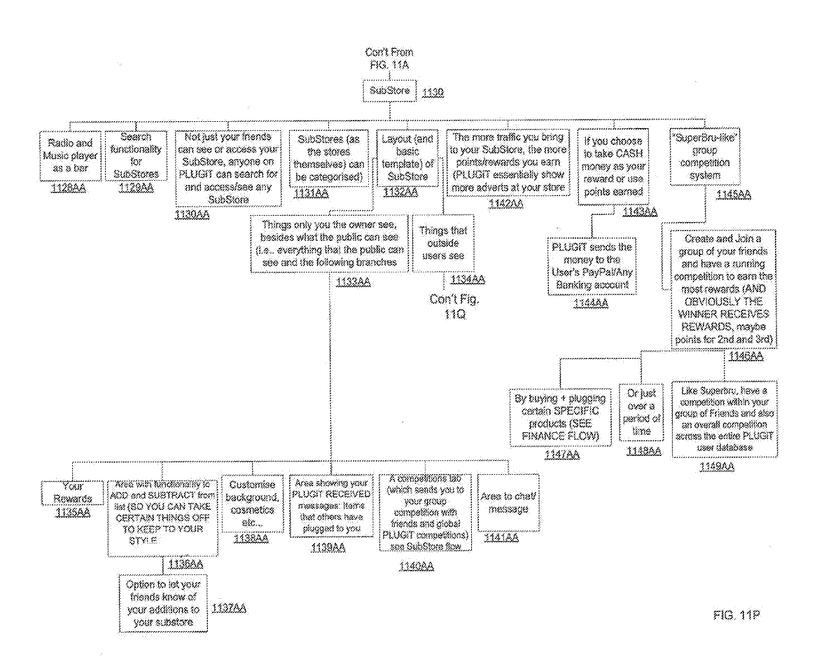

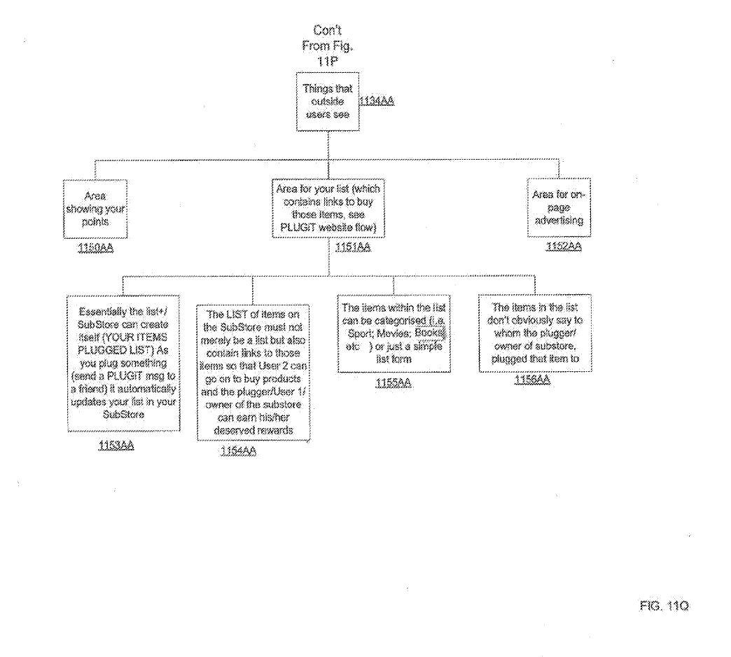

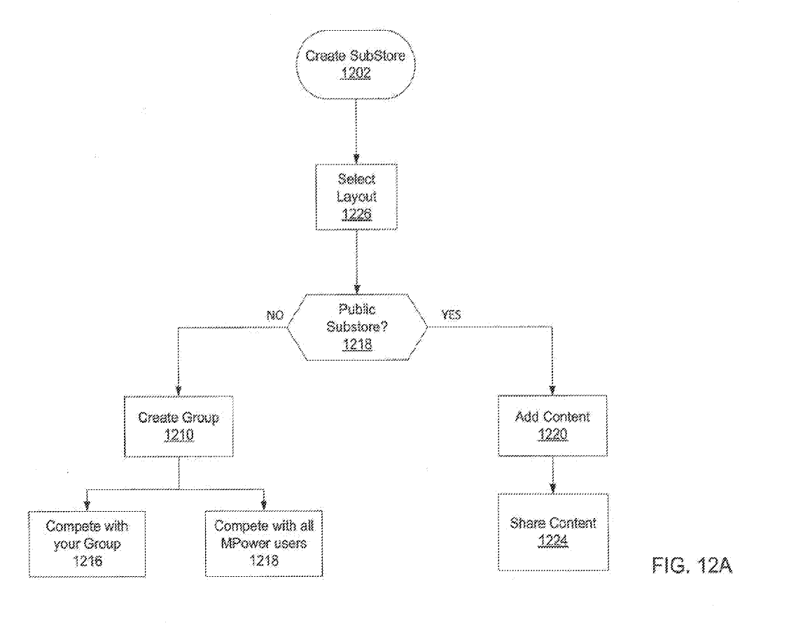

FIG. 11(A) illustrates an example of the options available for a user when they log on to the MPower website. For a detailed description of these options, see the discussion of FIGS. 7(A), 8(A), and 9(A) herein. FIG. 11(B) illustrates example options to determine how users are rewarded as part of the GETiT feature (block 1116). For additional details about this figure, see the discussion of FIG. 7(B). The process by which users are rewarded depends on the reward model being used (block 1132). For more on awarding users, see the discussion of FIGS. 6(B) to (E) above. FIG. 11(C) illustrates an example process for using the GETiT feature. For additional detail about this figure, see the discussion of FIG. 6(B) above. FIGS. 11(D)-(E) illustrate an example process for redeeming rewards with a points based model (block 1140). For additional detail about these figures, see the discussion of FIGS. 6(E) to (G). FIG. 11(F) illustrates an example process for redeeming coupons in a coupon based rewards system (block 1156). For additional detail about this figure, see the discussion of FIG. 6(E).

FIGS. 11(G) to (I) illustrate an example process for using the PLUGiT feature (block 1118). For additional detail about these figures, see the discussion of FIGS. 6(F)-(G) and FIGS. 7(G) to (I). FIG. 11J illustrates an example of a message with embedded media. As shown, the message can include a short greeting from the reviewer, a picture or video of the item being plugged 1166A, and options for the recipient to buy the item 1167A, get the item 1168A, or review the item 1169A.

FIG. 11L illustrates an example of a PLUGiT bar implemented at a content provider's website. FIG. 11K illustrates a message with an additional link to content that might not be available via the message. As shown, the message can include a short greeting from the reviewer, a picture or video of the item being plugged 1173A, and options for the recipient to buy the item 1174A, get the item 1175A, review the item 1176A, or preview the item 1177A via the attached link 1178A.

FIG. 11(M) illustrates an example process for distributing rewards earned through the MPower plug process. For additional detail about this figure, see the discussion of FIG. 7(M) above.

FIGS. 11(N)-(O) illustrate a process for purchasing an item according to an embodiment of the present invention. For additional detail about these figures, see the discussion of FIGS. 6(I) and 6(J). FIGS. 11(P) and 11(Q) illustrate an example set of features available with the substore option of the MPower system. For a detailed description of the substore, see the discussion of FIG. 12 herein.

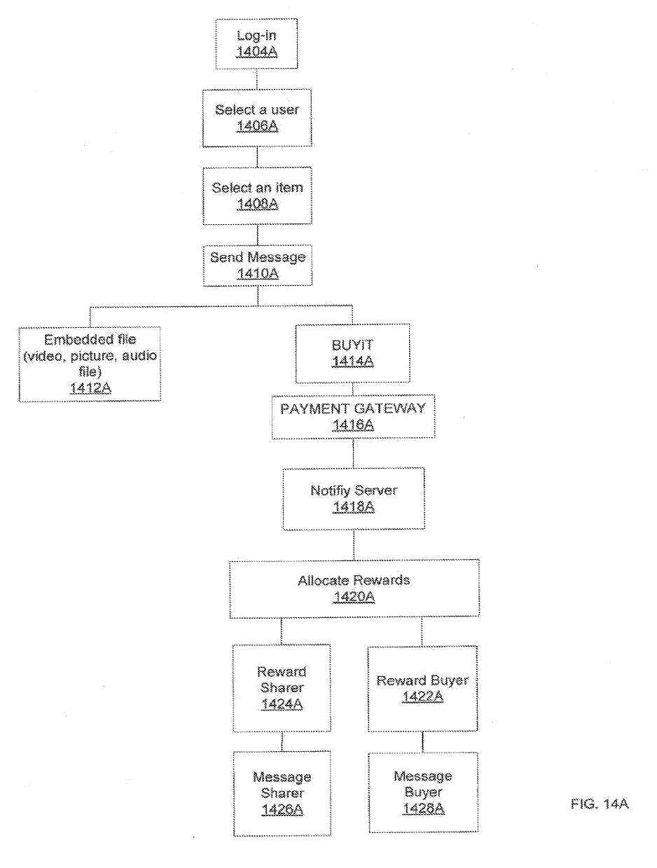

FIG. 13(A) illustrates an example of the options, attributes and features provided on an MPower mobile application. For example, an MPower mobile application 1302 will have several items displayed on a main page. Such display items can include one or more of the following: the number of points or reward total the user has accumulated (block 1308), a sticky PLUGiT button that is consistently available (this may be similar to Shazam) (block 1310), and one or more tabs. According to an embodiment, the mobile app can be setup to resemble the MPower website (block 1312). According to an embodiment, the user's point total will be displayed in the background of the app for multiple screens.

As shown in FIG. 13(A), there may be one or more tabs available to allow the user to access the features of the MPower system. For example, the app can include at least one of a GETiT tab (block 1306), a PLUGiT tab (block 1314), a substore tab (block 1316), a messages tab (block 1318), a friends tab (block 1320), a BUYiT tab (block 1326), and a rewards tab (block 1324).

The GETiT tab can provide access to the GETiT website, to the item catalog (block 1336), to the list of items recommended to the user, or to the list of items plugged (block 1338) for example through a link.

The PLUGiT tab can provide access a search function to find one or more items to share (block 1340). For example, through the PLUGiT tab the user can search a catalog, browse categories of items, and scroll through the lists of items recommended to or by them. Then once a user has selected an item to share, the user can search for friends to share the item with (block 1340). The friend search feature may provide the option to search for a person or to browse the user's list of friends. Then the user can plug the item (block 1344).

The substore tab can provide access to the user's personal substore(s) (block 1316). For example, through the substore tab, the user can add an item to their public list of shared items (block 1346), remove an item from the list shared items (block 1348), send a message to friends or other substore members (block 1350), or customize the look of the substore (block 1352).

The friends tab can provide access to the user's friends list (block 1320). For example, through the friends tab, the user can view their friends (block 1356), and can search for and add a friend to their friends list or remove a friend from the list (block 1358). The options available at the friends tab depends on the friend system used. For example, the user's account can be associated with a preexisting social network, then the user can view or import his friends from the network. If no social network is associated with the account, the user must build a friends list by requesting permission to add persons as a friend to their friend list.

The messages tab can provide access to the user's received messages (block 1318). Received messages can include promotion messages, server notifications, status updates, rewards disbursements, chat correspondence, etc. The number of unread messages may be visible, for example as a bubble, tag, or other visible number.

The BUYiT tab can provide access to a buy function to purchase one or more items (block 1326). The items can be purchased from within the app (block 1360) or the BUYiT tab will provide access to the BUYiT webpage (block 1362), for example via a link.

The rewards tab can provide access to a feature to manage the user's accumulated rewards (block 1324). For example, the rewards tab can include a history option to allow the user to view the history of points earned (and redeemed) with brief descriptions of each transaction (block 1364). The rewards tab can additionally allow the user to redeem a voucher (block 1368) or to access the GETiT functionality to exchange points for one or more items (block 1366). The user can access the GETiT function via a catalog or list of items recommended to the user (block 1370) or the user can access the GETiT webpage (block 1372), for example, via a link.

Another attribute of the app that can be set or adjusted is the cost of the app (block 1304). According to an embodiment, there will be multiple versions of the app, each having a different pricing scheme. For example, a free version of the app will be available for download and will be ad supported (block 1328). Another version may be free for basic app functionality but a paid for add on will provide increased functionality. For example, the user may purchase the ability to access the sub store features of the MPower system (block 1332). There may be increased functionality options available for purchase related to all or a subset of features of the MPower system (block 1334). Another version may include a paid app that is ad free, and potentially the user is awarded points for purchasing the app (block 1330). The user can upgrade their app to a paid service from the app.

FIG. 13(B) illustrates an example of a mobile app layout according to an embodiment of the invention. As shown in FIG. 13(B), the layout 1322 can include a reward status or point total, a PLUGiT button to access the PLUGiT features, one or more messages directed to the user, and tabs to access the GETiT, friends, and BUYiT features.

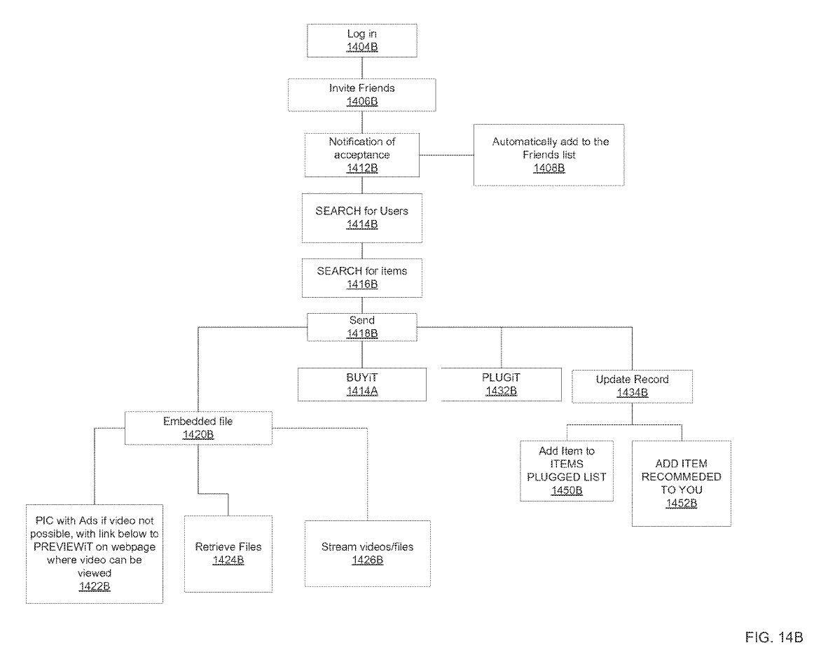

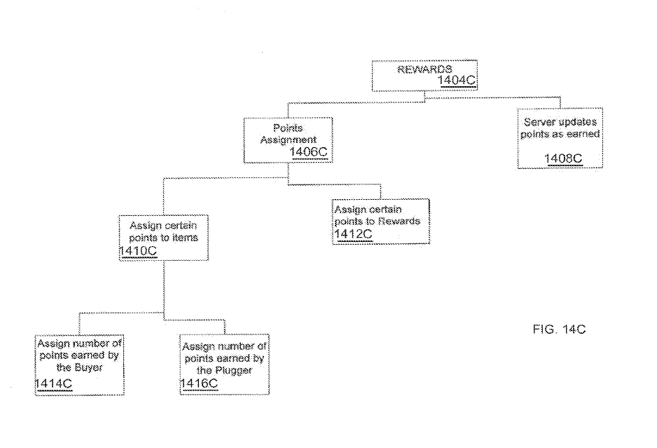

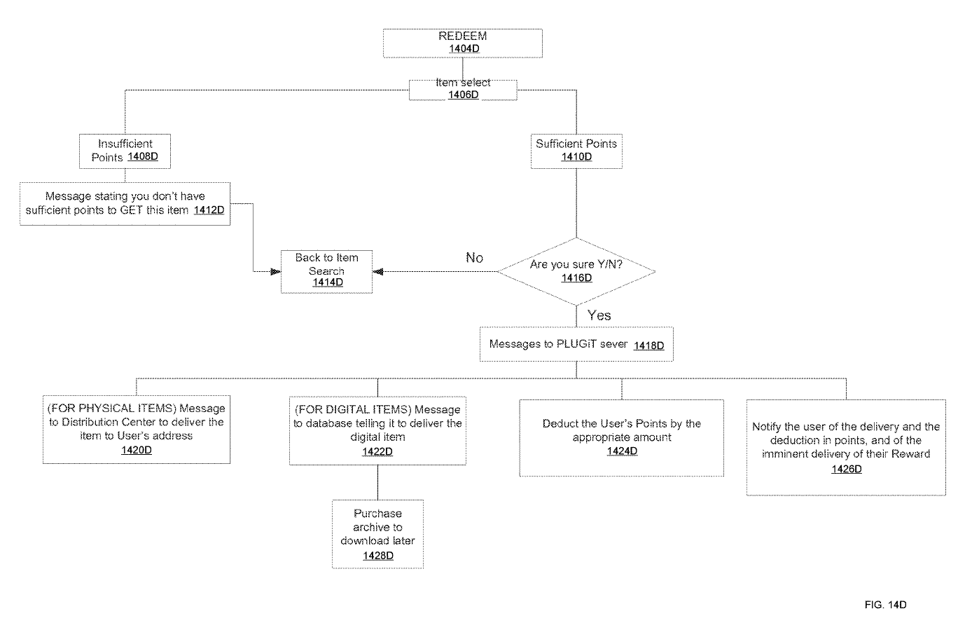

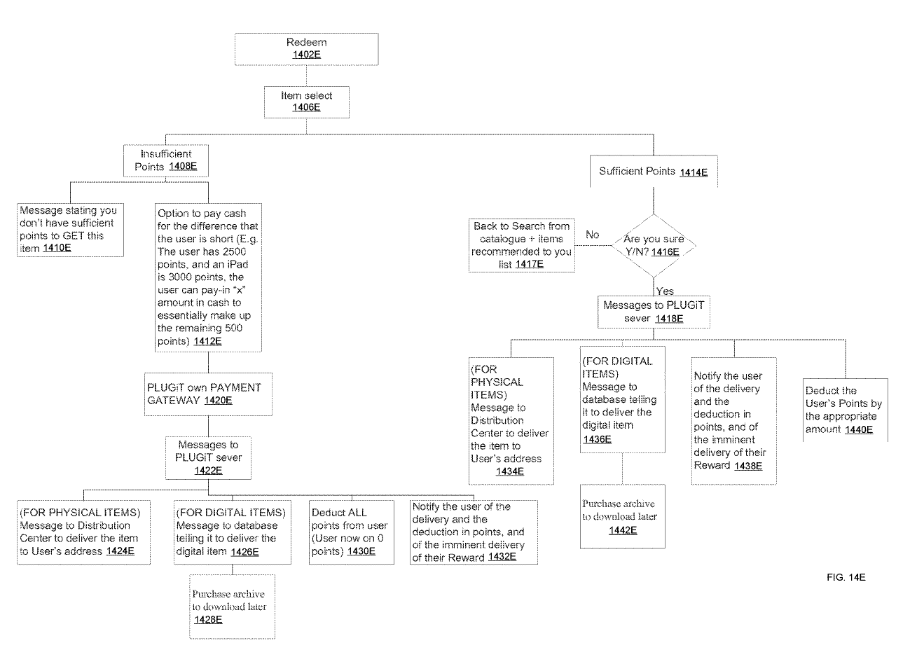

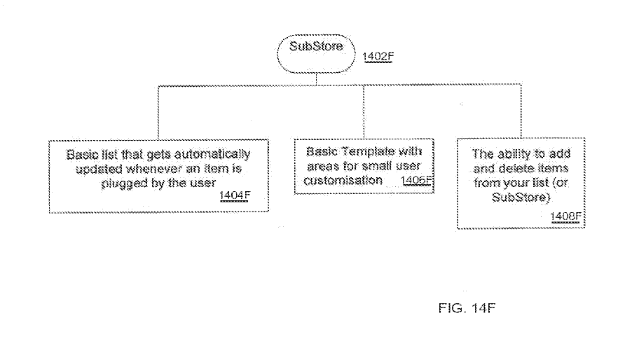

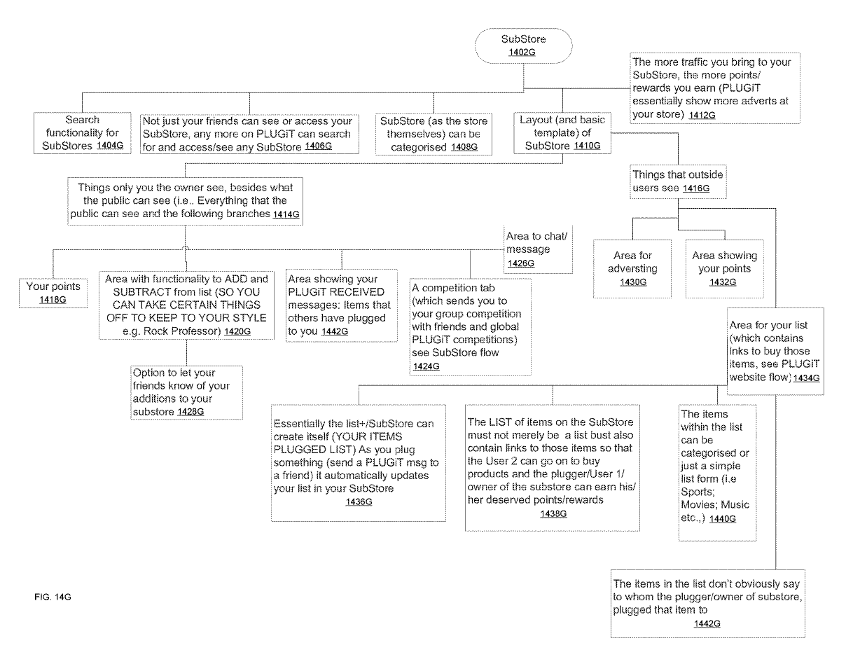

FIG. 14(A) illustrates example functionality provided at login (block 1404A). As shown in FIG. 14(A), once logged in, the user has the option to select an item to share (block 1408A), to select a user to share the item with (block 1406A), and to send the item in a message to the selected user (block 1410A). From the message, the receiving user can view embedded media related to the shared item (block 1412A), and can purchase the item through the BUYiT functionality (block 1414A). The receiving user can then purchase the item through a secure payment gateway (block 1416A). After a purchase is successfully completed, the system will be notified of transaction, including the item purchased, the sharing user, and the buying user (block 1418A). The system can then implement an algorithm to determine the rewards to distribute rewards for the transaction (block 1420A). For example, if an album by Artist A was purchased, the sharer may get v points and the buyer may get w points; however, if an album by Artist B was purchased, the sharer may get x points and the buyer y points. The system can then distribute the rewards by increasing the number of points in the user's account (block 1424A and 1428A) and notify the user that a reward has been placed in their account (block 1422A and 1426A).

FIG. 14(B) illustrates example functionality provided at login (block 1404B). As shown in FIG. 14(B), once logged in, the user has the option to invite friends to the MPower system and to their friends list (block 1406B). If an invited friend accepts the invitation (block 1412B) and the new user will be added to the requesting user's friends list (block 1408B). Then the user has the option to select an item to share (block 1414B), to select a user to share the item with (block 1416B), and to send the item in a message to the selected user (block 1418B). From the message, the receiving user can view embedded media related to the shared item (block 1420B), and can purchase the item through the BUYiT functionality (block 1414A). The Buy process will proceed as described with reference to FIG. 14(A).

The information about the item that the selected user can access from the notification message can include one or more of the following: an embedded video, picture, or audio file embedded in the notification or a link to any of them (block 1420B). If video is not available on the webpage, a picture with ads will be presented with a link to the video (block 1422B). The files can be retrieved directly from a supplier or other third party (block 1424B). For example, such files may include mp4 files, ogv files, ogg files, or webm files. Videos may also be streamed from a website such as YouTube (block 1426B).

Once an item has been shared, the system can update the records for the user's involved (block 1434B), for example, by adding the item shared to the recommending user's list of items shared (block 1450B), and by adding the item shared to the receiving user's list of items recommended to them (block 1452B).

FIG. 14(C) illustrates an example process for managing the rewards system (block 1404C). As shown in FIG. 14(C), the system can update points and rewards in the user's account as the awards are accrued (block 1408C). However, to earn and redeem awards, point values and conversion factors must first be assigned (block 1406C). For example, each item available through the MPower rewards system is assigned a certain point value (block 1412C). Additionally, each item for sale through the MPower system is assigned a certain reward value (block 1410C). For example, an item can be associated with a certain number of points the plugger receives for recommending the item (block 1414C) and a certain number of points the buyer receives for purchasing the item (block 1416C). Other combination can also be assigned, for example, only the plugger receives points, or if there is no plugger, then the buyer receives more points, etc.

FIGS. 14(D) and 14(E) illustrate an example processes for redeeming rewards. For additional details related to these figures, see the description related to FIG. 15 which describes an embodiment of the GETiT function. FIGS. 14(F) and 14(G) illustrate an example set of features available with the substore option of the MPower system. For a detailed description of the substore, see the discussion of FIG. 12 herein. FIG. 16 illustrates an example process for using the PLUGiT feature (block 1602). For additional detail about the elements of this figure, see the discussion of FIGS. 6(F)-(G).

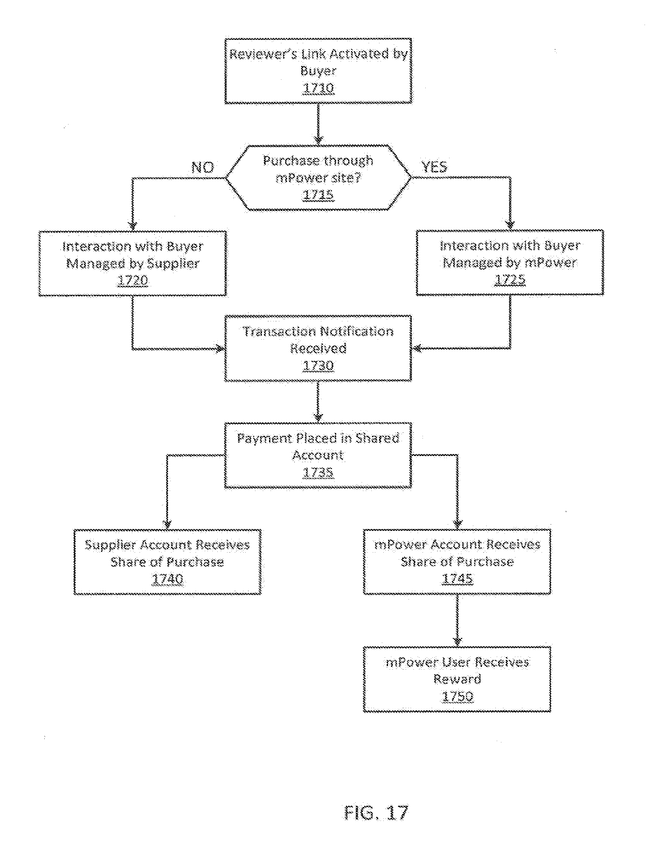

FIG. 17 illustrates a payment process according to an embodiment of the present invention. After an MPower User reviews a product and posts the review containing a link to the product to a social, a second user or buyer may access that review. Then a buyer may activate the link in the review (block 1710). The link may take the buyer to the website of the product Supplier or to an MPower website for purchase of the reviewed product (block 1715).

If the buyer is directed to the Supplier or other third party website, the interaction with the buyer is managed by the Supplier (block 1720). For example, the buyer may purchase the original reviewed item and the process of exchanging payment and providing for product delivery may be managed by the Supplier website. The payment of funds may then be executed via a payment system or payment authority preferred by the Supplier.

If the buyer is directed to an MPower website to purchase the reviewed product the interaction with the buyer is managed by MPower (block 1725). For example, the buyer may purchase the original reviewed item and the process of exchanging payment and providing for product delivery may be managed by MPower. The payment of funds may then be executed via a payment system or payment authority selected by the Supplier during the Supplier registration process, using an account shared by MPower and the Supplier.

MPower receives a notification upon completion of a purchase containing the details of the transaction (block 1730). The Supplier also receives the same or a similar notification. The notification should contain sufficient information to identify and track the parties to the transaction. For example, the provided details may include an identification of the parties, including the buyer, the Supplier, and the reviewer. Other transaction details may be included in the notification. For example, details for the item purchased, the purchase value, the status of the transaction, and other transaction details may be included.

The payment may be placed in an account shared by both the Supplier and MPower (block 1735). For example, the payment by the buyer may be executed via PayPal and the payment will be placed in a shared PayPal account. The payment may then be split between the Supplier and MPower, wherein MPower receives a share of the payment for providing the link that the buyer activated to access the product. The Supplier's share of the payment is transferred to the individual account of the Supplier (block 1740) and MPower's split of the payment is then transferred to MPower's individual account (block 1745). MPower may then disburse the reward earned by the reviewer for providing the link (block 1750). The reward may be in the form of a portion of the payment, points that may be redeemed for a reward by the reviewer, or other disbursement according to a reward scheme. According to an embodiment, the buyer may additionally receive a reward for making the purchase.

According to an embodiment, if the purchase is made on a Supplier online store or the MPower online site, the shared account with the preferred payment authority is used. According to an embodiment, when a payment is made through a Supplier online store or the MPower online site, both the Supplier and MPower are notified. For example, notification includes one or more of the following: a successful transaction confirmation, a buyer's name, a reviewer's name, an identification of the product purchased or leased, the price of the purchase, etc.

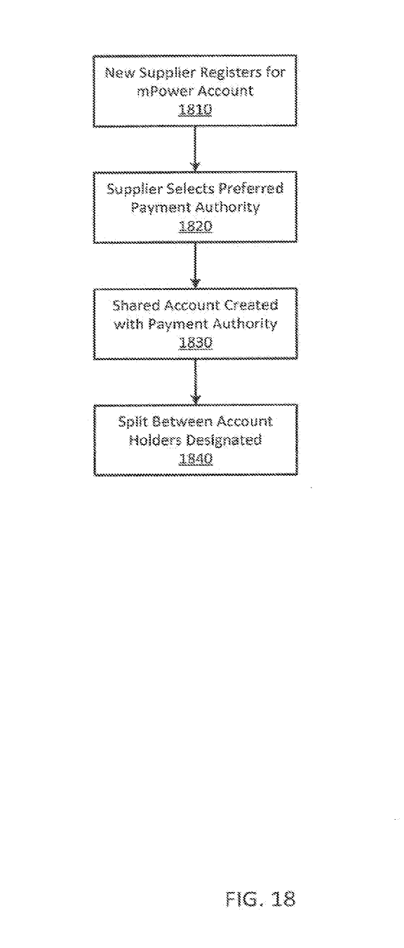

FIG. 18 illustrates a registration process for new Suppliers. New Suppliers may sign up or register for a partnership with MPower via the MPower website, for example, by accessing the “Suppliers” link on the MPower website (block 1810). Once Supplier details have been entered, including basic registration information such as company name, contact no, email address and contact information for person working at the company, a unique Supplier ID may be assigned to the Supplier.

Once initial registration is complete and the Supplier information verified, the Supplier is presented with various payment systems, for example PayPal, PayMate, SafePay, etc. The Supplier then chooses one of the available payment authorities that will be used to process online transactions (block 1820). As part of the selection process, the Supplier provides account information to which the Supplier's share of any received payments should be delivered. Then a shared account may be created with the payment authority (block 1830).

Once a shared account is created, all payments for items purchased from the Supplier may initially be placed in the shared account until the split is determined and the shares distributed to the individual Supplier and MPower accounts respectively. The split of the payments made to the account may be determined at the time of the Supplier registration and may be associated with the account such that the share of the payment for each account holder may be automatically determined and distributed (block 1840). The split can also be determined or adjusted at any time after registration as well.

Embodiments of the present invention provide for a capability for promoters and/or re-sellers online to provide a contribution towards digital content owners and manufacturers of physical products to promote/sell their products over a network, e.g., the Internet, to any number of customers in a controlled environment. For example, the digital content and/or physical products can include digital audio tracks, movies, TV shows, eBooks, tickets, software, mobile applications, electronic equipment, sporting equipment, kitchen appliances, used products, new products, presentations, intellectual data, etc. In embodiments, by using the present invention, a user, e.g., a promoter and/or re-seller, will get rewarded. Such reward can be financial and/or a rewards point based system, or a tracking and/or measuring system.

An embodiment of the present invention provides for a company web site via which a user can register, create an online platform through which to promote and/or resell digital content and/or physical products, and then effectively promote and/or resell. In an embodiment, one can track all registered users using the created online platform through the use of available web services running on the web server.

In an embodiment of the present invention, the company website also operates as an online store to promote digital content and/or physical products from digital owners and product manufacturers, to be available as digital content and/or physical products to both application users and non application users that want to buy online at a store of convenience that can provide local and international digital content or physical products with easy access.

In an embodiment of the present invention, after successful completion of the registration process, a user can log on to the company website and configure his/her substore to promote any digital content and/or physical products. The user does not have to own the original content and/or product in order to promote those products and content to others, and be rewarded in an embodiment of the present invention. In an embodiment of the present invention, the system can use any means of registration, for example: free, once-off fee, subscription, or other means.

For a subscription based service, for example, the user can subscribe to any music artist, movie, product brand name or favorite author. Through the subscription functionality the user's substore or front end for promoting his/her digital content and/or physical products, information can be updated with content about that selected subscription. The user can promote any of the digital content and/or physical products or product information to other users through any of the networks/social networks by adding more information about that promoted digital content and/or physical products.

In an embodiment of the present invention, a user having a substore can partake in a rewards system. For example, all new registered users can be rewarded through a financial and/or points based system or other measuring/accountability system by: a) promoting/re-selling digital content and/or physical products, b) receiving points on registration, c) taking part in online surveys and competitions, and/or d) promoting digital content or physical products to other users on social networks. For example, the more users that register on the website, then the more points/rewards the operating user can accumulate by recommending the Website and use the points received as the users see fit.

In an embodiment, all new signed up and approved promoters and/or advertisers (including, for example, new and upcoming artists or authors), and/or new or current product manufacturers, can take part promoting and/or advertising their digital content and/or physical products to a wide user audience getting more exposure of any new releases for any digital content and/or physical products. For example, such activity can enable all digital content or physical products owners and/or product manufacturers to be part of a fast moving industry collaborating with more users than ever before, sharing information on social networks and smart devices across the globe achieving direct marketing that is relatively much more affordable.

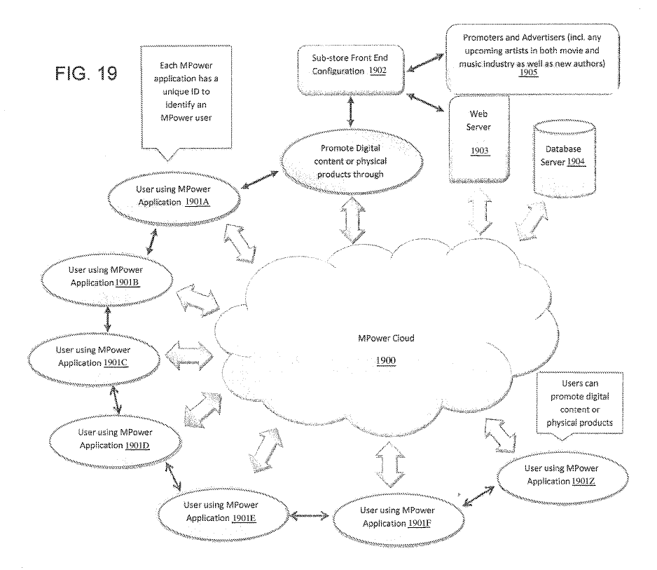

FIG. 19 shows an embodiment of an example system and method of the present invention. In FIG. 19, various entities are connected via a cloud 1900 or other network connection or internet connection. For example an entity 1901A . . . 1901Z using an application, accessing a digital front end, and/or using a digital front end 1902 of an embodiment of the present invention, also associates with the cloud 1900. The entity 1901A . . . 1901Z can set up a substore front end 1902 which can be personalized to the specific entity 1901A . . . 1901Z, including the specific entity's name or identification, content to be provided via the substore front, etc. For example, such content can be from outside resources such as a separate online store, self-standing artists, promoters, advertisers 1905. For example, such content can be from a proprietary database server 1904 associated with the cloud 1900. For example, such content can be from the specific entity's personal memory storage location. The cloud 1900, for example, includes at least one server which assists in connections between entities. The cloud 1900 can be associated with a database server 1904 which can store information regarding one or more of the entities 1901A . . . 1901Z, for example. The cloud 1900 can be associated with a web server 1903 which assists in the connection of entities to others.

For an entity's substore front end 1902, certain implementations are made in order to give the front end 1902 the presence of an online store. For example, a user is afforded the opportunity to register as a promoter and/or reseller. In an embodiment, this process registers a user on the company online system as a promoter/re-seller to promote/re-sell digital content and/or physical products from his/her own digital front end. The user registers using an online form which requests the necessary details from the user in order to setup the store front end 1902. If all the details provided are approved by the company online system, the user receives confirmation that his/her store is now active and he/she can login and setup the substore. In an embodiment of the store front end, an online product catalogue is provided that can be browsed. For example, this can include adding new product catalogue features which includes displaying categories, products, and product details. In an embodiment of the store front end, a searching of the catalogue is provided. In this search, the user can enter any phrase to search through the product catalogue. And, the phrase entered by the user is searched for in the products' names and descriptions. In an embodiment, a custom shopping cart and checkout is provided. For example, a custom shopping basket is implemented which stores its data into the local database. Or, for example, a “shopping cart summary control” is created that shows up in every catalogue page except the shopping cart page. In an embodiment, a handling of customer accounts is provided. For example, in a customer account system, details such as credit card numbers are stored in a database at the Payment Gateway Provider and not on the user's system or the company system due to security precautions. In another embodiment, the company system will handle the payments and keep the data in a database or other means. For example, customers can log in via a login page to get access to secured areas of the website. Once logged in, the web application remembers the customer until the customer logs out. Such logout can be either manual (e.g., push button, etc.) or automatic (e.g., session timeout, server error, etc.). In an embodiment, all secure pages in a web application need to check whether a customer is logged in before allowing access.

In an embodiment of a store front, in the online store the user can customize the Website for each visitor based on his or her preferences, and/or based on data gathered from other visitors with similar preferences. For example, in product recommendations system, additional relevant products are suggested to an individual visitor in order to increase sales. Or, for example, recommendations based on the users' past purchases and based on data gathered from other users with similar preferences. In an embodiment of a storefront, a catalogue administration is provided. This administrative interface, for example, is implemented for easy management of the online store data. For example, the catalogue administration page can allow the administrator to add or remove genres, and update the details of existing genres (in the case of music), view and manage the categories that belong to a genre (in the case of music), manage the list of products in a specific category, and edit product details, assign an existing product to an additional, or move it to another category, and/or remove a product from a category or delete the product from the catalogue. For example, the administration page requires a username and password, so that only the website administrator is allowed to perform administrative tasks.

In an embodiment of a storefront, all user interfaces are generated web pages. In order to access the system, the user uses a workstation/processor with Internet accessibility equipped with a web browser. A broadband connection may be recommended to boost the internet performance for faster browsing. In an embodiment, a web page will be displayed according to the user's choice. The Administrator can add new or update the quantity and details of existing Genres/Categories/Products. The online user can browse/search through the catalogue and buy from any of the online digital content or physical products listed.

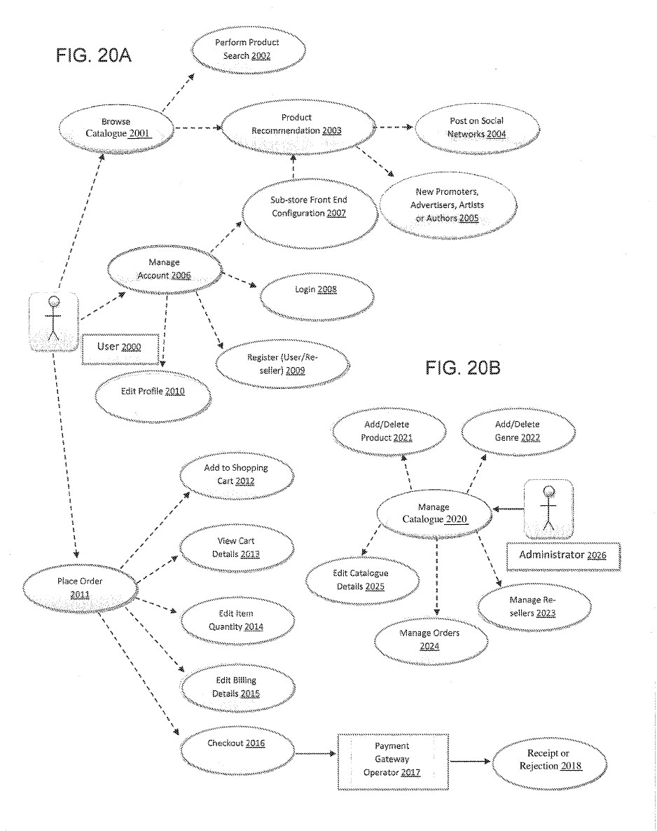

FIGS. 20A and 20B show an embodiment of an example system and method according to the present invention. In FIG. 20A, a diagram of the user's experience in an embodiment of the present invention illustrates a user 2000 browsing a catalogue 2001 in order to perform a product search 2002 or recommend a product 2003 via a post on a social network 2004 or with other promoters, advertisers, artists, or authors 2005. The user 2000 can manage its account 2006 which is associated with the substore front end configuration 207 and requires a login 2008, a registration 2009, and allows for an editing of a profile 2010. The user may also place an order for content 2011 and can add content to the shopping cart list 2012, view the cart details 2013, edit the item quantity 2014, edit billing details and information 2015, and checkout 2016. The checkout 2016 links to either an outside payment gateway operator 2017 or to the company website or other location to effect the payment. Receipt or rejection of purchase 2018 is then received.

In browsing, for example, a customer can browse through the different genres, categories and can also view the details of the products such as the description and price. A user selects one of the genres and its category. The system will display product list and information of the selected genre and/or category. The product list will be displayed on results page and products will be displayed on each page and the rest (if any) will be on the next page. This will be executed using the “pagination” property i.e. there will a link named “Previous” and “Next” on the bottom of every page to enable the customers to go to the next and previous pages to view products. The current page of the customer will also be displayed on every page.

In product and substore search requirements, for example, the customer is enabled to find the available online digital content or physical products of choice without browsing the entire catalogue. For input, for example, the customer will hit the Search button on the top of every page. This will redirect the user to Search web page where he/she will have the options to enter name of the digital content or physical product and price range of his/her choice. For example, the user can enter any text in the search text box and can choose for the system to search for all the words he entered and hit the “Search” button. This will redirect the user to the page which will display all the matched items; otherwise an appropriate message will be displayed. The user can also search for Sub-Stores using a similar process described above. For output, if the user inputs are not valid (i.e. the user did not enter any of the required options), an appropriate error message will be displayed. If the inputs are valid, a message will be displayed affirming the user's choices along with the appropriate product(s) information for the particular search. If there are no matches, the system will display an appropriate message.

In getting digital content and/or physical product recommendations, for example, the customer is enabled to find recommendations for digital content or physical products of choice. For input, for example, the customer will hit the “Get Recommendations” button on the top of every page within that specific digital content or physical product range. This will redirect the user to a recommendation web page where he/she will have the options to enter the title of the digital content or physical product and click the “Get Similar Items” button. For output, for example, a list of most similar product information will be displayed to the user, from which the user can choose from and get the most recommendations on that digital content or physical product.

In manage account requirements, for example, for system login, this enables user authentication. A valid user account must be used for an existing customer. For input, for example, the customer can login to the shopping cart system by entering his user name and password. For output, for example, the system will verify that the login name matches the login password. If the user name or password is invalid, the appropriate error message will be indicated and the user will be requested to re-enter user name and password. If the user inputs are valid, the main page will be displayed.

In system registration, for example, this is implemented to enable a new user authentication. A valid user account must be used for an existing customer or a new customer can register and create an account. For input, for example, if the customer is a new user, he can request to register on the system. For output, the system displays a registration page and asks the user to choose a user name, password and enter a valid email, security question and answer.

In manage profile requirements, for example, a User can edit, update and save his personal information. The user must be logged into his account to update personal Information. The user's input will be saved to the database. The user can request to update their customer info. For example, a user will enter personal information such as:
First name
Last name
Street address
City, State, Postal Code, Country
Telephone
Cell phone
Email address
Credit card details (only if MPower decides to handle the payments)
   After entering all the information the user must click the update/save button. For output, the customer updates the customer information and the system will store the updated customer info in the system database. In Place Order Requirements, this is implemented to add products to shopping cart while searching or browsing catalogues. The user must be logged in to add a product to the cart. The product will be added to a shopping cart table in the database. When the customer finds the products he wants, he/she adds them to the shopping cart by clicking on the “Add to Cart” button. The product will be added to the shopping cart and the system will store and keep track the information of the products that have been added into shopping cart. In view cart details, for example, this is to view contents of the shopping cart while searching or browsing the catalogues. The user must be logged in and must have at least one Cart item to view details of the shopping cart. The customer can request to view the contents of the shopping cart by clicking on the “View Cart” button. The system will return the contents of the shopping cart to the user; the unit price and total price will be shown as well. In Checkout, for example, this is to allow the user to buy the products added to the shopping cart. User must be logged in and must have at least one item in shopping Cart to be able to checkout and place the order. When the customer finishes shopping, he requests to checkout by clicking the “checkout” button. The user will now be redirected to the Payment Gateway. If the payment information of this customer already exists, the system prompts the customer to review or input a new one. If the credit card is valid, the order form will be processed by the system and checkout is complete.

In FIG. 20B, a diagram of the administrator's experience in an embodiment of the present invention illustrates the administrator 2026 manages the catalogue 2020, including addition and deletion of products 2021, genre 2022, details 2025, and management of orders 2024, and resellers 2023. For example, the Administrator role can use the system for:

### System Login Requirement

Purpose: This is implemented to enable user authentication. A valid user account must be used for an existing user.
Input: The user will enter two inputs (user name and password).
Processing: The user inputs will be validated and authenticated against the local database server. The system will check the user name and password to see if they match the data stored onto the database.
Output: If the user name or password is invalid, the appropriate error message will be displayed and the user will be requested to re-enter user name and password. If the user inputs are valid, the default page will be displayed. If the user is classified as an administrator, he/she will be redirected to an administrator page wherein he/she can update the category details and view customer orders.

### Manage Catalogue Requirements:

### Add New Genre/Category:

Purpose: To create and add new genres, categories to the catalogue.
Precondition: Administrator must be logged in to be able to create and add a new genre or category. Also, the genre to which the new category is to be associated should exist in catalogue.
Input: Administrator will enter the name and necessary details to create a new genre or category to the catalogue and click “Add” button to complete the action.
Output: After the action, the changes to the catalogue will be updated and saved and a message will be displayed accordingly.

### Delete Genre/Category:

Purpose: To remove genres, categories from the catalogue.
Precondition: Administrator must be logged in to be able to delete a genre or category.

There has to be at least one genre already present in catalogue.
Input: Administrator will select a genre/category that is to be removed from the catalogue and click “Remove” button.
Output: After the action, the changes to the catalogue will be updated and saved and a message will be displayed accordingly.

### Add New Product:

Purpose: To create and add new products to the catalogue.
Precondition: Administrator must be logged in to be able to create a new product. Also, the genre and/or category to which the new product is to be associated should exist in catalogue.
Input: Administrator will enter the name and necessary details to create a new product to the catalogue and click “Add” button to complete the action.
Output: After the action, the changes to the catalogue will be updated and saved and a message will be displayed accordingly.

### Delete Product:

Purpose: To remove product from the catalogue.
Precondition: Administrator must be logged in to be able to delete a product. There has to be at least one product already present in catalogue.
Input: Administrator will select a genre/category that is to be removed from the catalogue and click “Remove” button.
Output: After the action, the changes to the catalogue will be updated and saved and a message will be displayed accordingly.

### Manage Orders:

Purpose: To allow the site administrator to review and manage pending and past orders according to various criteria such as date and status.
Precondition: Administrator must be logged into the system. There has to be at least one order already present in database.
Input: Administrator will enter the number of recent records he wishes to view and the range of dates the records are created. He/she will press the Go button against one or both the options—to view unverified, unconcealed orders and/or to view verified, uncompleted orders.
Output: If the administrator enters invalid dates (Start date should be more recent then the End date) to view orders between the range, the system should display appropriate error message. The orders will be displayed as a dataset.
Also, after all the orders are displayed and the administrator presses select button for an order, he/she will be redirected to Orders web form where he can view and update order information. When selecting an order, its details are displayed.

### Manage Promoter/Re-Seller Accounts:

Purpose: To enable the administrator to see how many promoters/re-sellers are registered and be able to get reporting details on the history of the promoter/re-seller at any point in time.
Precondition: Administrator must be logged into the system.
Input: Administrator will select the date from a dropdown list to retrieve all History from the promoters/re-sellers in the system or search for any promoter/re-seller by unique ID.
Output: After the action, the results will be displayed accordingly on screen.

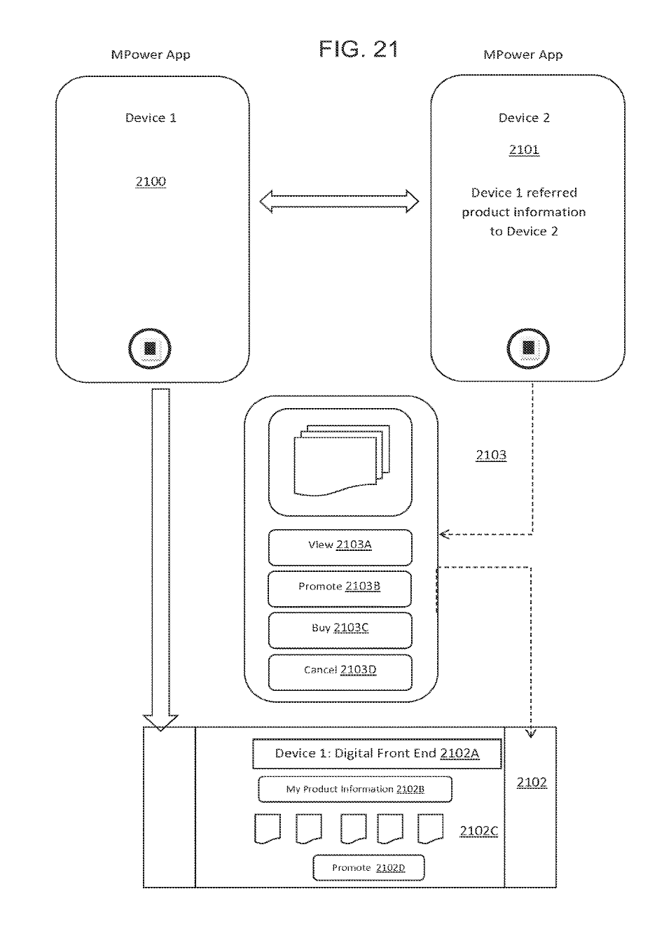

FIG. 21 shows an embodiment of an example system and method according to the present invention. In FIG. 21, a first device 2100 and a second device 2101 connect, with a first device referring (either by a push of information from the first device to the second device, or a pull of information from the second device to the first device, or by other mode) product information to the second device 2101. The first device is associated with a digital front end device 2102 which includes a front end appearance 2102A, product information 2102B, links to or copy of or representation of product/content 2102C available, and a promote device 2102D. A user can browse for digital content and/or physical products, or other product information, and promote this information and/or link(s) to another user registered with a central device (e.g., a central control server of the present invention). The user and/or other users can use a variety of devices including a processor, a computer terminal/desktop, a laptop, a smartphone, a tablet, etc. in connecting to the central device. A user who receives the promoted information can decide to view the product information and/or link(s). The product information may include written product information, an audio file, a video file, an RSS feed, among other possible information resources.

Another method of interaction between users can be done through smartphone devices and tablet devices using the MPower application. For example, the users can download the application from any of their preferred online retailers (or download the web-app from the MPower store depending on the model) and install it on their smartphone, tablet etc. . . . . The registration process will then gather all the information required from the user to get the user activated on the MPower network fast and easy.

For example, the user can browse for digital content or physical products or other product information and promote it to any other user also registered on the MPower application on their smartphone or tablet. The user who receives the promotion can decide to view the product information or listen to the audio if it is a music track or look at the video clip if it is a movie and then buy the digital content or physical products or cancel the recommendation.

For example, the functionality will track each request through the promoting of digital content or physical products or product information between users on the MPower network.

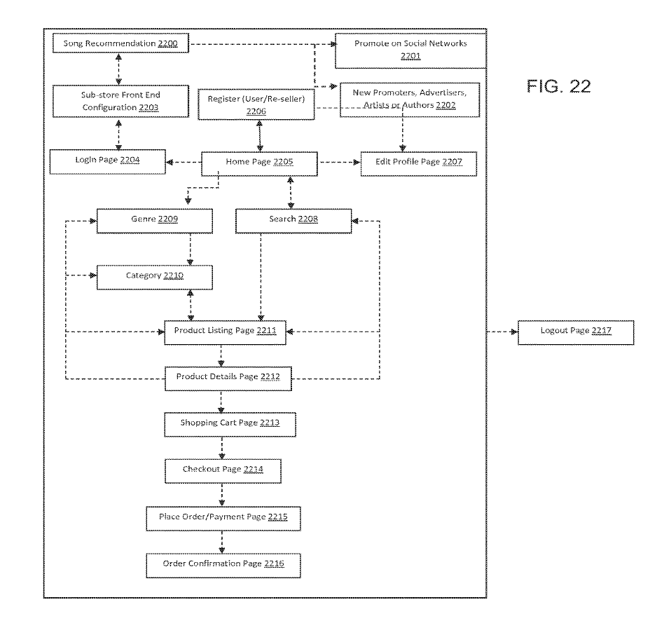

FIG. 22 shows an embodiment of an example system and method according to the present invention. In FIG. 22, a page flow diagram using an example of a music song is provided and the different web pages a user can encounter in this example. For example, a song recommendation 2200 is provided on the substore front end 2203, or via promotion on social networks 2201 or new promoters, advertisers, artists, or authors 2202. One can register as a user or reseller 2206 and establish a homepage 2205 with a login page 2204 and an edit profile page 2207. From the homepage 2205, one can search content 2208 to see product listings 2211, product details 2212, a shopping cart page 2213, a checkout page 2214, a placement of order page 2215, and then an order confirmation page 2216. When searching a genre 2209, and/or a category 2210, a user can also proceed through the products listing page 2211 all the way through the order confirmation page 2216. A logout page 2217 is provided.

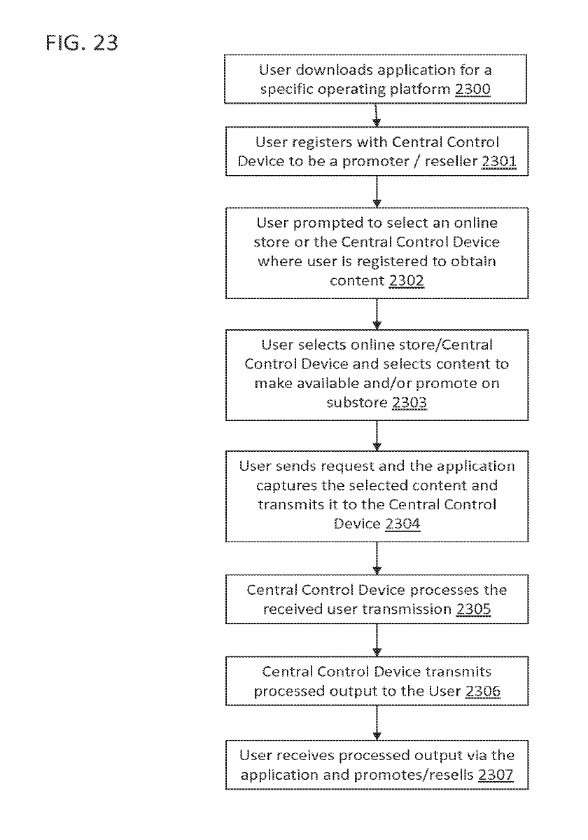

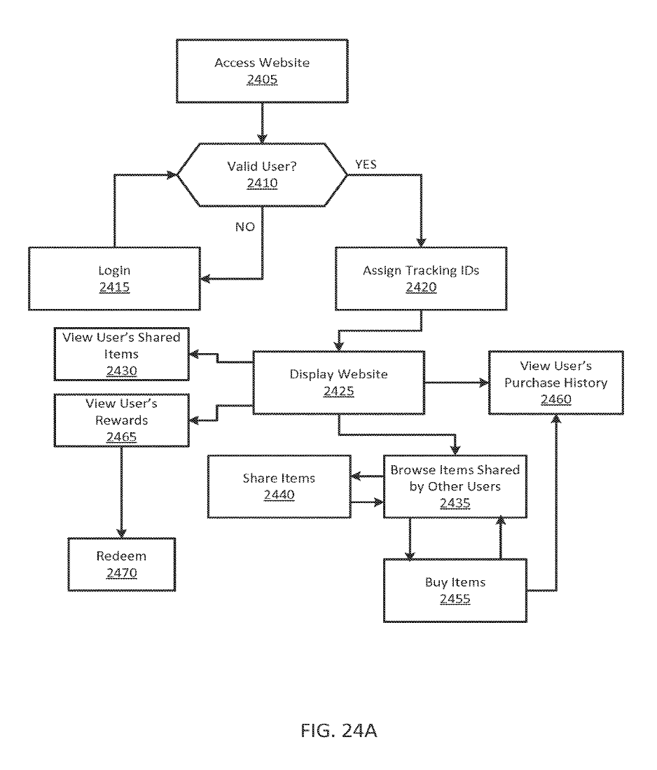

FIG. 23 shows an embodiment of an example system and method according to the present invention. In FIG. 23, the application embodiment of the present invention uses the Internet to communicate with users via a cloud environment. The application works over the internet by communicating with registered users through a Cloud environment that will interact with the users in the following way:

Step 2300: The user downloads an application for his/her preferred platform. The mobile application is developed to work on the Windows, Apple, Symbian, Blackberry and Android or any platforms. And, the mobile application will be available in all countries and not limited to specific countries.

Step 2301: in order for the user to interact with the MPower Cloud, he/she needs to register first.

Step 2302: Upon registration the user is prompted to select from predefined online stores where he/she is already registered with to obtain the digital content or physical products or physical products being promoted to him/her or register on the store alone, depending on the model.

Step 2303: Once the user is registered to be a re-seller/promoter, he/she can login to the application and browse for all the content to be listed on their digital front end. The Web Service will also send promotional content to all users from time to time to maintain and grow its client base.

Step 2304: The user sends a request and the application captures the input and sends it over to the Cloud.

Step 2305: The Cloud performs the following actions: processing of the user input to list the product information in the Cloud base on the user's content selected to be available on his/her digital front end; and querying the database and retrieves relevant data to the user's request.

Step 2306: The Cloud sends back processed output to the user through the MPower application.

Step 2307: The user receives the output response in the MPower application.

Users can now promote their digital content or physical products or other product information to other users on any platform. All digital content or physical products and other product information will be stored on the users own media device and not within the Cloud. The Web Service will store its own digital content or physical products and other product information within the Cloud for promotional and re-selling purposes on an online store.

Registered users can also buy from the online store and promote/re-sell the digital content or physical products to any other users using the application.

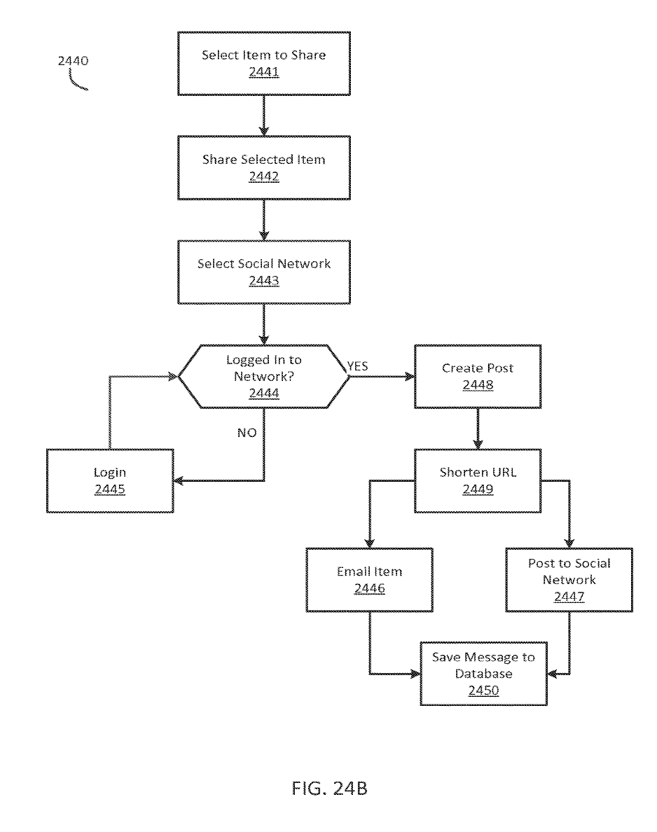

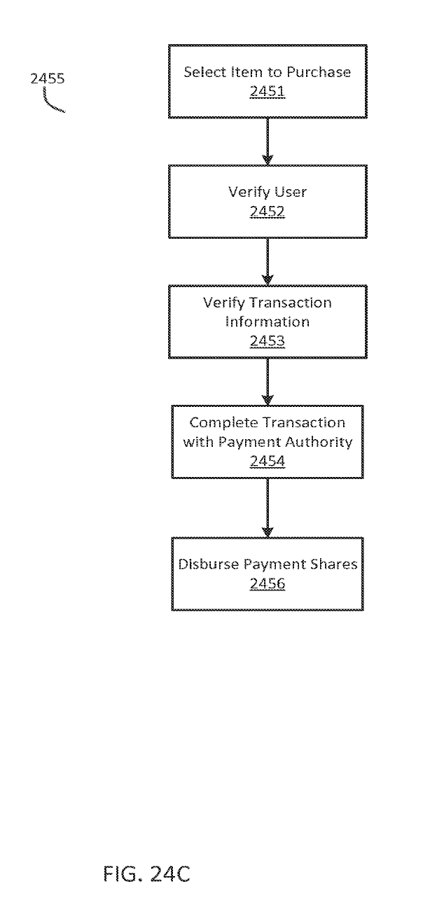

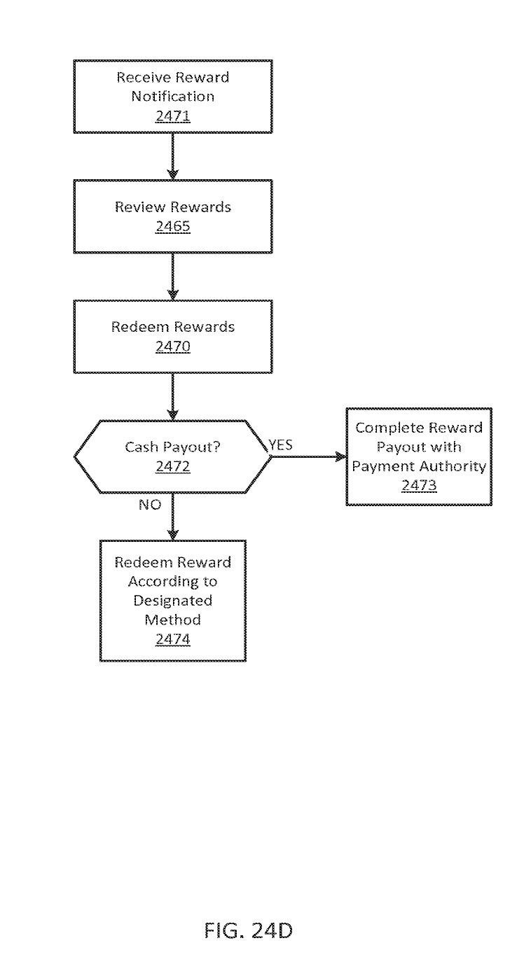

FIG. 24A is a simplified flow diagram that illustrates a process for accessing the MPower system according to an embodiment of the present invention. An MPower user initially accesses the MPower system via the website through any conventional method, for example via an MPower plugin or via HTTP browsing from user's browser (block 2405). An MPower webserver can preliminarily verify the HTTP Request through a filter process that checks for unwanted string parameters, and then evaluates the request string. Once the Request is validated, the URL of the web site is opened.

When accessing the MPower website, the user's identification and membership is verified (block 2410). For example, a function such as a CheckLogin( ) function identifies a currently active MPower sessions for the user. If an active session is detected, user details associated with the user are retrieved from a database and compared to the details associated with the active session. If the active session is determined to be invalid, all current sessions are cleared from the user's system and the user will be directed to a Login screen (block 2415). From the Login screen, the user enters a username and password which is then verified. One or more functions can be used to verify the user's information, for example, a VerifyUser( ) function is called to compare the entered username and password with a username and password retrieved from a database of registered users. Once a user is verified, a new session is activated and a session ID for the active session and a secure code is associated with the user's active session in order to verify and track the user's actions (block 2420). One or more functions can be called to set up the active session. For example, a TransCode( ) function is called to assign and/or verify a transaction ID for transaction processing and a SecureCode( ) function is called to assign and/or verify a secure code ID associated with the session.

Once a valid active session has been established, the MPower webpage is displayed (block 2425). As part of the displayed webpage, user details can be displayed. A variety of user information can be displayed on an MPower website, including for example a username, the user's current rewards and options to buy or share items or information. One or more functions can be used to retrieve and display user information. For example, a GetUserDetails( ) function is called to retrieve user information from a database and to control the display of user information on the MPower webpages.

A user can view the custom list of items and information posted or shared with others from the MPower website (block 2430). For example, a ShowUserCategories( ) function is called to retrieve a list categories for the shared items from a database and to manage the display of such items on a webpage. Similarly, a ShowRatings( ) function retrieves and displays the ratings that the user has assigned to various items and a GetMessages( ) function retrieves and displays all previously shared messages. The user's rating gives an indication to other users as to how good or valuable the user thought the item was. The user can edit or review the items they have previously shared and the categories associated with an item. For example, a user can mark a shared message as public or private.

At the website, the MPower user is presented with public reviews and ratings posted by users of the MPower system (block 2435). The MPower system displays the public reviews and ratings via one or more functions that retrieve stored information from a database. For example, a ShowCategories( ) function retrieves and displays all the latest categories selected by MPower users that shared information and a ShowRatings( ) function retrieves and displays the reviews and ratings shared by MPower users. Only those items marked public or shared will be searched and displayed. Items marked private will not be displayed, or even searched. A logged in user can browse through all searchable items and information and share or buy a previously shared item.

A user can share items and information with other users or with an existing Social Network (block 2440). FIG. 24B illustrates a process for sharing items with the MPower system. Initially, a user selects an item to share (block 2441). Then the user indicates they want to share the selected item (block 2442), for example by clicking a “share” link or button. One or more functions can be called when the user indicates they have a new item to share. For example, a ShareThis( ) function is called. The user is then prompted to select a Social Network with which to share the selected item (block 2443). For example, the available Social Networks for a user can be presented as a set of icons and the user selects the icon associated with an available Social Network. If a user is already logged in to a Social Network and has posting access (block 2444), for example Facebook or Twitter, the user can share a selected item instantly with a post message (block 2447). One or more functions can be called to check that the user is logged in to a Social Network and has posting status. For example, a CheckSocialStatus( ) function is called to check whether the posting option for the given login ID is available. A user may already be logged in to a Social Network if the user registered with the MPower system using an existing social ID for a Social Network. The user can also share an item by sending an email (2446) such that when a message is created, the local email server is called to send the email using a SendEmail( ) function that authenticates the request.

If the user is not already logged in to a Social Network, the user is prompted to login to the network with their username and password for the network or associated website, or to register with the network, before continuing (block 2445). One or more functions can be called to facilitate logging in to the selected network. For example, once a Social Network is selected, a <SocialNetwork>Login( ) function (e.g. FaceBookLogin( ) or TwitterLogin( ) is called to retrieve the user's Social Network login information from a database and transmit the login request to the Social Network with a call to the requested Social Network's API, through local registered libraries, via an HTTP Request using OAuth verification.

Additional authentication indicating that the MPower system can access basic information is required before a user a user can post to their Social Networks. The basic information can include user id, name, surname, email, and birthday (where applicable). Whenever a user does not want to share this information, the MPower system is denied access to the Social Network and the process would not be able to proceed. Once authentication has completed, locally installed libraries send the HTTP requests using pre-registered information from the application and each application can follow a range of secured tokens to be used for each unique call. Therefore, the application can be initially set up with a unique API token key and secret key by sending a request to each Social Network in a specific HTTP Request string for that Social Network. One or more functions can be called to get the authentication keys. For example, a GetAuthKeys( ) function is called that will send the authentication key request through to the Social Network.

Once a user has been logged onto a Social Network and the user authenticated, the user can be directed to a message board screen of the MPower website to create a new message. Then the user enters a new message and a custom post message is created that includes a URL to the item or information being shared (block 2448). One or more functions can be called to post the message. For example, the SendMessage( ) function is called to validate the link and message and a ShortenURLO function is called to append the link to the message. The URL is shortened (block 2449), for example with a Bitly API application which uses an HTTP Request handler to send a long URL to the API and receive the shortened URL in return. An online application can use API calls to verify the request and authenticate the access to the application through a user login and API request token which are requested by a GetShortenURLKeys( ) function. The shortened URL can be stored as a local variable.

Once the shortened URL is received it will be concatenated to the custom message and posted to the selected Social Network (block 2447). For example, an application associated with each Social Network is setup with specific settings for posting to the associated Social Network. Security settings for posting the messages are setup using the OAuth 2.0 protocol. The status of the message, for example, whether it was successfully posted, is returned to the MPower system and saved to a database, for example, with a call to a SavePostStatus( ) function.

Each message posted will also be saved to a database and can later be retrieved and displayed on an MPower webpage as indicated above (block 2450). The details of the shared message saved to the database can include the message, the long URL, the shortened URL, the user ID, the transaction ID, the secure code ID, or other message information. One or more functions can be called to save the message to a local database. For example, a SaveMessages( ) function is called to save the details of the shared message to a database.

After sharing an item, the user is returned to the MPower webpage to browse publicly posted items and information.

A user can purchase items and information shared by other users of the MPower system (block 2455). FIG. 24C illustrates a process for purchasing items with the MPower system. Initially, a user selects an item to purchase (block 2451). For example, a user selects an item for purchase by clicking on a shared item or link in a shared message. When the user selects an item for purchase, the MPower system verifies the user status (block 2452), for example, by calling the CheckLogin( ) function as previously described and verifies the validity of the item, for example with a call to a VerifyItem( ) function. Then one or more functions can be called to collect and verify the information to complete the transaction (block 2453). For example, a GetItemInfo( ) function is called to collect information from the user, information about the selected item, and information about the Supplier of the item and then sends the collected information to a payment authority. The Supplier must be registered with the MPower system before the transaction can be completed. As previously noted, the payment authority is chosen by the Supplier during the registration process. Additionally, a CheckItemInfo( ) function can be called that retrieves and verifies that the item information sent for payment processing is the same as the item selected, and a CheckUserInfo( ) function can be called that retrieves and verifies that the transaction ID and secure code ID used to process the transaction is the same as the user session information. If the information is not correct, the transaction is declined.

Once the transaction information is verified, the payment request is sent to the payment gateway and the transaction proceeds following the steps requested by the payment authority (block 2454). The transaction follows the instructions required by the payment authority and sends back the transaction response codes to be save to the DB, for example with a SaveTransaction( ) function to record the transaction details including the user information, the item information and transaction details. One or more functions can be called to check the transaction details, including the purchase value, and to distribute the payment amounts to each entity as appropriate. For example, a GetPurchaseValue( ) function is called to determine the value amounts that will be paid to each entity.

The payment authority has access to the individual accounts of each entity (e.g. the Supplier and the MPower account) and the shared account to be used to process the transaction. Then the disbursement value will be sent to each entity's account following completion of the transaction (block 2456). All response codes and account information are stored by the MPower system in a database. The transaction percentages that determine the disbursement amounts to be paid to each entity will be predetermined by agreement during the initial registration of the Supplier and must be in place before any transaction can take place between a Supplier and the MPower system.

According to an embodiment, the purchase transaction is completed without a shared account. For example, the payment can be split into the proper disbursement amounts when the payment authority receives the payment. Then the transaction is completed by splitting the purchase transaction into two separate flows, paying both entities with the percentages agreed on by both parties.

According to an embodiment, the purchase transaction is processed and the payment made from the user to an account that does not belong to the MPower system or the Supplier. Then all payments will be paid to the payment authority and the payment authority will make pay-outs to all the entities as appropriate.

A user can review the rewards earned through either sharing items or through purchasing items (block 2465). A user who has received rewards may redeem their rewards as designated in the reward (block 2470). The user may receive rewards for completing a purchase transaction. Then a function can be called, for example, a SaveRewards( ) function saves the reward details for the transaction. A Supplier sets up the rewards a user receives by completing a transaction during the registration process.

Additionally, a user that originally shared the item or information (the reviewer) may also receive a reward when another user purchases the shared item. The reviewer that shared link for the item or information receives a notification indicating that a transaction to purchase the shared item was completed (block 2471), as shown in FIG. 24D. For example a SendNotification( ) function creates a notification message showing the transaction that took place on the shared item or information. The reviewer then sees the rewards added to his online profile account (block 2465) and can choose to redeem the received rewards (block 2470). Some rewards can be redeemed by requesting a pay-out if the reward is cash based (block 2472). If the user chooses to redeem the reward and the reward system used is based on a cash reward, the reviewer can have the option to be paid-out via an online payment authority (block 2473). To complete the payout, the user enters account details and a CheckUserInfo( ) function is called to verify the reviewer's user information. After a successful verification, a RewardPayments( ) function is called that calls the selected payment authority and sends the request. Once the payout request is initiated by the MPower system the instruction request will be handled by the payment authority based on online process instructions. Merchant information can be sent to the payment authority using a GetMerchantlnfo( ) function. The payment authority will then process the merchant information and if the information is successfully verified, will execute the instructions sent with the payout request. If the reward system used for the reward is not cash based, then the user can redeem the reward as instructed by the designated reward system (block 2474). For example, the reward may be a coupon, a free download, or points that are collected and exchanged for items.

After a purchase transaction is successfully completed, the user is directed to a purchase history page showing the transactions details. One or more functions can be used to display the transaction history. For example, a ShowPurchaseHistory( ) function retrieves and displays the user's purchase history. Then if the user purchased an item that contains digital content, the user can access the downloadable content. The digital content available for download is displayed on the webpage with a call to one or more functions. For example, a GetDigitalContent( ) function retrieves and verifies download instructions that were defined by the Supplier during the registration process.

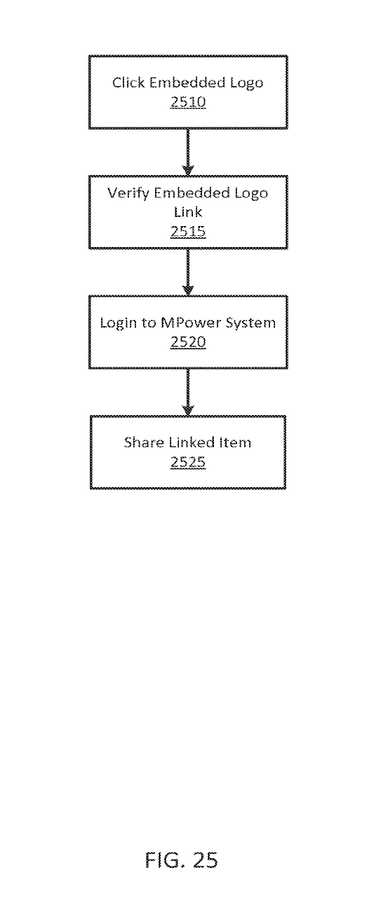

FIG. 25 is a simplified flow diagram that illustrates a process for accessing the MPower system via a plug-in at a Supplier website according to an embodiment of the present invention. A user accesses the MPower plug-in by clicking on an embedded MPower logo from a Supplier webpage (block 2510). A Supplier registered with MPower system receives an MPower sharing logo that may be included on their specified item and information webpages pages of their choice. The MPower sharing logo may be embedded on each page or with each item using a client-side script block that is generated during the Supplier's registration. For example, a GenerateClientScript( ) function creates a script block containing a unique ID for each registered Supplier. Unique ID's for Suppliers are not transferrable and will first be checked together with the link generated from the Supplier for each item or information to be shared. One or more functions can be used to verify the unique Supplier ID, for example, a CheckSupplierCode( ) function is called to retrieve and compare a unique ID to a known Supplier ID.

When the user clicks on the MPower embedded logo, the unique generated script block for each Supplier captures the current page information (for example, the current HREF) and sends it with an encoded URL back to the server for processing. The URL will be verified and the encoded URL will be posted to the MPower web site (block 2515). The posted URL may be decoded and saved to database, for example, by calling a SaveSupplierLinks( ) function that calls a CheckSharedLink( ) function to decode the URL and to save the link with the unique ID of the Supplier to the database.

After successful verification of both the link and the unique ID, the user can login to the MPower system (block 2520). As noted above, the user can Login with a Social Network ID, an MPower ID, or register on the MPower web site. Then the user shares the item, information, or webpage on which the MPower logo was embedded as described with reference to FIG. 24 (block 2525).

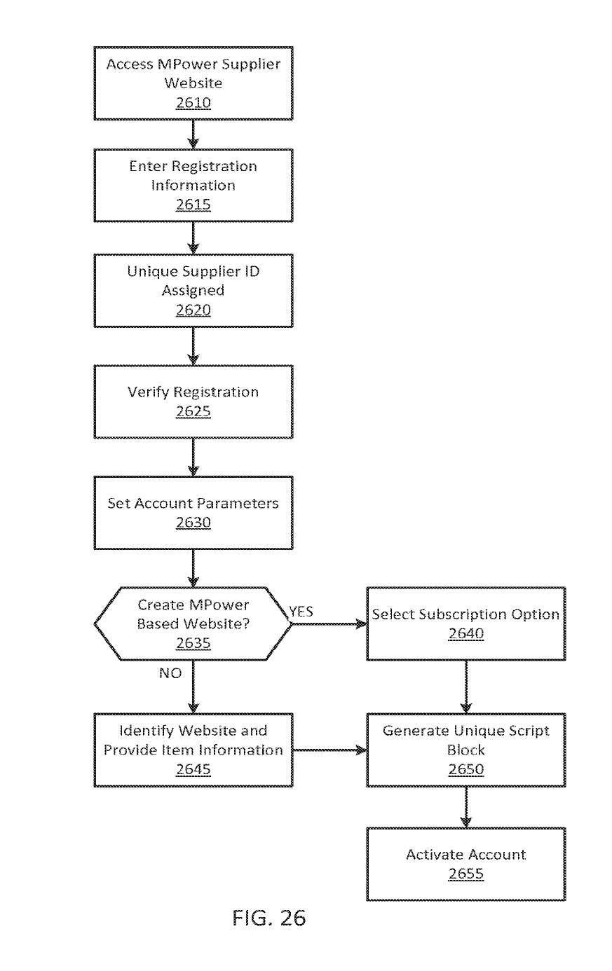

FIG. 26 is a simplified flow diagram that illustrates a process for registering new suppliers with the MPower system according to an embodiment of the present invention. Suppliers can register on the main MPower web site via the link for Suppliers (block 2610). Once a user clicks on the link to register as a Supplier, a new registration screen will open, requesting basic registration details such as a company name, a contact number, an email address and contact information for a person working at the company (block 2615). One or more functions can be used to input the registration information. For example, a SaveRegisterInfo( ) function is called that saves the registration information to a database and creates a unique Supplier ID (block 2620). Then a verification message is sent to the new Supplier, for example, at the provided email address. A VerifySupplier( ) function is called to verify send a verification link to the new Supplier. Then a verify link in the verification message needs to be clicked to complete the Supplier verification process (block 2625). A VerifySupplierEmail( ) function is called to verify and activate the Supplier account.

After the Supplier is verified, on behalf of the Supplier, a user sets account parameters (block 2630). The account parameters include a list of options and requirements that need to be completed before the account is activated and the sharing logo created. For example, the Supplier must designate a payment authority. The Supplier must make a selection from the available payment authorities that will be used when online transactions are processed and the payment is to be made. The supplier should also provide the account information to be used whenever a new purchase is completed and payments are to be disbursed. The Supplier must supply a payment authority account in order to receive any payments.

Additionally, a Supplier may choose to use an MPower web site rather than an independent web site (block 2635). If the Supplier chooses to use an MPower web site, the user is prompted to specify how many items or information selections they want to include on the web site, which can be based on one of three basic monthly subscription fee options (block 2640). Each fee option will have a different selection of items or information that can be included. The Supplier can also select the items or information that will be available on the MPower web site including images, video links, and audio clips, and what information is to be displayed, including the name or title and a description of the item. The MPower web site may be ideal for new comers like entertainers, music artists, authors or anyone new to the wide range of available options to share your content to the rest of the world. If the Supplier already has a web site, the user is asked to supply information on the type of items or information that can be shared from their web site (block 2645).

All selections and options will be saved from page to page. For example, a SaveSupplierInfo( ) function is called to save all the information from the Supplier into a database after all the selections have been completed. Once the registration is complete and the Supplier information and account parameters have been saved, an MPower sharing logo with a unique script block is generated (block 2650) and the Supplier account is activated (block 2655).

The various computer systems described herein may each include a storage component for storing machine-readable instructions for performing the various processes as described and illustrated. The storage component may be any type of machine readable medium (i.e., one capable of being read by a machine) such as hard drive memory, flash memory, floppy disk memory, optically-encoded memory (e.g., a compact disk, DVD-ROM, DVD±R, CD-ROM, CD±R, holographic disk), a thermomechanical memory (e.g., scanning-probe-based data-storage), or any type of machine read able (computer readable) storing medium. Each computer system may also include addressable memory (e.g., random access memory, cache memory) to store data and/or sets of instructions that may be included within, or be generated by, the machine-readable instructions when they are executed by a processor on the respective platform. The methods and systems described herein may also be implemented as machine-readable instructions stored on or embodied in any of the above-described storage mechanisms.

Although the present invention has been described with reference to particular examples and embodiments, it is understood that the present invention is not limited to those examples and embodiments. The present invention includes variations from the specific examples and embodiments described herein. Except to the extent necessary or inherent in the processes themselves, no particular order to steps or stages of methods or processes described in this disclosure, including the figures is implied. In many cases, the order of process steps may be varied without changing the purpose, effect or import of the methods described.

The subject matter defined in the appended claims is not necessarily limited to the specific features, or specific implementations described above. Many other configurations of computing devices, communications features, applications, and distributed software and/or hardware systems can be employed to implement the described invention as claimed. The specific features and methods described above are thus disclosed as example forms of implementing the claims and embodiments, and can be used in combination with and without each other.

What is claimed is:

1. A method for distributing, via a first system, an item from a webpage hosted by a second system, the method comprising:
receiving, by the second system from the first system, a script block in a communication session between the first system and a second system over a network, the script block containing an identification unique to the second system;
embedding, by the second system, a logo in the webpage using the script block, the logo being associated with the item and being clickable in a graphical user interface of the webpage;
sending, by the second system to the first system, and upon a user accessing the webpage over the network on a terminal device and clicking on the logo, the identification and an encoded link related to the item;
verifying, by the first system, the identification and the encoded link;
directing, by the first system and upon verification of the identification and the encoded link, the user to the first system;
allowing, by the first system, the user to insert the encoded link in an electronic post on a social networking site account registered to the user, such that the encoded link is shared with one or more other users of the social networking site; and
applying, by the first system, a credit to an account linked to the user when at least one of the one or more other users selects the encoded link and performs over the network a purchase transaction of the item from the second system.

2. The method of claim 1, further comprising, when the at least one of the one or more users selects the encoded link, displaying the webpage on another terminal device of the at least one of the one or more users.

3. The method of claim 1, wherein the item is at least one of a product, a digital file, a digital music file, a digital book, and a digital image.

4. The method of claim 1, further comprising, prior to the receiving the script block:
receiving, by the first system from the second system, an activation instruction and credentials about the second system;
verifying, by the first system, the credentials; and
setting, by the first system, account parameters for the second system in the first system.

5. The method of claim 4, wherein the account parameters include designating a payment authority.

6. The method of claim 4, further comprising prompting, by the first system to the second system, for specification of items to include in a website hosting the webpage.

7. The method of claim 6, wherein the second system is prompted to specify how many items or information selections to include on the website.

8. The method of claim 7, wherein the information selections depend on subscription fees.

9. The method of claim 4, further comprising the second system choosing an outside website as a host of the webpage.
